(19) United States
(12) Patent Application Publication
(10) Pub. No.: US 2026/0316296 A1
(43) Pub. Date: Oct. 15, 2026

(54) SYSTEM AND METHOD TO AUGMENT GRASPING OF OBJECTS VIA AN AUXILARY GRASPING DEVICE

(71) Applicant: Nexera Robotics Corp., North Vancouver (CA)

(72) Inventors: Jingyang PENG, Surrey (CA); Jeffrey M. KRAHN, Mission (CA); Sepehr SHEIKHOLESLAMI, Surrey (CA); Carlo MENON, Zurich (ZH); Michael CELIO, North Vancouver (CA)

(21) Appl. No.: 19/485,299

(22) PCT Filed: May 17, 2024
(86) PCT No.: PCT/CA2024/050672

§ 371 Date: Nov. 18, 2025

Related U.S. Application Data
(60) Provisional application No. 63/503,182, filed on May 19, 2023.
(60) Provisional application No. 63/523,563, filed on Jun. 27, 2023.
(60) Provisional application No. 63/589,119, filed on Oct. 10, 2023.

(51) Int. Cl. B25J 15/06; B25J 13/08; B25J 15/00

(52) U.S. Cl. CPC B25J 15/0616; B25J 13/082; B25J 15/0052

(57) ABSTRACT

A system and method to augment a grasping device adapted to provide the capability of applying gripping and suction forces to an object through more than one grasping interface to facilitate picking up and moving a wide variety of objects. This is accomplished through an augmented grasping device composed of a primary grasping device augmented by one or more auxiliary grasping devices; wherein said primary grasping device can have at least one primary grasping interface for providing gripping and suction forces; wherein said auxiliary grasping devices each can have one or more auxiliary grasping interfaces for providing gripping and suction forces; wherein said auxiliary grasping devices each can have one or more auxiliary grasping interfaces can be in the form of a rotating protrusion, an auxiliary suction interface, a miniature protrusion, or a sleeve; wherein said augmented grasping device can grasp an object using the primary grasping device alone, using the primary grasping device and one or more auxiliary grasping devices, or using one or more auxiliary grasping devices.

### CROSS REFERENCE TO RELATED APPLICATIONS

This application claims priority to and the benefit of U.S. Provisional Application Ser. No. 63/503,182, entitled “SYSTEM AND METHOD TO AUGMENT GRASPING OF OBJECTS”, filed on May 19, 2023, U.S. Provisional Application Ser. No. 63/583,563, entitled “SYSTEM AND METHOD TO AUGMENT GRASPING OF OBJECTS”, filed on Sep. 18, 2023 and U.S. Provisional Application Ser. No. 63/589,119, entitled “SYSTEM AND METHOD TO AUGMENT GRASPING OF OBJECTS”, filed on Oct. 10, 2023, the disclosures of which are incorporated herein by reference in its entirety.

### BACKGROUND

The embodiments described herein relate generally to a device configured to grasp, attract, and hold objects, and more particularly, to a method and apparatus for grasping a large variety of different objects in terms of both shapes and sizes.

The rise of automation across industries such as manufacturing, agriculture, e-commerce, and logistics brings about the ever-increasing need of robotic manipulators as well as grippers that will fit onto them. More specifically, the need to grip different kinds of objects with a single gripper arises in many fields.

While several solutions exist and have been adapted to grasp a large variety of objects, none are particularly effective, for example, when grasping objects that tend to undesirably deform or deconstruct if not handled correctly. Also, it is desirable to improve the gripping stability of the objects during the transfer stage of the pick and place process to increase the allowable acceleration, therefore reducing the cycling time. As such, there is a need for a device that can address these issues, and the present invention satisfies these needs.

### SUMMARY

A system and method to augment a grasping device adapted for gripping and applying suction forces to an object through a grasping interface to facilitate picking up and moving a wide variety of objects. This is accomplished through an augmented grasping device composed of a primary grasping device and auxiliary grasping devices. The primary grasping device can have at least one primary grasping interface for providing gripping and suction forces, the auxiliary grasping devices can have one or more auxiliary grasping interfaces for providing gripping and suction forces, the auxiliary grasping devices each can have one or more auxiliary grasping interfaces can be a rotating protrusion, an auxiliary suction interface, a miniature protrusion, or a sleeve. The augmented grasping device can grasp an object using the primary grasping alone, using the primary grasping device and one or more auxiliary grasping devices, or using one or more auxiliary grasping devices.

The present disclosure will provide an augmented grasping device adapted to provide gripping and suction forces to pick up and move a wide variety of objects in terms of shape, size, and construction, while maintaining the stability of the objects being grasped. This is accomplished through a primary grasping device augmented by at least one auxiliary grasping device.

The primary grasping device can be a wide variety of grasping devices, including but not limited to an adaptable grasping device, a suction device, an electromagnetic device, or a finger type grasping device.

An auxiliary grasping device may or may not have at least one actuator that allows the auxiliary grasping device to move relative to the primary grasping device. An auxiliary grasping device can be configured to provide stabilization during motion or to enhance grasping capabilities by enabling objects to be grasped in ways that the primary grasping device alone cannot.

The primary grasping device can be configured for grasping with one, more than one, or without an auxiliary grasping device, and may be configured with one or more actuation mechanisms.

An auxiliary grasping device can be configured for grasping with or without the first grasping device and may be configured with one or more actuation mechanisms.

### BRIEF DESCRIPTION OF THE DRAWINGS

FIG. 1 illustrates some examples of the general construction of an augmented grasping device.

FIG. 2 illustrates an augmented grasping device comprising one primary grasping device and one auxiliary grasping device that can rotate relative to the primary grasping device, and the method for it to grasp an object.

FIG. 3 illustrates that the auxiliary grasping interface can both move linearly and rotate relative to the primary grasping device.

FIG. 4 illustrates auxiliary grasping devices with at least one auxiliary grasping interface being a suction interface.

FIG. 5 illustrates examples of different shapes of a suction interface.

FIG. 6 illustrates examples of different arrangements of multiple suction interfaces: A. Horizontal array; B. Vertical array; C. Cross-shaped array; and D. 2-dimensional array.

FIG. 7 illustrates different variations of the auxiliary grasping device with at least one auxiliary grasping interface being a rotating protrusion.

FIG. 8 illustrates an auxiliary grasping device with at least one auxiliary grasping interface being a miniature protrusion.

FIG. 9 illustrates an auxiliary grasping device with a rotating protrusion, an object sensor, and a force sensor.

FIG. 10 illustrates an auxiliary grasping device with a miniature protrusion, an auxiliary suction interface, a force sensor, and a vacuum sensor.

FIG. 11 illustrates an auxiliary grasping device that can articulate as a whole.

FIG. 12 illustrates an auxiliary grasping device in with an auxiliary grasping interface the form of a sleeve.

FIG. 13 illustrates an alternative construction of the auxiliary grasping interface.

FIG. 14 illustrates an augmented grasping device comprising one primary grasping device and one auxiliary grasping device that is in a fixed position relative to the primary grasping interface, and the method for it to grasp an object.

FIG. 15 illustrates an augmented grasping device comprising one primary grasping device and one auxiliary grasping device that can move parallel to the central axis of the primary grasping device or the central axis of the primary grasping interface, and the method for it to grasp an object.

FIG. 16 illustrates an augmented grasping device comprising one primary grasping device and one auxiliary grasping device that can move parallel to the central axis of the primary grasping device or the central axis of the primary grasping interface, and the method for it to grasp an object.

FIG. 17 illustrates an augmented grasping device comprising one primary grasping device and one auxiliary grasping device that can rotate relative to the primary grasping device, and the method for it to grasp an object.

FIG. 18 illustrates an augmented grasping device comprising one primary grasping device and one auxiliary grasping device that can rotate relative to the primary grasping device, and the method for it to grasp an object.

FIG. 19 illustrates an augmented grasping device comprising one primary grasping device and one auxiliary grasping device that can rotate relative to the primary grasping device, and the method for it to grasp an object.

FIG. 20 illustrates an augmented grasping device comprising one primary grasping device and one auxiliary grasping device with a rotating protrusion, and the method for it to grasp an object.

FIG. 21 illustrates an augmented grasping device comprising one primary grasping device and one auxiliary grasping device with a rotating protrusion, and the method for it to grasp an object.

FIG. 22 illustrates an augmented grasping device comprising one primary grasping device and one auxiliary grasping device with a rotating protrusion, and the method for it to grasp an object in the form of a book. Notice that the book is kept closed during the grasping process.

FIG. 23 is a flowchart of a method for an augmented grasping device with an auxiliary grasping device having a rotating protrusion to grasp an object.

FIG. 24 is a flowchart of a method for an augmented grasping device with an auxiliary grasping device having a rotating protrusion to release an object.

FIG. 25 illustrates an augmented grasping device comprising one primary grasping device and one auxiliary grasping device with a rotating protrusion, and its application for keeping a box lid closed during grasping.

FIG. 26 illustrates an augmented grasping device comprising one primary grasping device and one auxiliary grasping device with a rotating protrusion, and its application for grasping a tall narrow object. Oscillations and vibrations of the object during motion can be reduced due to it being grasped both by the top face and the bottom face.

FIG. 27 illustrates an augmented grasping device comprising one primary grasping device and one auxiliary grasping device that can rotate relative to the primary grasping device, and the method for it to grasp an object.

FIG. 28 illustrates an augmented grasping device comprising one primary grasping device and one auxiliary grasping device that can rotate relative to the primary grasping device, and the method for it to grasp an object.

FIG. 29 illustrates an augmented grasping device that uses an auxiliary grasping device used for oscillation and vibration reduction.

FIG. 30 illustrates an augmented grasping device in which an auxiliary grasping device is used for grasping an object at a location that is difficult for the primary grasping device to reach.

FIG. 31 illustrates an augmented grasping device comprising one primary grasping device and one auxiliary grasping device and the method for it to grasp an object. The auxiliary grasping device has one auxiliary grasping interface in the form of one auxiliary suction interface.

FIG. 32 illustrates an augmented grasping device comprising one primary grasping device and one auxiliary grasping device and the method for it to grasp an object. The auxiliary grasping device has more than one interfaces in the form of more than one auxiliary suction interfaces.

FIG. 33 illustrates an augmented grasping device comprising one primary grasping device and one auxiliary grasping device and the method for it to grasp an object. The primary grasping interface is in the form of a primary suction interface. The auxiliary grasping interface is in the form of one auxiliary suction interface.

FIG. 34 illustrate an augmented grasping device comprising one primary grasping device and one auxiliary grasping device and the method for it to grasp an object. The primary grasping interface is in the form of more than one primary suction interfaces. The auxiliary grasping interface is in the form of one auxiliary suction interface.

FIG. 35 illustrates an augmented grasping device comprising one primary grasping device and one auxiliary grasping device and the method for it to grasp an object. The primary grasping interface is in the form of a primary suction interface. The auxiliary grasping device has more than one auxiliary grasping interfaces in the form of more than one auxiliary suction interfaces.

FIG. 36 illustrates an augmented grasping device comprising one primary grasping device and one auxiliary grasping device and the method for it to grasp an object. The primary grasping interface is in the form of more than one primary suction interfaces. The auxiliary grasping interface is in the form of more than one auxiliary suction interfaces.

FIG. 37 illustrates an augmented grasping device comprising one primary grasping device and two auxiliary grasping devices and the method for it to grasp an object. The first auxiliary grasping device has one auxiliary grasping interface in the form of an auxiliary suction interface. The second auxiliary grasping device has one auxiliary grasping interface in the form of a rotating protrusion.

FIG. 38 illustrates an augmented grasping device comprising one primary grasping device and two auxiliary grasping devices and the method for it to grasp an object. The primary grasping device has more than one primary grasping interfaces in the form of more than one suction interfaces. The first auxiliary grasping device has one auxiliary grasping interface in the form of an auxiliary suction interface. The second auxiliary grasping device has one auxiliary grasping interface in the form of a rotating protrusion.

FIG. 39 illustrates an augmented grasping device comprising one primary grasping device and two auxiliary grasping devices and the method for it to grasp an object. The primary grasping device has more than one grasping interfaces in the form of more than one suction interfaces. The first auxiliary grasping device has more than one auxiliary grasping interface in the form of more than one auxiliary suction interfaces. The second auxiliary grasping device has one auxiliary grasping interface in the form of a rotating protrusion.

FIG. 40 illustrates a detailed embodiment of an augmented grasping device comprising one primary grasping device and two auxiliary grasping devices. The first auxiliary grasping device has one auxiliary grasping interface in the form of an auxiliary suction interface. The second auxiliary grasping device has one auxiliary grasping interface in the form of a rotating protrusion.

FIG. 41 illustrates a detailed embodiment of an augmented grasping device comprising one primary grasping device and two auxiliary grasping devices and the method for it to grasp and release an object in the form of a telescopic box. The first auxiliary grasping device has one auxiliary grasping interface in the form of an auxiliary suction interface. The second auxiliary grasping device has one auxiliary grasping interface in the form of a rotating protrusion.

FIG. 42 is a flowchart of a method for an augmented grasping device with one auxiliary grasping device having a rotating protrusion and one auxiliary grasping device having at least one auxiliary suction interface to grasp an object.

FIG. 43 is a flowchart of a method for an augmented grasping device with one auxiliary grasping device having a rotating protrusion and one auxiliary grasping device having at least one auxiliary suction interface to release an object.

FIG. 44 illustrates an augmented grasping device comprising one primary grasping device and one auxiliary grasping device that can articulate as a whole, and the method for it to grasp an object.

FIG. 45 illustrates an augmented grasping device comprising one primary grasping device, one auxiliary grasping device that can articulate as a whole, and one auxiliary grasping device having an auxiliary grasping interface in the form of a rotating protrusion, and the method for it to grasp an object.

FIG. 46 illustrates an augmented grasping device comprising one primary grasping device, one auxiliary grasping device having a first auxiliary grasping interface in the form of a miniature protrusion, a second auxiliary grasping interface in the form of an auxiliary suction interface, and one auxiliary grasping device having an auxiliary grasping interface in the form of a rotating protrusion.

FIG. 47 illustrates an augmented grasping device comprising one primary grasping device, one auxiliary grasping device having an auxiliary grasping interface in the form of a miniature protrusion, and one auxiliary grasping device having an auxiliary grasping interface in the form of a rotating protrusion, and the method for it to grasp an object.

FIG. 48 illustrates an augmented grasping device comprising one primary grasping device, one auxiliary grasping device having an auxiliary grasping interface in the form of a miniature protrusion, and one auxiliary grasping device having an auxiliary grasping interface in the form of a rotating protrusion, and the method for it to grasp an object.

FIG. 49 illustration of moving a book held by its cover.

FIG. 50 illustrates an augmented grasping device comprising one primary grasping device and one auxiliary grasping device having an auxiliary grasping interface in the form of a rotating protrusion, and the method for it to grasp an object.

FIG. 51 illustrates an embodiment of a primary grasping device in an augmented grasping device.

FIG. 52 illustrates an augmented grasping device comprising one primary grasping device and one auxiliary grasping device preconditioning an object to facilitate subsequent grasping.

FIG. 53 illustrates an augmented grasping device comprising one primary grasping device and one auxiliary grasping device preconditioning an object to facilitate subsequent grasping.

FIG. 54 illustrates an augmented grasping device comprising one primary grasping device and one auxiliary grasping device preconditioning an object to facilitate subsequent grasping.

FIG. 55 Augmented grasping device comprising one primary grasping device and one auxiliary grasping device preconditioning an object to facilitate subsequent grasping.

FIG. 56 illustrates an augmented grasping device comprising one primary grasping device and one auxiliary grasping device grasping an object after preconditioning said object. Said primary grasping device is used to grasp said object.

FIG. 57 illustrates an augmented grasping device comprising one primary grasping device and two auxiliary grasping devices grasping an object after preconditioning said object. One of said auxiliary grasping devices with at least one auxiliary suction interface is used to grasp said object.

FIG. 58 illustrates an augmented grasping device comprising one primary grasping device and two auxiliary grasping devices grasping an object after preconditioning said object. One of said auxiliary grasping devices with a rotating protrusion is used to grasp said object.

FIG. 59 illustrates an augmented grasping device with at least one auxiliary grasping interface being an auxiliary suction interface.

FIG. 60 illustrates an augmented grasping device with at least one auxiliary grasping interface being a miniature protrusion.

### DETAILED DESCRIPTION

### General Construction of an Augmented Grasping Device

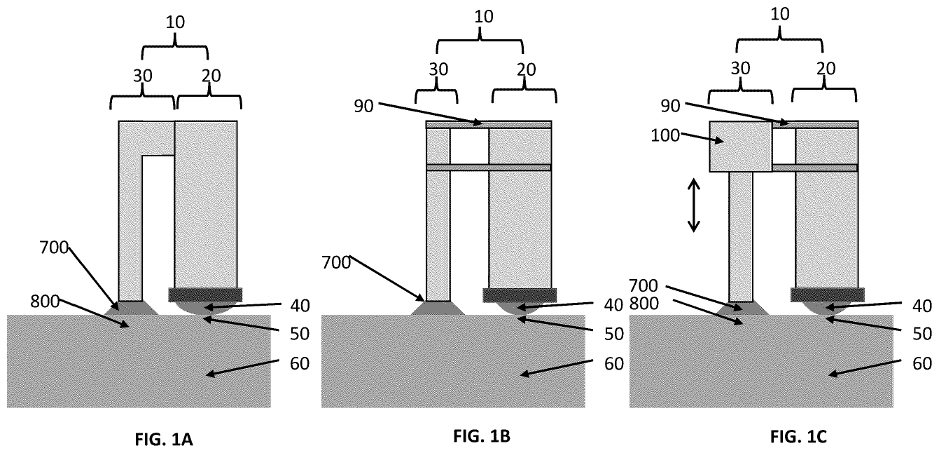

In the preferred embodiment as in FIG. 1A, an augmented grasping device [10] comprises a primary grasping device [20] and at least one auxiliary grasping device [30].

The primary grasping device [20] may work on one or more principles including but not limited to suction, friction, magnetic attraction, electrostatic attraction, and mechanical interlocking, and may be optimized for grasping a specific range or set of objects [60]. The primary grasping device [20] may work alone or in combination with one or more auxiliary grasping devices [30] for grasping an object [60]. The primary grasping device [20] has a distal end [28] and a proximal end [25].

An auxiliary grasping device [30] may also work on one or more principles including but not limited to suction, friction, magnetic attraction, electrostatic attraction, and mechanical interlocking, and may be individually optimized for grasping a specific range or set of objects [60]. An auxiliary grasping device [30] has a distal end and a proximal end.

The primary grasping device [20] grasps an object [60] with at least one primary grasping interface [40] at one or more primary grasping area [50] on the object [60].

An auxiliary grasping device [30] grasps the object [60] with at least one auxiliary grasping interface [700] connected to the distal end of the auxiliary grasping device [30], at one or more auxiliary grasping area [800] on the object [60].

The primary grasping device [20] and auxiliary grasping device [30] may be connected to each other directly as in FIG. 1A or through an intermediate structure [90] as in FIG. 1B. The intermediate structure [90] can be implemented in different ways, including but not limited to a plate, a disc, a bracket, a truss, a framed structure, a robotic interface, a ball joint, a hydraulic mechanism, a pneumatic mechanism, a fluid mechanism, an electro-mechanical mechanism, a linear mechanism, a revolute joint, a spherical joint, a cardan joint, etc. If there are more than one auxiliary grasping devices [30] in the augmented grasping device [10], the connection between the primary grasping device [20] and the multiple auxiliary grasping devices [30] through the intermediate structure [90] can be implemented in different topologies. For example, in a star topology all auxiliary grasping devices [30] are connected to the primary grasping device [20] but not to each other; in a star topology the primary grasping device [20] and all but one auxiliary grasping devices [30] are connected to the remaining one auxiliary grasping devices [30] but not to each other; in a daisy chain topology, the primary grasping device [20] and the auxiliary grasping devices [30] are connected as a chain. Other topologies such as ring topology, tree topology, mesh topology, bus topology, or a hybrid topology that combines at least two of the aforementioned topologies may also be used.

An auxiliary grasping device [30] may have zero, as in FIG. 1A and FIG. 1B, or more actuators [100], as in FIG. 1C, that allow properties, e.g. position, orientation, force, torque, etc. of said at least one auxiliary grasping interface [700] to be individually, or as a group, controlled. In this way, the user or control software can select which grasping device, primary [20] and/or one or more auxiliary [30], individually or as a group, is to be used in a specific situation.

An auxiliary grasping device [30] may have one or more sensors [310] for measuring the position of at least one auxiliary grasping interface [700] on said at least one auxiliary grasping device [30], or measuring the orientation of at least one auxiliary grasping interface [700] on said at least one auxiliary grasping device [30], or detecting object [60] existence, or detecting the detachment of the object [60] from any second object placed underneath, or measuring object [60] properties such as distance, size, color, reflectivity, surface texture, and appearance, or collision avoidance, or measuring force, or measuring torque, or measuring pressure, or measuring vacuum level.

The augmented grasping device [10] is configured in such a manner as to allow for the assembly to be mounted on a robot, machine, automated equipment or intelligent system on the proximal end of the augmented grasping device [10], whereas a primary grasping interface [40] of the primary grasping device [20] is preferably located at the distal end of the augmented grasping device [10].

An auxiliary grasping device [30] may be used to aid the primary grasping device [20] in grasping objects before, during or after grasping, or before, during or after object manipulation.

An auxiliary grasping device [30] may be used alone, in combination with one or more additional auxiliary grasping devices [30], in combination with the primary grasping device [20], or in combination with both one or more additional auxiliary grasping devices [30] and the primary grasping device [20] to grasp objects [60].

An auxiliary grasping device [30] may be used to aid the primary grasping device [20] in stabilizing objects or dampening object oscillations before, during or after grasping, or before, during or after object manipulation. For example, an auxiliary grasping device [30] may provide one or more additional points or areas of contact or auxiliary grasping areas [800] far from the center of mass of the object [60] in addition to the primary grasping area [50] to stabilize the object [60].

An auxiliary grasping device [30] may be used to precondition an object [60] prior to grasping by moving or manipulating the object [60] so that the object [60] may be in a position so it can be better grasped by the primary grasping device [20], by one or more auxiliary grasping devices [30], or by the combination of the primary grasping device [20] and one or more auxiliary grasping devices [30].

### Auxiliary Grasping Interface Can Move Relative to the Primary Grasping Device

In one embodiment of an augmented grasping device [10], an auxiliary grasping device [30] may be designed such that it has at least one auxiliary grasping interface [700] that can move relative to the primary grasping device [20] or a primary grasping interface [40], with or without one or more actuators [100]. The actuators [100] could work by a mechanical means such as guided cables or fluidic, pneumatic, motorized, electronic, magnetic actuators or any other suitable actuation method. Specifically, in one embodiment an auxiliary grasping interface [700] can move beyond the distal end [28] of the primary grasping device [20] and below the object; in another embodiment an auxiliary grasping interface [700] can at least move close to one surface of the object [60] for grasping the object [60]; in another embodiment an auxiliary grasping interface [700] can move beyond the distal end [28] of the primary grasping device [20] but not necessarily reaching below the object.

### Auxiliary Grasping Interface Can Move Linearly Relative to the Primary Grasping Device

In one embodiment of an augmented grasping device [10], an auxiliary grasping device [30] may be designed such that it has at least one auxiliary grasping interface [700] that can move linearly relative to the primary grasping device [20] or a primary grasping interface [40] with or without one or more actuators [100], providing at least one auxiliary grasping area [800] whose orientation is fixed relative to the central axis of the primary grasping device [20] or the central axis of a primary grasping interface [40]. In a special case as in FIG. 1C, an auxiliary grasping device [30] may have one or more auxiliary grasping interfaces [700] designed to move parallel to the central axis of the primary grasping device [20] or the central axis of a primary grasping interface [40]. The auxiliary grasping area [800] can be used to improve the holding force for objects [60] or stabilize objects [60] during motion by reducing object [60] oscillations or vibrations.

### Auxiliary Grasping Interface Can Rotate Relative to the Primary Grasping Device

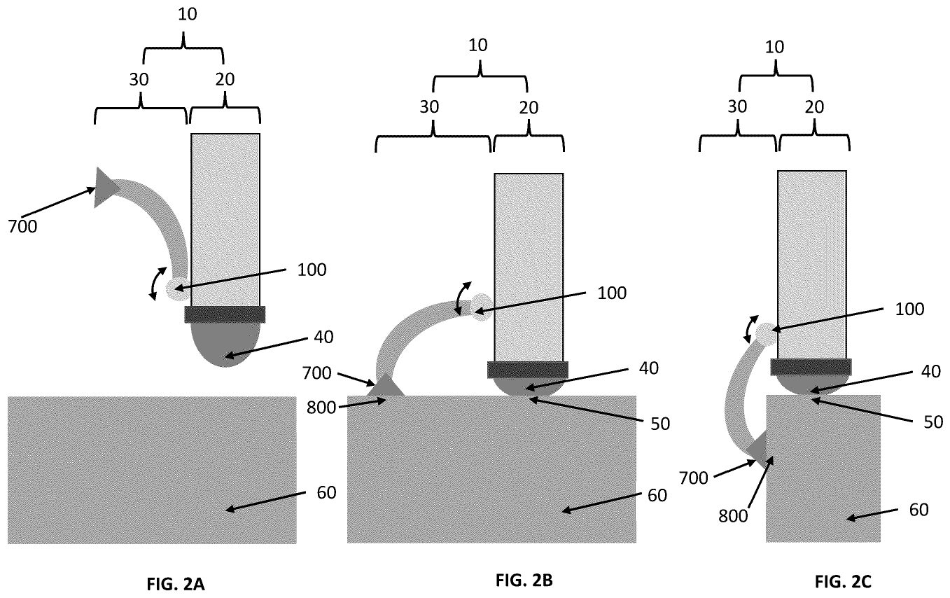

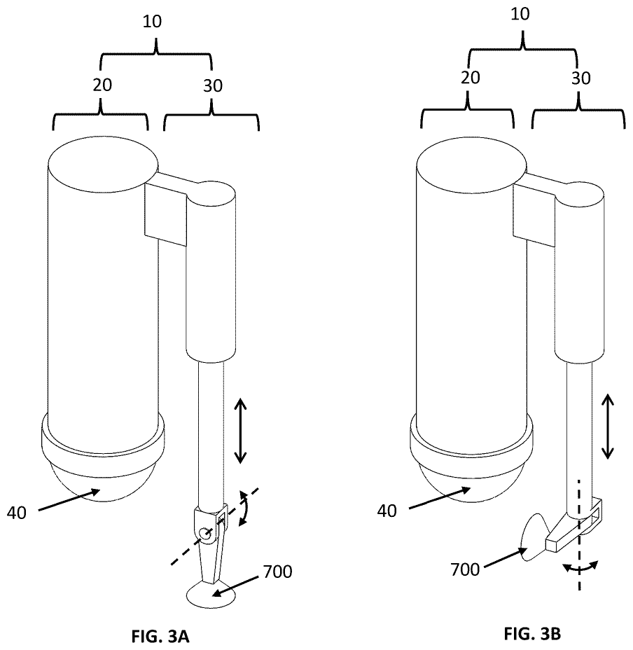

In another embodiment of an augmented grasping device [10], an auxiliary grasping device [30] may be designed such that it has at least one auxiliary grasping interface [700] that can rotate around an axis with or without the use of one or more actuators [100], to provide at least one auxiliary grasping area [800] whose orientation is variable relative to the central axis of the primary grasping device [20] or the central axis of a primary grasping interface [40]. In a special case, an auxiliary grasping device [30] may have at least one auxiliary grasping interface [700] designed to rotate around an axis perpendicular to the central axis of the primary grasping device [20] or the central axis of a primary grasping interface [40] as in FIG. 2, or to rotate around an axis parallel to the central axis of the primary grasping device [20] or the central axis of a primary grasping interface [40]. Due to the rotation, the orientation of the auxiliary grasping area [800] can vary relative to the orientation of the primary grasping area [50]. For example, in FIG. 2B both the primary grasping area [50] and the auxiliary grasping area [800] is placed on the same surface (e.g. top of a box) of an object [60], and in FIG. 2C the primary grasping area [50] is placed on one surface (e.g. top of a box) of an object [60] while the auxiliary grasping area [800] is placed on another surface (e.g. side of a box) of the object [60]. The auxiliary grasping area [800] can be used to improve the holding force for objects [60] or to stabilize objects [60] during motion by reducing object [60] oscillations or vibrations.

### Auxiliary Grasping Interface Can Both Move Linearly and Rotate Relative to the Primary Grasping Device

In another embodiment of an augmented grasping device [10], an auxiliary grasping device [30] may be designed such that it has at least one auxiliary grasping interface [700] that can both move linearly relative to the primary grasping device [20] or a primary grasping interface [40] and rotate around an axis, with or without the use of one or more actuators [100]. In one special case as in FIG. 3A, an auxiliary grasping device [30] may have one or more of its auxiliary grasping interfaces [700] designed to be able to both move parallel to the central axis of the primary grasping device [20] or the central axis of a primary grasping interface [40] and to rotate around an axis perpendicular to the central axis of the primary grasping device [20] or the central axis of a primary grasping interface [40]. In another special case as in FIG. 3B, an auxiliary grasping device [30] may have at least one auxiliary grasping interface [700] designed to be able to both move parallel to the central axis of the primary grasping device [20] or the central axis of a primary grasping interface [40] and to rotate around an axis parallel to the central axis of the primary grasping device [20] or the central axis of a primary grasping interface [40].

### Auxiliary Grasping Interface Can Move in Arbitrary Ways Relative to the Primary Grasping Device

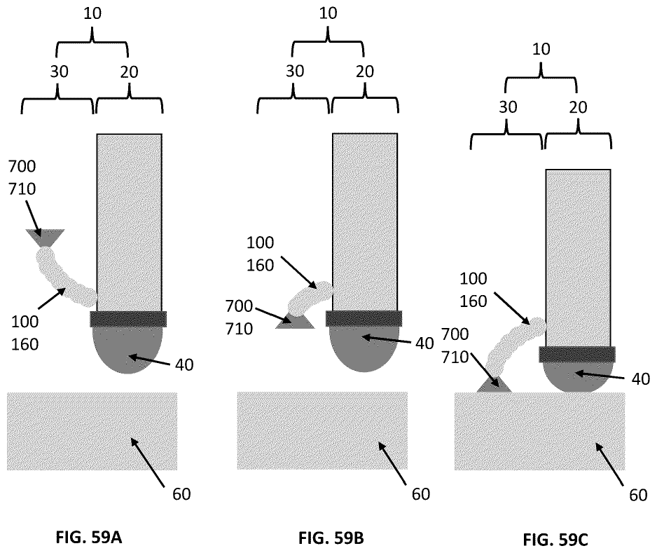

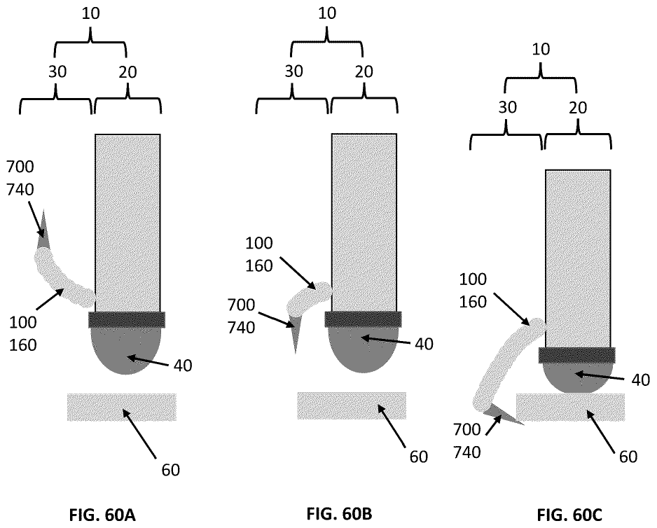

In another embodiment of an augmented grasping device [10] as in FIG. 59 and FIG. 60, an auxiliary grasping device [30] may be designed such that it can change shape arbitrarily, which includes bending as in FIG. 59A, FIG. 59C, FIG. 60A, and FIG. 60C, twisting, and straightening in one or more planes, as well as changes in size including shortening as in FIG. 59B and FIG. 60B, elongating, swelling, shrinking, and deforming, either over the entire auxiliary grasping device [30] or over one or more of its parts, thus allowing its auxiliary grasping interfaces [700] to achieve a wide range of positions and orientations relative to the primary grasping device [20] or the at least one primary grasping interface [40]. This can for example be achieved with an actuator [100] in the form of a fluidic actuator [160] embedded in the auxiliary grasping device [30] having at least one internal cavity, and by varying the gas/fluid pressure, including pressurizing or depressurizing, inside said internal cavity of the of fluidic actuator [160]. The interior of said fluidic actuator [160] may also be subdivided into multiple cavities and may be designed to encourage deformation in a specific manner or direction.

### Use One or More Auxiliary Grasping Devices in Combination With the Primary Grasping Devices for Grasping

In another embodiment of an augmented grasping device [10], one or more auxiliary grasping devices [30] may be used in combination with the primary grasping device [20] to grasp objects [60] that would otherwise be difficult to grasp with the primary grasping device [20] alone, such as telescoping boxes (e.g., shoe boxes), tuck-lid boxes, or books that may have a softcover, hardcover or a dust jacket.

### Auxiliary Grasping Devices with at Least One Auxiliary Grasping Interface Being a Suction Interface

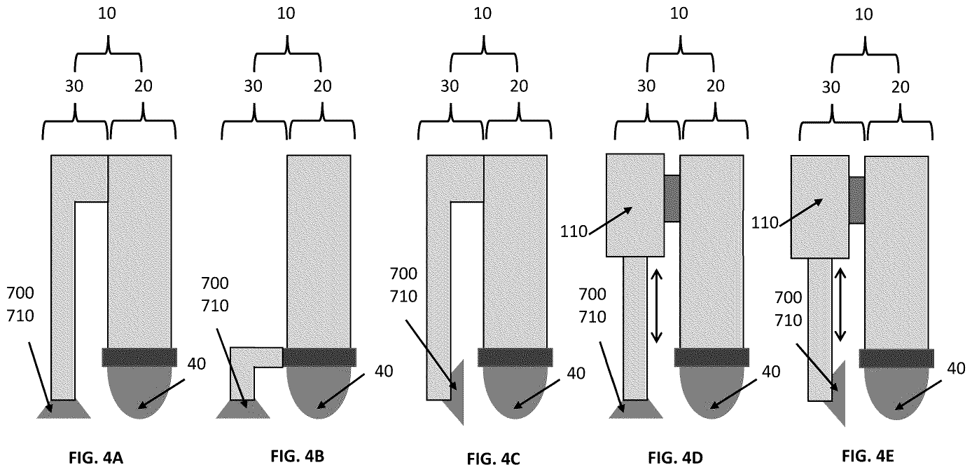

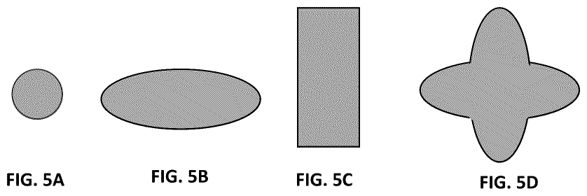

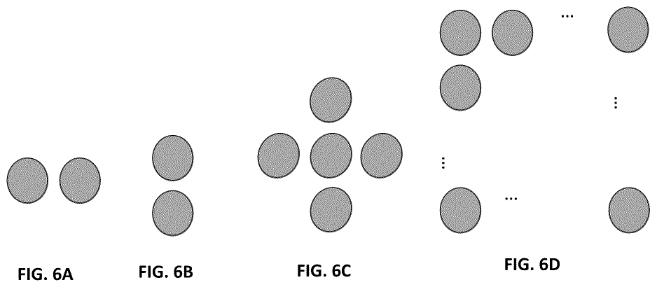

In another embodiment of an augmented grasping device [10] as in FIG. 4A, an auxiliary grasping device [30] is designed such that it has at least one auxiliary grasping interface [700] in the form of an auxiliary suction interface [710], i.e. suction is generated at the auxiliary grasping interface [700] when the auxiliary grasping device [30] is activated. Said auxiliary suction interface [710] could comprise one or more sub-suction interfaces [720] (e.g. multiple suction cups). An auxiliary suction interface [710] or sub-suction interface [720] could be of different shapes, for example circular as in FIG. 5A, oval as in FIG. 5B, rectangular as in FIG. 5C, or cross-shaped as in FIG. 5D. Said auxiliary suction interface [710] could have an array of sub-suction interfaces [720] that could be arrayed horizontally, vertically, or both horizontally and vertically. In addition, multiple sub-suction interfaces [720] could be arranged into other patterns such as, but not limited to a cross, diamond, or hexagonal configuration. Some arrangements of the sub-suction interfaces [720] are shown in FIG. 6. When multiple sub-suction interfaces [720] are arrayed horizontally, their configuration may prevent the object [60] from twisting or rotating on the horizontal plane or, similarly, when the multiple sub-suction interfaces [720] are arrayed vertically, their configuration may prevent the object [60] from twisting or rotating on the vertical plane. In FIG. 4A, the auxiliary suction interface [710] is fixed relative to the primary grasping device [20] and oriented in the same direction as the primary grasping interface [40]. It should be noted that if a primary grasping interface [40] takes the form of one suction interface or multiple sub-suction interfaces, it can also have different designs, for example using those in FIG. 5 and FIG. 6.

In another embodiment of an augmented grasping device [10] as in FIG. 4 and FIG. 59, an auxiliary grasping device [30] is designed such that it has at least one auxiliary grasping interface [700] in the form of an auxiliary suction interface [710], i.e. suction is generated at the auxiliary grasping interface [700] when the auxiliary grasping device [30] is activated. Said auxiliary suction interface [710] could comprise one or more sub-suction interfaces [720] (e.g. multiple suction cups). An auxiliary suction interface [710] or sub-suction interface [720] could be of different shapes, for example circular as in FIG. 5A, oval as in FIG. 5B, rectangular as in FIG. 5C, or cross-shaped as in FIG. 5D. Said auxiliary suction interface [710] could have an array of sub-suction interfaces [720] that could be arrayed horizontally, vertically, or both horizontally and vertically. In addition, multiple sub-suction interfaces [720] could be arranged into other patterns such as, but not limited to a cross, diamond, or hexagonal configuration. Some arrangements of the sub-suction interfaces [720] are shown in FIG. 6. When multiple sub-suction interfaces [720] are arrayed horizontally, their configuration may prevent the object [60] from twisting or rotating on the horizontal plane or, similarly, when the multiple sub-suction interfaces [720] are arrayed vertically, their configuration may prevent the object [60] from twisting or rotating on the vertical plane. In FIG. 4A, the auxiliary suction interface [710] is fixed relative to the primary grasping device [20] and oriented in the same direction as the primary grasping interface [40]. It should be noted that if a primary grasping interface [40] takes the form of one suction interface or multiple sub-suction interfaces, it can also have different designs as in FIG. 5 and FIG. 6.

A variant of the embodiment of an augmented grasping device [10] in FIG. 4A is shown in FIG. 4D. It is different from FIG. 4A that in FIG. 4D an actuator [110] is used to at least move the auxiliary suction interface [710] close to one surface of the object [60] for grasping the object [60].

A variant of the embodiment of an augmented grasping device [10] in FIG. 4C is shown in FIG. 4E. It is different from FIG. 4C that in FIG. 4E an actuator [110] is used to at least move the auxiliary suction interface [710] close to one surface of the object [60] for grasping the object [60].

### Auxiliary Grasping Devices With at Least One Auxiliary Grasping Interface Being a Rotating Protrusion

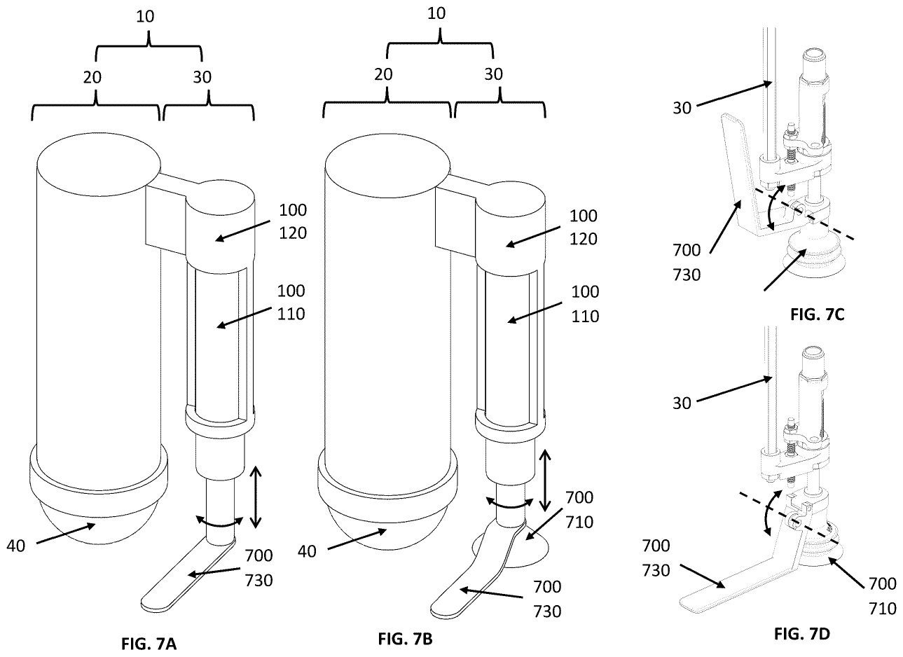

In another embodiment of an augmented grasping device [10] as in FIG. 7A, an auxiliary grasping device [30] is designed such that it has at least one auxiliary grasping interface [700] in the form of a rotating protrusion [730] that may be twisted, rotated, turned, bent or lifted, and is configured to aid in picking up, manipulating, and releasing objects [60]. Said rotating protrusion [730] is positionally controlled relative to the primary grasping device [20] or the at least one primary grasping interface [40]. Specifically, at least one actuator [110] may be used to move the rotating protrusion [730] relative to the primary grasping device [20] or a primary grasping interface [40], for example extend beyond the distal end [28] of the primary grasping device [20] and below the object [60], and the same [110] or a different [120] actuator may be used to rotate the rotating protrusion [730] relative to the primary grasping device [20] or a primary grasping interface [40] around an axis parallel to the central axis of the primary grasping device [20] or the central axis of a primary grasping interface [40], so that the rotating protrusion [730] may be rotated underneath and then pinch the object [60] that have been grasped against said primary grasping interface [40] of the primary grasping device [20]. The rotating protrusion [730] may be in any shape including, but not limited to, that of a thin blade, spatula, flat bar, rod or other shape. Such pinching action has many uses including for grasping books, telescopic boxes, tuck-lid boxes, ensuring that the item remains at least partially closed or intact, and stabilizing the object [60] being grasped.

### Rotating Protrusion for Object Stabilization

In yet another embodiment of an augmented grasping device [10], the rotating protrusion [730] could be deployed to increase grasping reliability and aid in object [60] stabilization while the whole augmented grasping device [10] is being moved, for example by a robot, machine, automated equipment or intelligent system on which the augmented grasping device [10] is mounted.

Auxiliary Grasping Devices with at Least One Auxiliary Grasping Interface Being a Miniature Protrusion

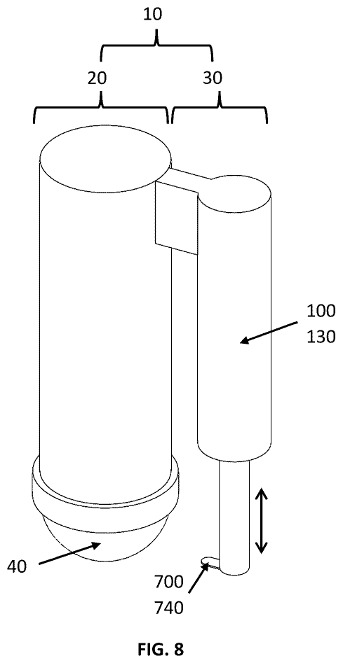

In another embodiment of an augmented grasping device [10] as in FIG. 8 and in FIG. 60, an auxiliary grasping device [30] is designed such that it has at least one auxiliary grasping interface [700] in the form of a miniature protrusion [740]. At least one actuator [130] may be used to move the miniature protrusion [740] beyond the distal end [28] of the primary grasping device [20] so that the miniature protrusion [740] may be used to slightly lift an item [60] to facilitate subsequent grasping processes.

The miniature protrusion [740] could also provide a means to pull, pry, nudge or otherwise create a gap between the object [60] and other surrounding objects by either adjusting the position of the object [60] or by adjusting the positions of the surrounding objects.

### Auxiliary Grasping Devices With Sensor

An auxiliary grasping device [30] may have zero or more sensors [300] on it for purposes including but not limited to: measuring the position of at least one auxiliary grasping interface on said auxiliary grasping device [300], measuring the orientation of at least one auxiliary grasping interface on said auxiliary grasping device [30], detecting object [60] existence, measuring object [60] properties such as distance, size, color, reflectivity, surface texture, and appearance, collision avoidance, measuring force, torque, pressure, and vacuum levels. Said sensor [300] may or may not be attached to an auxiliary grasping interface [700]. Said sensor [300] may or may not be actuated by an actuator [100]. Said actuator [100] may or may not be also used for actuating one or more auxiliary grasping interfaces [700] of said auxiliary grasping device [30].

### Auxiliary Grasping Devices With Rotating Protrusion, Object Sensor, and Force Sensor

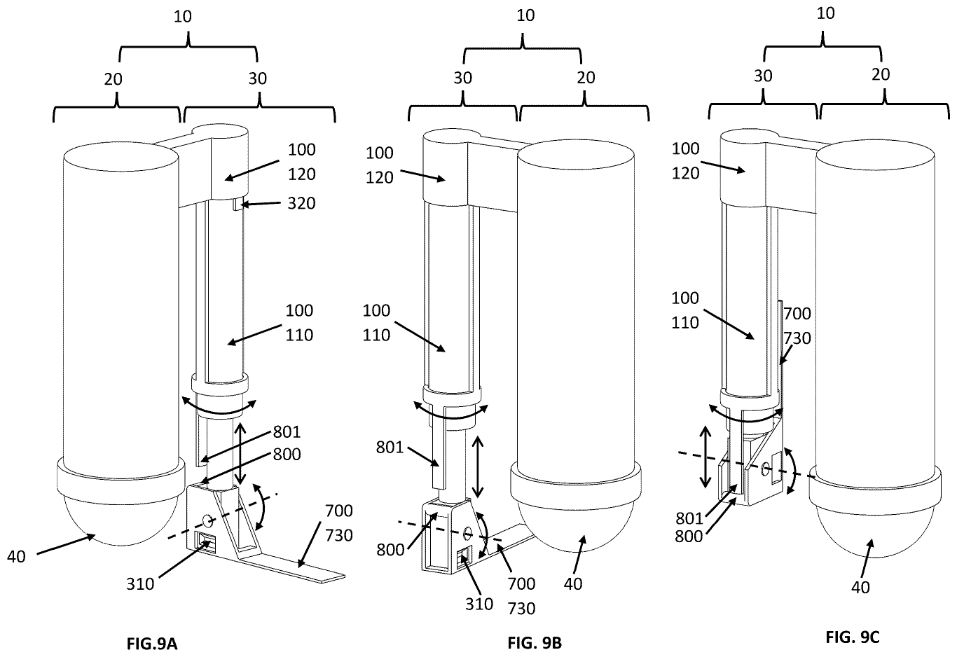

In a preferred embodiment of an augmented grasping device [10] as shown in FIG. 9, which is a variant of the embodiment in FIG. 7A, an auxiliary grasping device [30] has a sensor [310] installed near an auxiliary grasping interface [700] that has the form of a rotating protrusion [730]. Said sensor [310] is at least used for object [60] detection, object [60] distance measurement, and the detection of detachment of said object [60] from any other objects placed underneath. At least one actuator [110] is used to move both said rotating protrusion [730] and said sensor [310] beyond the distal end [28] of the primary grasping device [20] and below the object [60], and the same [110] or a different actuator [120] is used to rotate both said rotating protrusion [730] and said sensor [310] so that said rotating protrusion [730] may be used to pinch objects [60] against said primary grasping interface [40] and said sensor [310] may point to different directions. Said embodiment may also have one or more sensors [320] that are used for monitoring the force applied to the rotating protrusion [730]. In addition, in said embodiment the rotating protrusion [730] can also rotate around an axis that is substantially perpendicular to the central axis of the primary grasping device [20] or the central axis of a primary grasping interface [40]. So the rotating protrusion [730] can fold up when it is in an idle position to save space, and fold down otherwise as shown in FIG. 9C, and this can be achieved passively as follows: there is a boss [800] on the rotating protrusion [730] that when the rotating protrusion [730] is fully retracted to its idle position, said boss [800] hits a protrusion [801] on the auxiliary grasping device [30], folding the rotating protrusion [730] up. And upon extending the rotating protrusion [730] away from its idle position, said boss [800] disengage with said protrusion [801], and the rotating protrusion [730] folds down due to gravity or a torque exerted by a mechanism, e.g. a spring.

### Auxiliary Grasping Devices With Multiple Auxiliary Grasping Interfaces

An auxiliary grasping device [30] may have more than one auxiliary grasping interface [700]. The following is an example.

### Auxiliary Grasping Device With Rotating Protrusion, and Suction Interface

In an embodiment of an augmented grasping device [10] as in FIG. 7B, the auxiliary grasping device [30] has one auxiliary grasping interface [700] in the form of a rotating protrusion [730] and another auxiliary grasping interface [700] in the form of an auxiliary suction interface [710]. The auxiliary suction interface [710] is oriented substantially parallel to the central axis of a primary grasping interface [40]. Alternatively, said auxiliary suction interface [710] is oriented towards a direction which is different from or substantially perpendicular to the one defined by the central axis of said primary grasping interface [40]. An actuator [110] is used to move both the rotating protrusion [730] and the auxiliary suction interface [710] beyond the distal end [28] of the primary grasping device [20] and below the object [60] or at least close to one surface of the object [60] for grasping the object [60]. The same [110] or a different [120] actuator is used to rotate at least the rotating protrusion [730] around an axis substantially parallel to the central axis of the primary grasping device [20] or the central axis of said primary grasping interface [40]. Optionally, the rotating protrusion [730] can also rotate around an axis substantially perpendicular to the central axis of the primary grasping device [20] or the central axis of said primary grasping interface [40] as in FIG. 7C and FIG. 7D, so that it can be folded up when not in use to save space and reduce the chance of undesirable collisions involving the rotating protrusion [730]. This rotation motion can be generated with or without an actuator.

In another embodiment of an augmented grasping device [10], the auxiliary grasping device [30] comprises a primary grasping device [20], a first auxiliary grasping device [310], and a second auxiliary grasping device [320]. Wherein at least one auxiliary grasping interface [700] of said first auxiliary grasping device [310] is in the form of a rotating protrusion [730]. An actuator [110] is used to move said rotating protrusion [730] beyond the distal end [28] of the primary grasping device [20] and below the object [60]. The same [110] or a different [120] actuator is used to rotate at least said rotating protrusion [730] around an axis substantially parallel to the central axis of the primary grasping device [20] or the central axis of said primary grasping interface [40]. And at least one auxiliary grasping interface [700] of said second auxiliary grasping device [310] is in the form of an auxiliary suction interface [710]. Said auxiliary suction interface [710] is oriented substantially parallel to the central axis of a primary grasping interface [40]. An actuator [1100] is used to at least move said auxiliary suction interface [710] close to one surface of the object [60] for grasping the object [60].

### Auxiliary Grasping Devices With Miniature Protrusion, Suction Interface, Force Sensor, and Vacuum Sensor

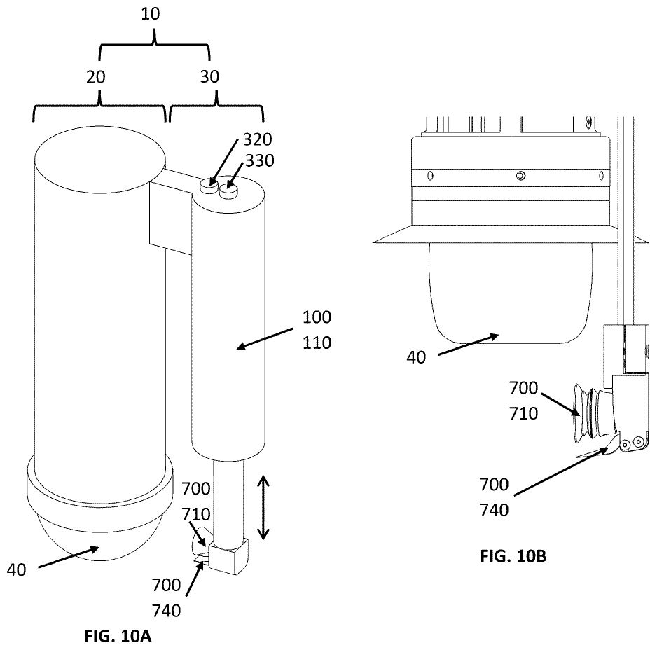

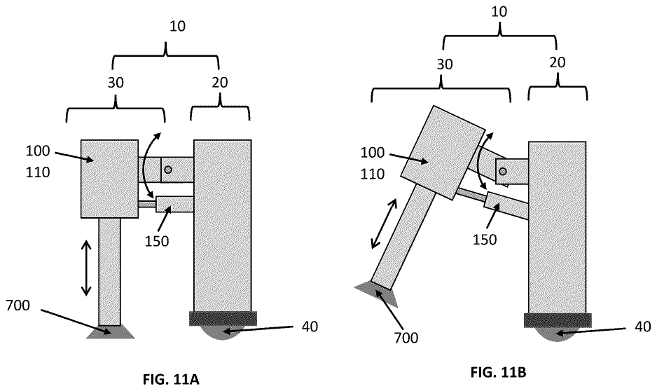

In another preferred embodiment of an augmented grasping device [10] as in FIG. 10A and FIG. 10B, the auxiliary grasping device [30] has a first auxiliary grasping interface [700] in the form of a miniature protrusion [740] and a second auxiliary grasping interface [700] in the form of an auxiliary suction interface [710]. The auxiliary suction interface [710] is oriented towards a direction which is different from or substantially perpendicular to the one defined by the central axis of the primary grasping device [20] or the central axis of a primary grasping interface [40]. An actuator [110] is used to move both the miniature protrusion [740] and the auxiliary suction interface [710] beyond the distal end [28] of the primary grasping device [20] or at least close to one surface of the object [60] for grasping the object [60]. Said embodiment may have one or more sensors [320] at least used for monitoring the force the actuator [110] is subject to. In addition, said embodiment may have one or more sensors [330] at least used for monitoring the pressure or vacuum level at the auxiliary suction interface [710]. Optionally, the embodiment may have one or more sensors [320] at least used for monitoring the force the actuator [110] is subject to. Optionally, the miniature protrusion [740] can be folded up, possibly passively or actively by zero or more actuator [140], which may or may not be the same actuator as [110], so that it does not prevent the auxiliary suction interface [710] from contacting with the object [60] to be grasped to form a seal.

### Auxiliary Grasping Device Can Articulate As a Whole

In yet another embodiment, an augmented grasping device [10] as in FIG. 11A and FIG. 11B comprises one primary grasping device [20] and at least one auxiliary grasping device [30]. Said auxiliary grasping device [30] has at least one auxiliary grasping interface [700] that can be extended or retracted by a actuator [110], and said auxiliary grasping device [30] is mounted in such a way that it may be articulated in a manner where the angle of said at least one auxiliary grasping interface [700] with respect to the central axis of the primary grasping device [20] or the central axis of a primary grasping interface [40] can change passively, or be controlled actively using the same actuator [110] or a separate actuator [150].

### Auxiliary Grasping Device With the Auxiliary Grasping Interface in the Form of a Sleeve

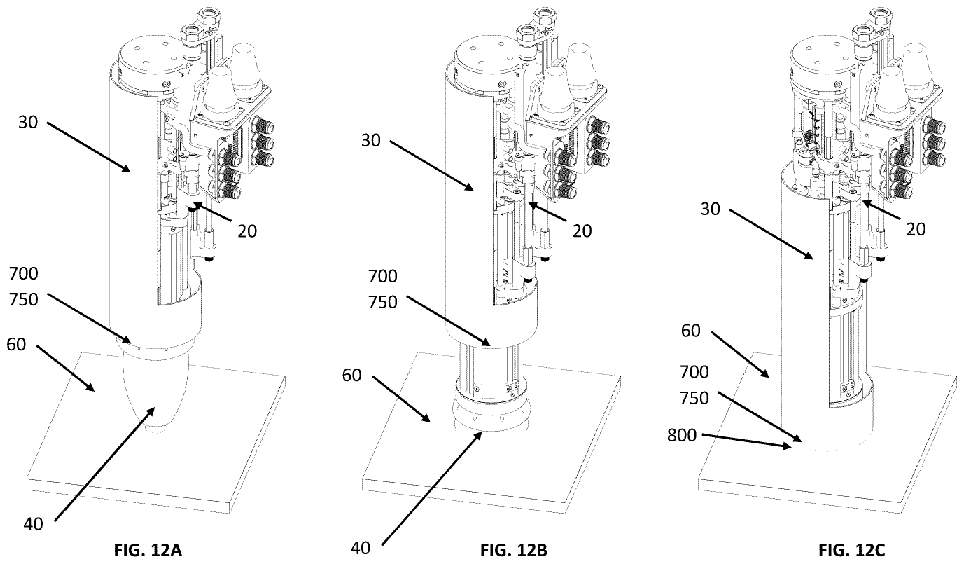

In yet another embodiment of an augmented grasping device [10] as in FIG. 12, the auxiliary grasping device [30] has an auxiliary grasping interface [700] in the form of a sleeve [750] surrounding the primary grasping device [20]. The sleeve [750] may or may not be actuated. The sleeve [750] could be used to provide objects [60] with additional contact points or auxiliary grasping area [800] to increase grasp strength or reduce object [60] oscillations and vibrations in the direction of contact between the object [60] and sleeve [750]. Furthermore, even if the sleeve [750] does not contact the object [60] when the augmented grasping device [10] is stationary, the sleeve [750] may still contact the object [60] when the augmented grasping device [10] is moving due to accelerations and movements introduced by the a robot, machine, automated equipment or intelligent system to which the augmented grasping device [10] is mounted, and yield some oscillation or vibration damping. The sleeve [750] may also be fitted with one or more suction devices that could be individually or collectively controlled. In the case where the sleave [750] is immovable, the primary grasping device [20] could operate in such a manner as to use at least one primary grasping interface [40] to pull an object [60] into contact with the sleeve [750] or, if the sleeve [750] is actuated, an actuator [100] could move the sleeve [750] into contact with the object [60].

### Rim Fixed Around the Primary Grasping Device for Object Stabilization

In yet another embodiment of an augmented grasping device [10], the primary grasping device [20] has a rim [21] fixed to its body surrounding at least one primary grasping interface [40]. After said primary grasping interface [40] grasps an object [60], said primary grasping interface [40] may be further actuated relative to the body of the primary grasping device [20] to pull said object [60] towards the rim [21]. By bringing the object [60] near or into contact with the rim [21], the contact between the rim [21] and the object [60] may reduce object [60] oscillations or vibrations while the augmented grasping device [10] is in motion.

### Alternative Construction of the Blade

In yet another embodiment of an augmented grasping device [10], the rotating protrusion [730] could be made from a single semi-rigid component, or a flexible linkage with attached spatula or similar means, that is capable of being kept near to and aligned with the primary grasping device [20] when not in use. When deployed, the rotating protrusion [730] could be slid downwards, substantially parallel to the central axis of the primary grasping device [20] or a primary grasping interface [40], and then rotated or bent towards a direction substantially perpendicular to the central axis of the primary grasping device [20] or a primary grasping interface [40] so that it slides under the object [60].

### Alternative Construction of the Blade

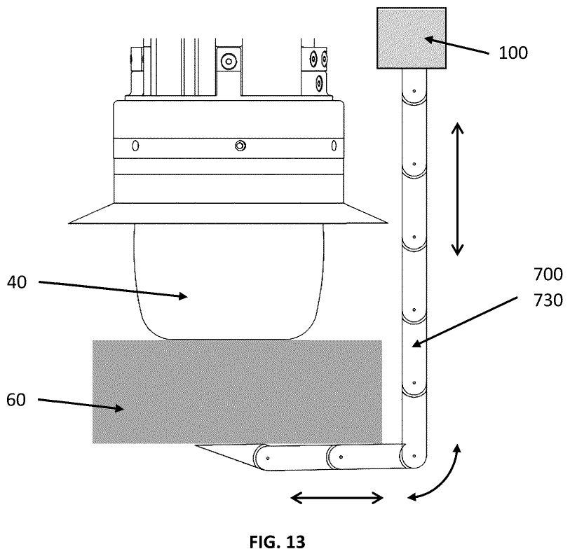

In yet another embodiment of an augmented grasping device [10] as in FIG. 13, the rotating protrusion [730] may be formed by a semi-rigid yet flexible device or linkage that restricts or directs the rotation of a spatula so that said rotating protrusion [730] may be bent or rotated only in the direction of a primary grasping interface [40]. In this case the motion of the rotating protrusion [730] is enabled by at least one actuator [100] that slides the rotating protrusion [730] towards the distal direction of the augmented grasping device [10]. The rotating protrusion [730] may be pre-stressed in such manner that the rotating protrusion [730] always rotates or flexes towards said primary grasping interface [40] or it may have a mechanical means of directing and limiting the motion of the rotating protrusion [730] such as a mechanical stop that prevents curvature away from said primary grasping interface [40] and the use of cables and or actuators [100] that directs the curvature of the rotating protrusion [730]. By lowering and flexing the rotating protrusion [730] into position and then bringing the rotating protrusion [730] towards said primary grasping interface [40] a pinching force is exerted on the object [60] being grasped.

### Grasping With the Primary Grasping Device and an Appendage Fixed Relative to the Primary Grasping Device

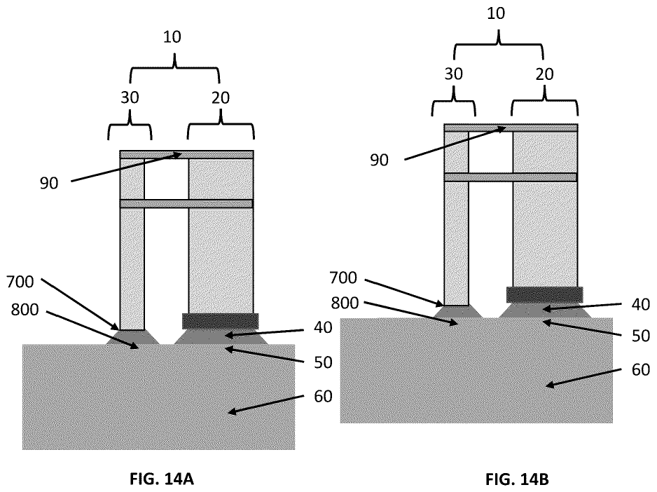

In one embodiment, a method for an augmented grasping device [10] with at least one auxiliary grasping device [30], whose at least one auxiliary grasping interface [700] is in a fixed position relative to a primary grasping interface [40] of the primary grasping device [20] of the augmented grasping device [10] as in FIG. 14A, to grasp, move, and place an object [60] is as follows and shown in FIG. 14:
a) The best pick point and orientation for the augmented grasping device [10] is determined by means that may include a manual (person-in-the-loop), machine vision, software, sensors or other methods.
b) Said augmented grasping device [10], with both at least one primary grasping interface [40] of the primary grasping device [20] and at least one auxiliary grasping interface [700] of at least one auxiliary grasping device [30], which may be attached to a robot, machine, automated equipment or intelligent system or by other such means are moved to the pick point and orientation determined in (a) as in FIG. 14A.
c) Said at least one primary grasping interface [40] of said primary grasping device [20] is activated to grasp the object [60]. Said at least one auxiliary grasping interface [700] may or may not be activated to provide at least one auxiliary grasping area [800] to grasp said object [60].
d) Said object [60] is lifted as in FIG. 14B, moved laterally and then placed in a desired position and orientation.
e) Said object [60] is released from the grasp of said augmented grasping device [10], that is from both said primary grasping device [20] and said at least one auxiliary grasping device [30].

### Grasping With the Primary Grasping Device and an Appendage That Can Move Axially Relative to the Primary Grasping Device

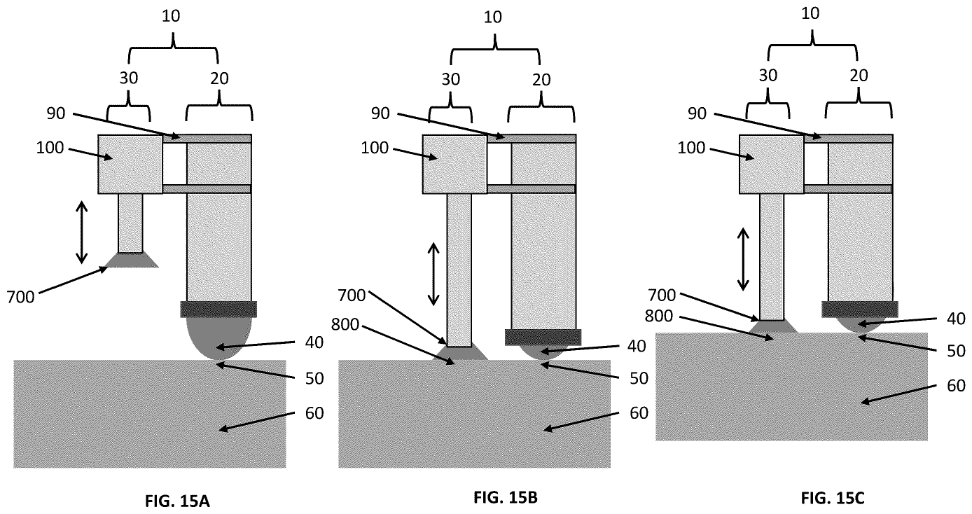

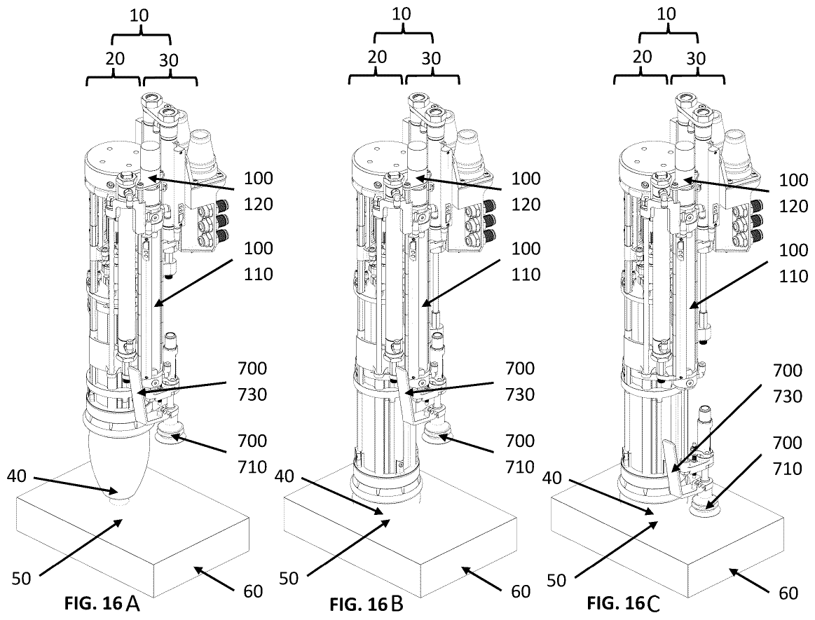

In yet another embodiment as in FIG. 15 or FIG. 16, a method for an augmented grasping device [10] in FIG. 1C with at least one auxiliary grasping device [30], whose at least one auxiliary grasping interface [700] can at least move close to one surface of the object [60], to grasp, move, and place an object [60] is as follows:
a) The best pick point and orientation for the augmented grasping device [10] is determined by means that may include manually or with a person-in-the-loop, machine vision, software, sensors or other methods.
b) Said augmented grasping device [10], with both at least one primary grasping interface [40] of the primary grasping device [20] and at least one auxiliary grasping interface [700] of at least one auxiliary grasping device [30], which may be attached to a robot, machine, automated equipment or intelligent system or by other such means are moved to the pick point and orientation determined in (a) as in FIG. 15A or FIG. 16A.
c) Said at least one primary grasping interface [40] of said primary grasping device [20] is activated to grasp the object [60] with at least one primary grasping area [50] as in FIG. 15B or FIG. 16B.
d) If desired, said at least one auxiliary grasping interface [700] of said at least one auxiliary grasping device [30] may already be in a position to contact said object [60] and provide at least one auxiliary grasping area [800] or, said at least one auxiliary grasping device [30] may be moved at least close to one surface of the object [60] in order to further bring said at least one auxiliary grasping interface [700] into contact with said object [60] to create at least one auxiliary grasping area [800] as in FIG. 15B or FIG. 16C.
e) Said at least one auxiliary grasping device [30] is activated and grasps said object [60] at one or more auxiliary grasping areas [800] separated from the primary grasping area [50].
f) Said object [60] is lifted as in FIG. 15C, moved laterally and then placed in a desired position and
g) Said object [60] is released from the grasp of said augmented grasping device [10], that is from both said primary grasping device [20] and said at least one auxiliary grasping device [30]. h) Said at least one auxiliary grasping device [30] along with said at least one auxiliary grasping interface [700] is moved away from said object [60].

### Grasping With the Primary Grasping Device and an Appendage Having a Revolute Joint

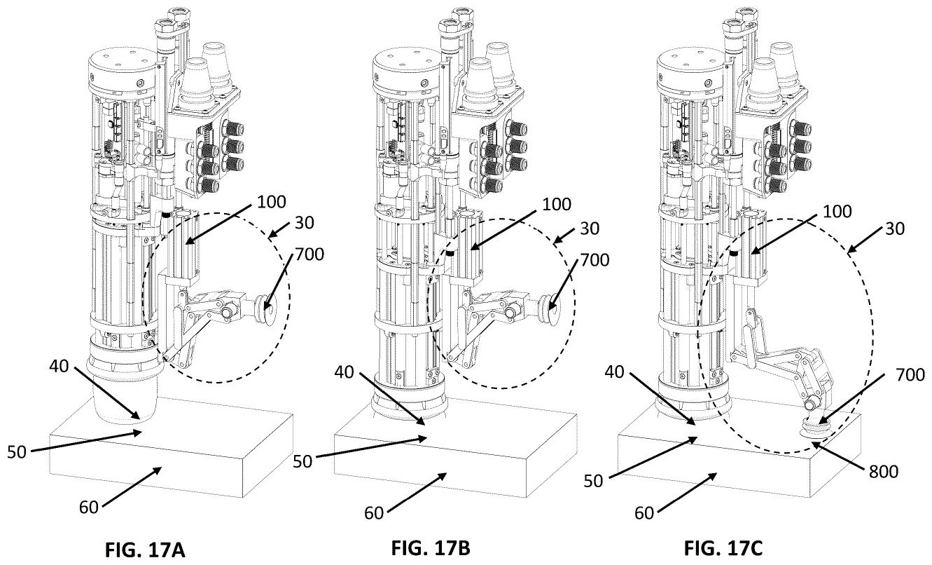

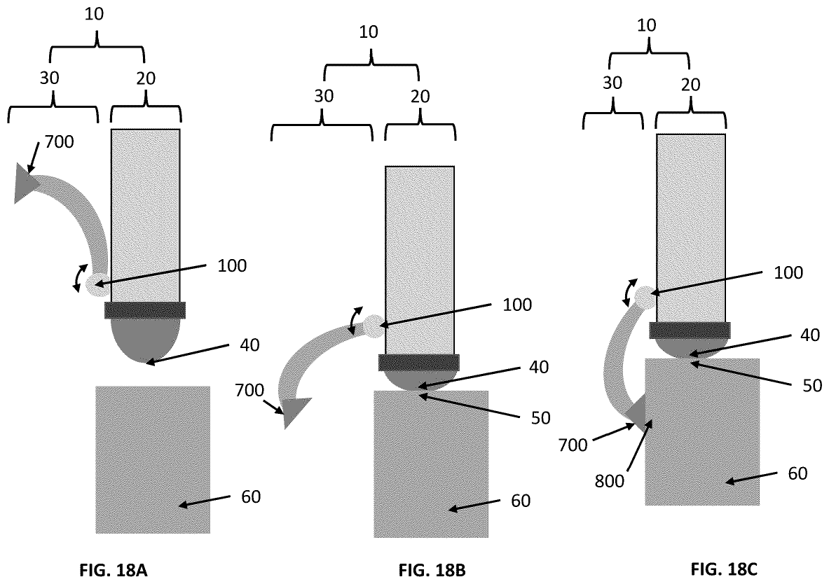

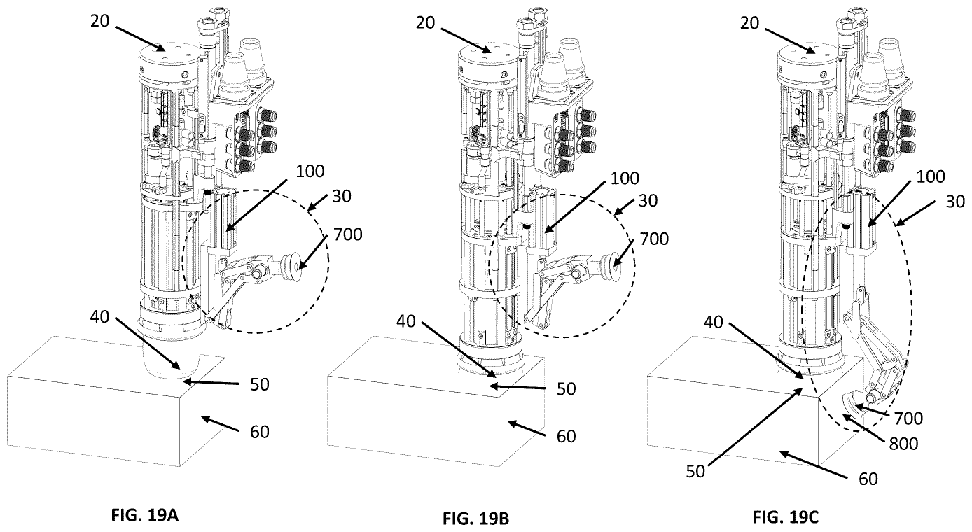

In yet another embodiment, a method for an augmented grasping device [10] in FIG. 2 with an auxiliary grasping device [30], whose auxiliary grasping interface [700] can change orientation relative to the primary grasping device [20] or a primary grasping interface [40], to grasp and move an object [60] is as follows and shown in FIG. 2, FIG. 17, FIG. 18 and FIG. 19:
a) The best pick point and orientation for the augmented grasping device [10] is determined by means that may include a manual method (person-in-the-loop), machine vision, software, sensors or other methods.
b) The augmented grasping device [10], with both at least one primary grasping interface [40] of the primary grasping device [20] and at least one auxiliary grasping interface [700] of at least one auxiliary grasping device [30], which may be attached to a robot, machine, automated equipment or intelligent system or by other such means are moved to the pick point and orientation determined in (a) as in FIG. 2A, FIG. 17A, FIG. 18A and FIG. 19A.
c) Said primary grasping interface [40] of said primary grasping device [20] is activated to grasp said object [60] at a primary grasping area [50] as in FIG. 2B, FIG. 17B, FIG. 18B and FIG. 19B.
d) If desired, said auxiliary grasping interface [700] may already be in a position to contact said object [60] and provide an auxiliary grasping area [800] or, it may be rotated by means of one or more actuators [100] relative to the central axis of said primary grasping device [20] or the central axis of said primary grasping interface [40] in order to bring said auxiliary grasping interface [700] into contact with said object [60], forming an auxiliary grasping area [800]. Said auxiliary grasping interface [700] may be placed on the same plane as the primary grasping interface [50] as in FIG. 2B and FIG. 17C, a perpendicular plane relative to the primary grasping plane as in FIG. 18B and FIG. 19C, or at some convenient angle, for example parallel, or location relative to the primary grasping area [800].
e) Said auxiliary grasping device [30] is activated and grasps said object [60] at an auxiliary grasping area [800] separated from the primary grasping area [50].
f) Said object [60] is lifted as in FIG. 2C and FIG. 18C, moved laterally and then placed in a desired position and orientation.
g) Said object [60] is released from the grasp of said primary gripper interface [40] and said auxiliary grasping interface [700].
h) Said auxiliary grasping device [30] is moved away from the primary grasping area [50] using one or more actuators [100].

### Grasping With the Primary Grasping Device and the Rotating Protrusion

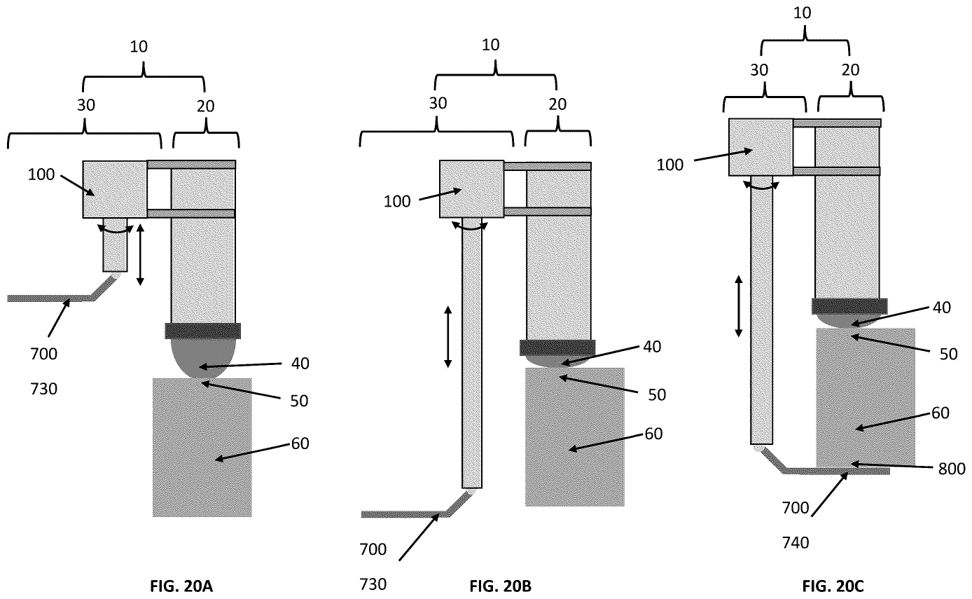

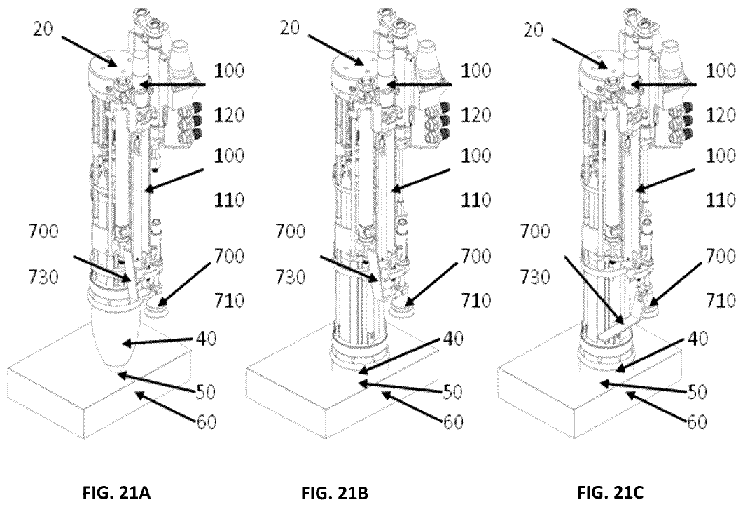

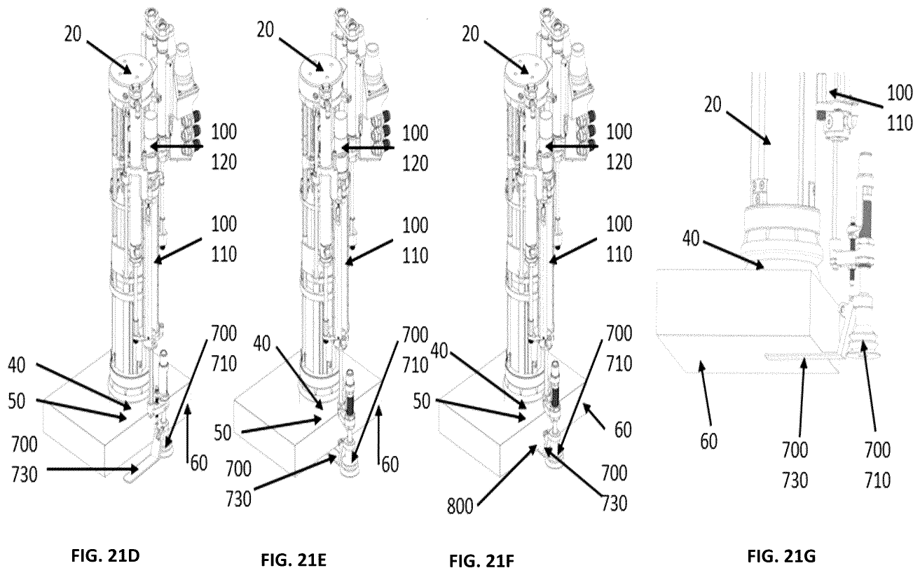

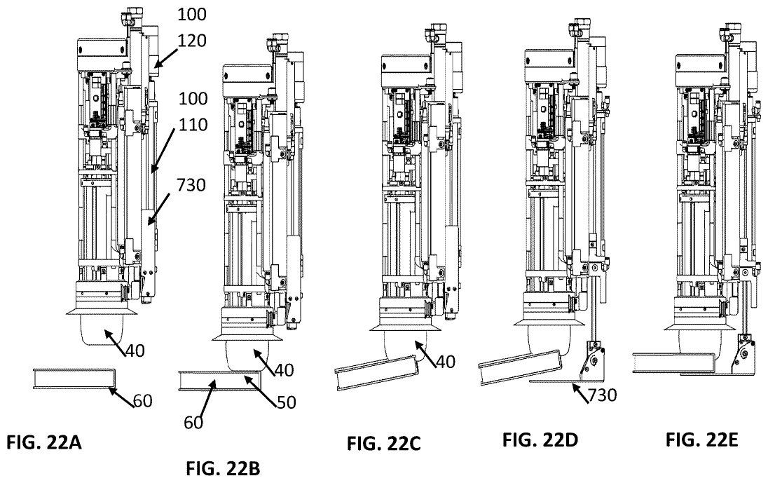

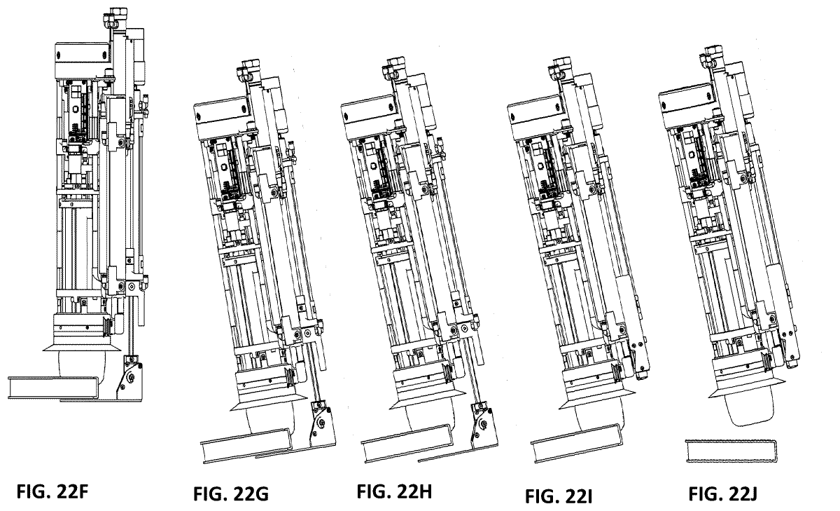

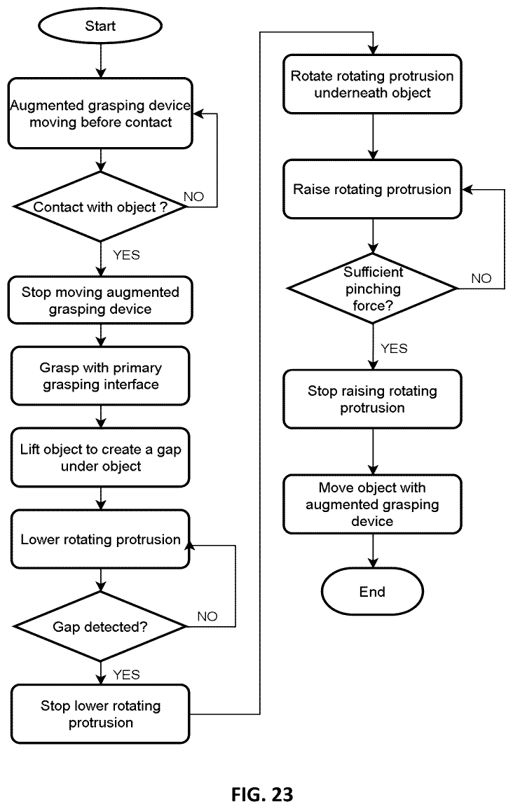

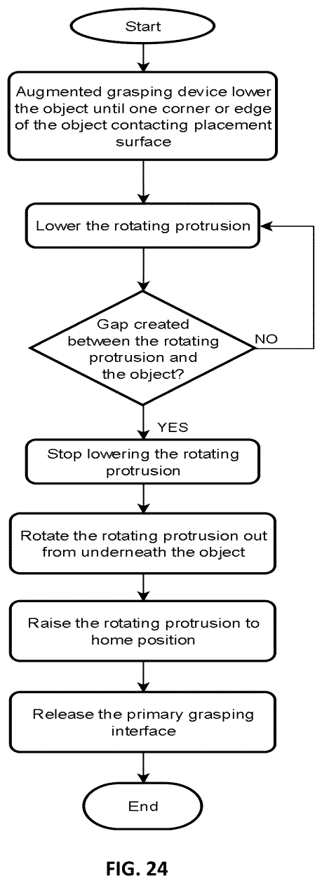

In yet another embodiment, a method for an augmented grasping device [10] with an auxiliary grasping device [30] having a rotating protrusion [730] to grasp, move and place an object [60] is as follows and shown in FIG. 20, FIG. 21, FIG. 22, FIG. 23, and FIG. 24:
a) The best pick point and orientation for the augmented grasping device [10] is determined by means that may include a manual (person-in-the-loop), machine vision, software, sensors or other methods.
b) The augmented grasping device [10], with both at least one primary grasping interface [40] of the primary grasping device [20] and at least one auxiliary grasping interface [700] of at least one auxiliary grasping device [30], which may be attached to a robot, machine, automated equipment or intelligent system or by other such means are moved to the pick point and orientation determined in (a) as in FIG. 20A, FIG. 21A, and FIG. 22B.
c) Said primary grasping interface [40] of said primary grasping device [20] is activated to grasp said object [60] at a primary grasping area [50] as in FIG. 20B and FIG. 21B, and FIG. 22B.
d) If needed, said rotating protrusion [730] is unfolded for deployment, with or without an actuator, as in FIG. 21C.
e) If needed, said object [60] is lifted, tilted or rotated, for example by said primary grasping interface [40], creating a gap between the bottom of said object [60] and the one or more items it rests on, so that the gap is sufficiently big to allow said rotating protrusion [730] to fit between said object [60] and the item it rests on, as in FIG. 22C.
f) If desired, said rotating protrusion [730] on said auxiliary grasping device [30] may already be in a position to rotate into the gap under said object [60] without obstruction. Or said rotating protrusion [730] may be moved by means of at least one actuator [100] to a position that would allow said rotating protrusion [730] to rotate under said object [60] without obstruction, as in FIG. 21D.
g) Said rotating protrusion [730] is rotated [150] under said object [60] as in FIG. 20C, FIG. 21E, and FIG. 22D.
h) At least one actuator [100] is used to move said rotating protrusion [730] towards said primary grasping interface [40] so that it contacts with said object [60] and reaches a position that allows said rotating protrusion [730] to provide, at a minimum an auxiliary grasping area [800] to said object [60] and, at best, a sufficient pinching force between said rotating protrusion [730] and said primary grasping interface [40] as in FIG. 20C, FIG. 21F, FIG. 21G, and FIG. 22E.
i) Said object [60] is then lifted, moved laterally to above the desired placement position on a placement surface in FIG. 22F. The grasping process from (a) to (i) is also presented in FIG. 23.
j) Said object [60] is lowered towards said placement surface until an edge or a corner of said object [60] touches said placement surface, as in FIG. 22G.
k) At least one actuator [100] is used to create sufficient space between said object [60] and said rotating protrusion [730] as in FIG. 22H to allow said rotating protrusion [730] to rotate out from under said object [60] as in FIG. 221.
l) Said object [60] is released from the grasp of said primary grasping interface [40], and said rotating protrusion [730] is then retracted, by means of at least one actuator [100] towards the proximal direction of said augmented grasping device [10] as in FIG. 22J. The releasing process from (j) to (I) is also presented in FIG. 24.

### Applications of the Rotating Protrusion Grasping Methods

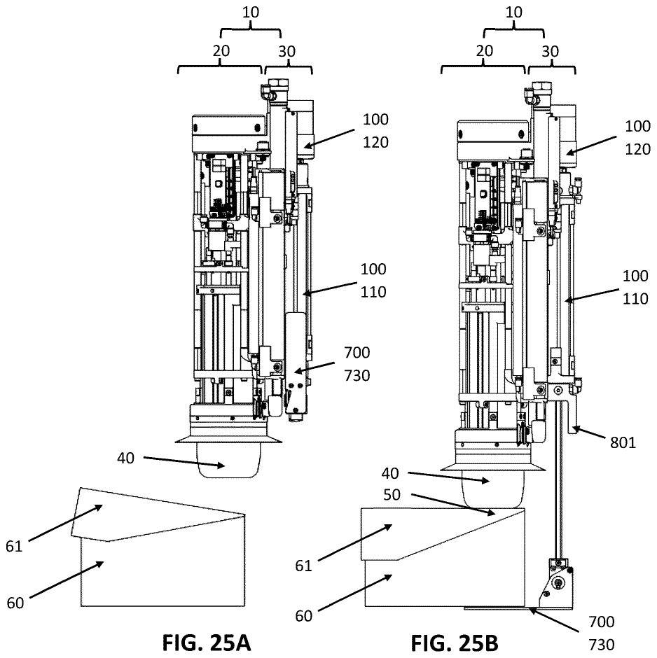

The method described herein may be used to grasp items such as books, boxes or bags. In particular, when used to grasp books as in FIG. 22, the method described in herein may ensure that the book remains closed and intact (e.g., the dust jacket remains in place) during motion introduced by a robot, machine, automated equipment or intelligent system to which the augmented grasping device [10] is mounted. In the case of boxes, in particular tuck-lid or telescoping boxes, the pinching action provided by the rotating protrusion [730] may be used to aid in holding the box closed during motion. For example, the lid [61] of a box [60] is kept closed by the rotating protrusion [730] when the box is held by the augmented grasping device [10] as shown in FIG. 25.

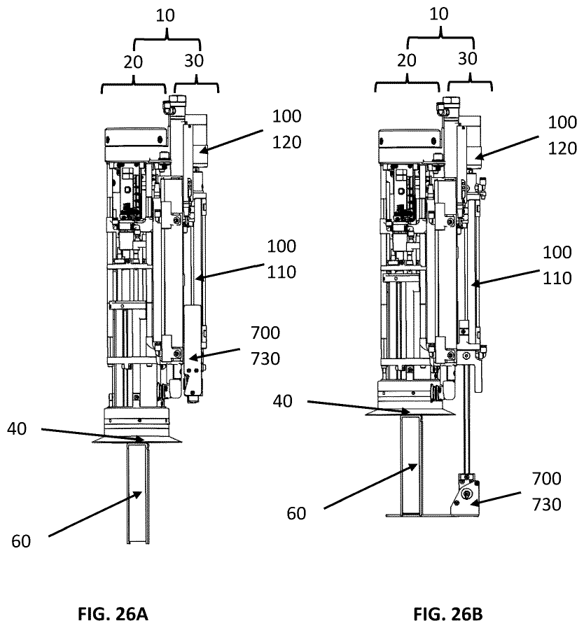

In yet another embodiment, a method for an augmented grasping device [10] with an auxiliary grasping device [30] having a rotating protrusion [730] to grasp an object [60] that is relatively tall but narrow, for example a book that is standing with its binding facing up, to help reducing oscillations and vibrations, is as follows and shown in FIG. 26:
a) The best pick point and orientation for the augmented grasping device [10] is determined by means that may include a manual (person-in-the-loop), machine vision, software, sensors or other methods, such that the best pick point is on the top surface of the object [60]. For example, the pick point is chosen to be on the binding of the book and the picking orientation is such that the primary grasping interface [40] is pointing downward.
b) The augmented grasping device [10], with both at least one primary grasping interface [40] of the primary grasping device [20] and at least one auxiliary grasping interface [700] of at least one auxiliary grasping device [30], which may be attached to a robot, machine, automated equipment or intelligent system or by other such means are moved to the pick point and orientation determined in (a) as in FIG. 26A.
c) Said primary grasping interface [40] of said primary grasping device [20] is used to grasp said object [60] at a primary grasping area [50] as in FIG. 26A.
d) If needed, said rotating protrusion [730] is unfolded for deployment, with or without an actuator.
e) If needed, said object [60] is lifted, tilted or rotated, for example by said primary grasping interface [40], sufficiently to allow said rotating protrusion [730] to fit between said object [60] and the one or more items it rests on.
f) If desired, said rotating protrusion [730] on said auxiliary grasping device [30] may already be in position to rotate under said object [60]. Or said rotating protrusion [730] may be moved by means of at least one actuator [100] to a position that would allow said rotating protrusion [730] to rotate under said object [60].
g) Said rotating protrusion [730] is rotated [150] under said object [60].
h) At least one actuator [100] is used to move said rotating protrusion [730] into contact with said object [60] and into a position that allows at least one actuator [100] to provide, at a minimum, auxiliary grasping area [800] to the object [60] and, at best, a sufficient pinching force between said rotating protrusion [730] and said primary grasping interface [40] as in FIG. 26B.
i) Said object [60] is now grasped and ready to be moved. It is noted that with the tall and narrow object [60] grasped by both the top face by said primary grasping interface [40] and the bottom by said rotating protrusion [730], said tall and narrow object [60] can be securely grasped with reduced oscillations and vibrations during motion.

### Grasping by Pinching the Object Between the Primary and Auxiliary Grasping Devices on the Side

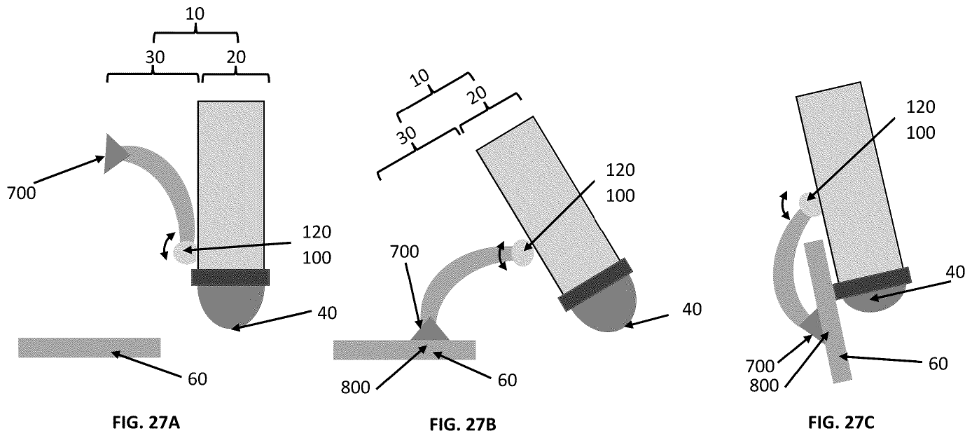

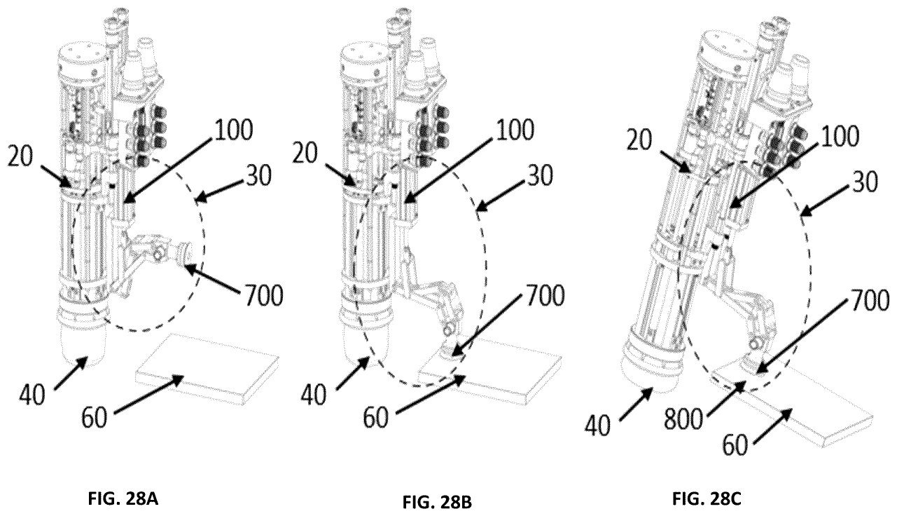

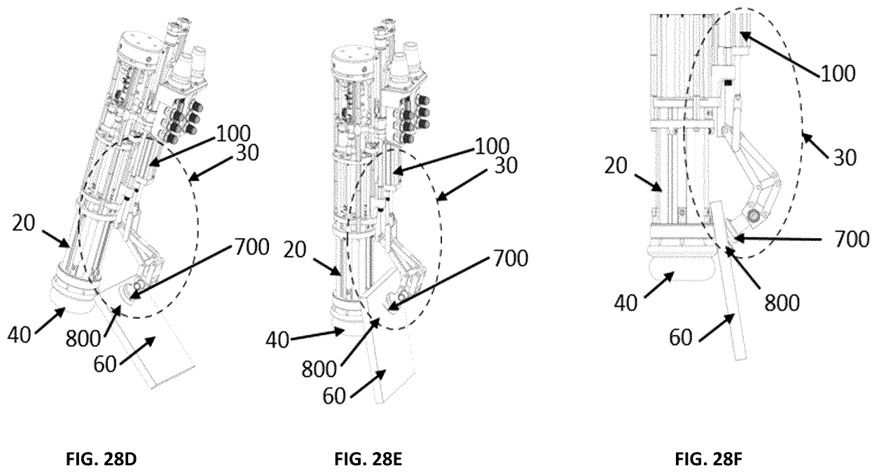

In yet another embodiment as in FIG. 2, a method for an augmented grasping device [10] with an auxiliary grasping device [30] whose orientation can change relative to the central axis of the primary grasping device [20] or the central axis of a primary grasping interface [40] to grasp and move an object [60] is as follows and shown in FIG. 27 and FIG. 28:
a) The best pick point and orientation for the augmented grasping device [10] is determined by means that may include a manual (person-in-the-loop), machine vision, software, sensors or other methods.
b) The augmented grasping device [10], with both at least one primary grasping interface [40] of the primary grasping device [20] and at least one auxiliary grasping interface [700] of at least one auxiliary grasping device [30], which may be attached to a robot, machine, automated equipment or intelligent system or by other such means are moved to the pick point and orientation determined in (a) as in FIG. 27A and FIG. 28A.
c) Said auxiliary grasping interface [700] is used to grasp said object [60] as in FIG. 27B and FIG. 28B.
d) Said auxiliary grasping interface [700] is used to pull said object [60] near to said primary grasping device [20] as in FIG. 28C and FIG. 28D, and a pinching force is created between the body of said primary grasping device [20] and said auxiliary grasping interface [700] as in FIG. 27C, FIG. 28E and FIG. 28F. Said primary grasping interface [40] may be activated or may be in the neutral position. Alternatively, said auxiliary grasping interface [700] could hold said object [60] while said primary grasping device [20] is brought near said auxiliary grasping interface [700] to support or pinch said object [60].
e) Said object [60] is lifted, moved laterally and then placed in a desired position and orientation.
f) The pinching grip on said object [60] is released by moving said auxiliary grasping interface [700] away from the body of said primary grasping device [20]. At this point, said object [60] may be further manipulated by said auxiliary grasping device [30] before being released or it may be released immediately.
g) Said auxiliary grasping device [30] is moved away from said primary grasping device [20] using one or more actuators [100].

### Object Oscillation Reduction—Boxes

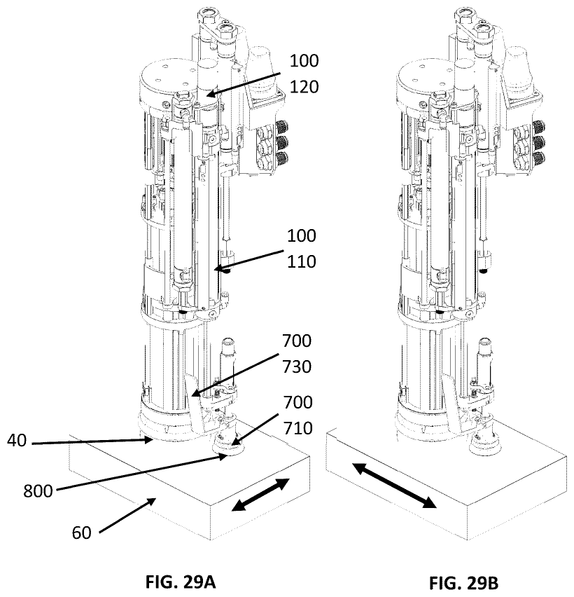

In yet another embodiment as in FIG. 29A, the auxiliary grasping device [30] is used to reduce object [60] oscillations and vibrations during motion. When the object [60] is a box-like object [60], the position of the auxiliary grasping interface [700] of an auxiliary grasping device [30] may be oriented or located in any direction with respect to the motion of the augmented grasping device [10] and the motion of the robot, machine, automated equipment or intelligent system to which the augmented grasping device [10] is mounted. However, having said auxiliary grasping interface [700] located nearly perpendicular to the path of the augmented grasping device [10] being moved by a robot, machine, automated equipment or intelligent system may result in an ability to move a box-like object [60] with a higher rate of acceleration than in other orientations.

### Object Oscillation Reduction—Bags

In yet another embodiment as in FIG. 29B, the auxiliary grasping device [30] is used to reduce object [60] oscillations and vibrations during motion. When the object [60] is enclosed within a bag, the position of the auxiliary grasping interface [700] of an auxiliary grasping device [30] may be oriented or located in any direction with respect to the motion of the augmented grasping device [10] and the motion of the robot, machine, automated equipment or intelligent system to which the augmented grasping device [10] is mounted. However, having said auxiliary grasping interface [700] located nearly aligned with the path of the augmented grasping device [10] being moved by a robot, machine, automated equipment or intelligent system may result in an ability to move a bagged object [60] with a higher rate of acceleration than in other orientations.

### Grasping With Appendage Alone to Reach Small Items in Confined Spaces

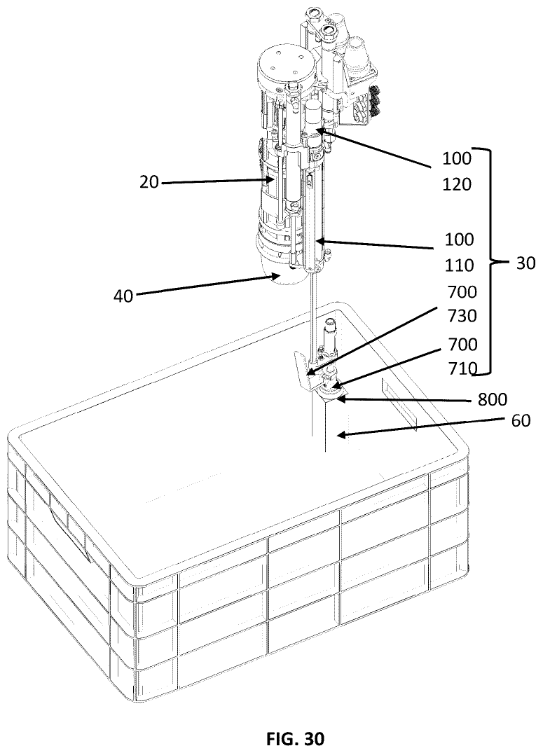

In yet another embodiment as in FIG. 30, an auxiliary grasping device [30] is used to grasp objects [60] that are located in spaces or areas that are difficult for the primary grasping device [20] or the primary gripping interface [40] to reach, for example near the edge or corner of a bin or within a partitioned bin. In this case, the primary grasping device [20] or the primary gripping interface [40] may be stopped at some distance from an object [60] and an auxiliary grasping interface [700] on said auxiliary grasping device [30] may be brought near or into contact with said object [60] using one or more actuators [100] before grasping is initiated. Once said auxiliary grasping interface [700] has been activated and grasped the object [60], if desired, said auxiliary grasping interface [700] may be brought back near said primary grasping interface [40] of said primary grasping device [20] and grasped by said primary grasping interface [40].

Methods for Grasping with the Primary Grasping Device and Side Cup

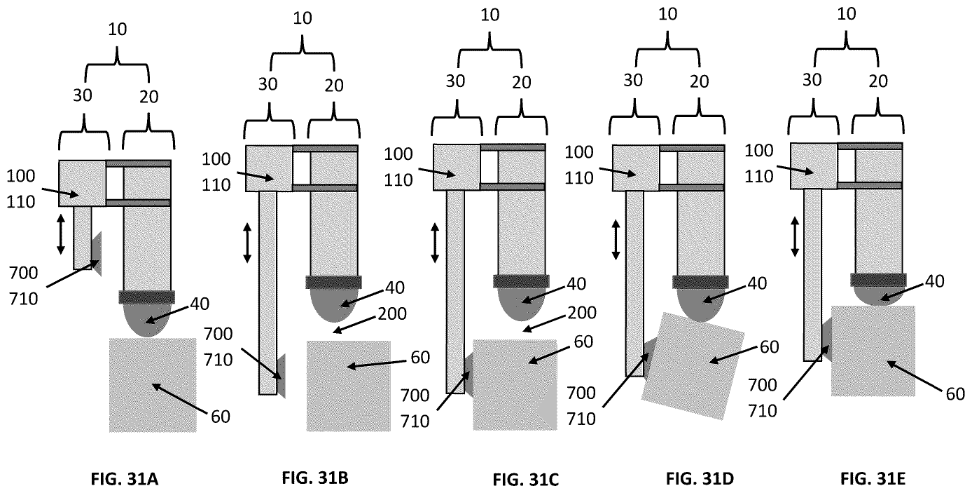

In yet another embodiment as in FIG. 31A, an augmented grasping device [10] comprises a primary grasping device [20] and one auxiliary grasping device [30], in which the auxiliary grasping device [30] has one auxiliary grasping interface [700] in the form of one auxiliary suction interface [710] substantially facing the central axis of the primary grasping device [20] or the central axis of a primary grasping interface [40]. Said auxiliary suction interface [710] is positionally controlled relative to said primary grasping interface [40]. For example, it can move, in a controlled manner, at least close to one surface of the object [60] by an actuator [110].

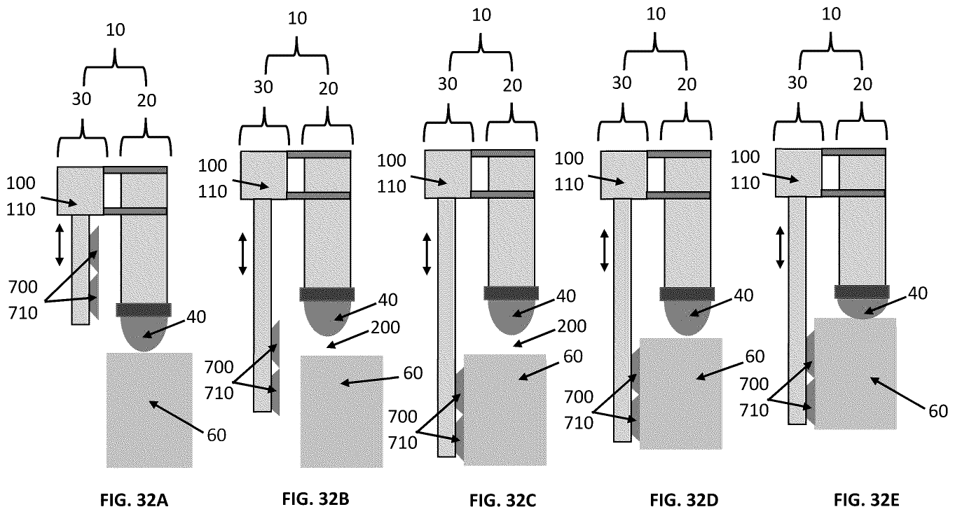

In yet another embodiment as in FIG. 32A, an augmented grasping device [10] comprises a primary grasping device [20] and one auxiliary grasping device [30], in which the auxiliary grasping device [30] has more than one auxiliary grasping interfaces [700] in the form of more than one auxiliary suction interfaces [710] facing towards a direction which is different from or substantially perpendicular to the one defined by the central axis of a primary grasping interface [40]. Said auxiliary suction interfaces [710] is positionally controlled relative to said primary grasping interface [40]. For example, it can move, in a controlled manner, at least close to one surface of the object [60] by an actuator [110].

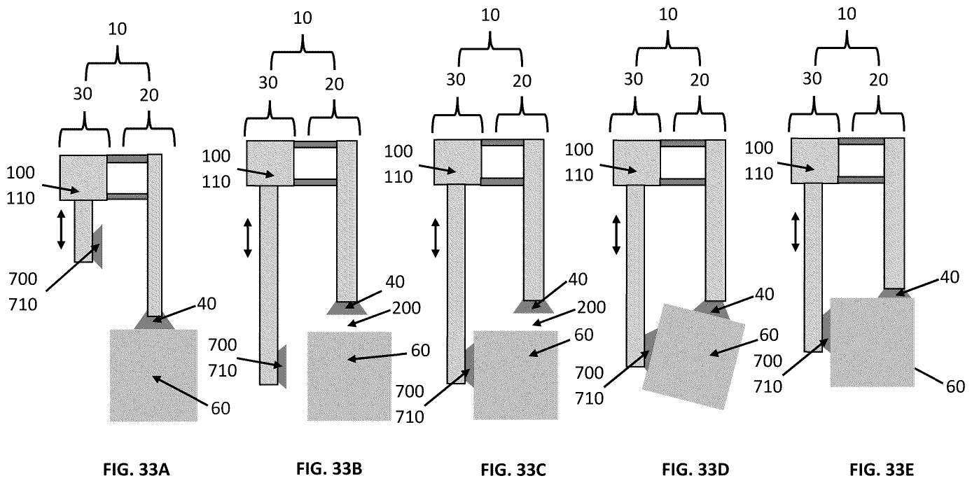

In yet another embodiment as in FIG. 33A, an augmented grasping device [10] comprises a primary grasping device [20] and one auxiliary grasping device [30]. Said primary grasping device [20] has one primary grasping interface [40] in the form of one suction device. And said auxiliary grasping device [30] has one auxiliary grasping interface [700] in the form of one auxiliary suction interface [710] facing towards a direction which is different from or substantially perpendicular to the one defined by the central axis of the primary grasping device [20] or the central axis of said primary grasping interface [40]. Said auxiliary suction interface [710] is positionally controlled relative to said primary grasping interface [40]. For example, it can move, in a controlled manner, at least close to one surface of the object [60] by an actuator [110].

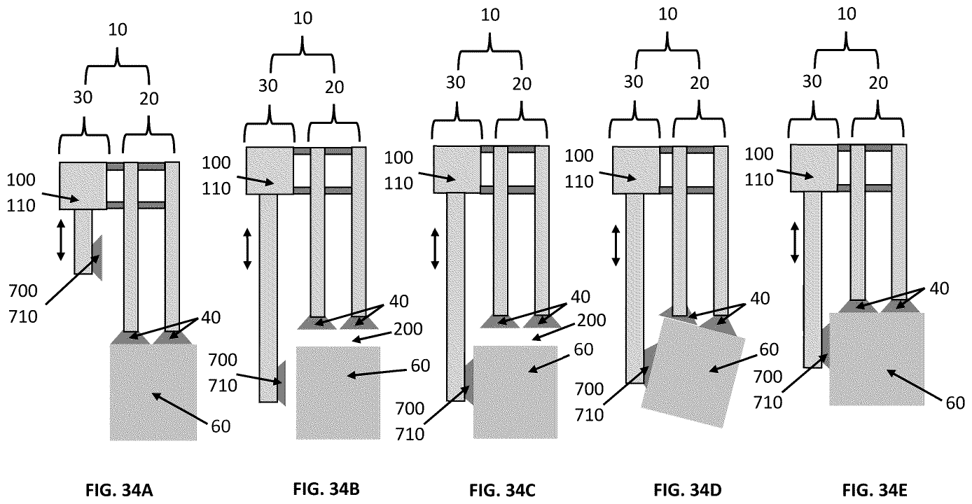

In yet another embodiment as in FIG. 34A, an augmented grasping device [10] comprises a primary grasping device [20] and one auxiliary grasping device [30]. Said primary grasping device [20] has more than one primary grasping interfaces [40] in the form of more than one suction devices. And said auxiliary grasping device [30] has one auxiliary grasping interface [700] in the form of one auxiliary suction interface [710] substantially facing the axis of the primary grasping device [20] or the at least one primary grasping interface [40] . Said auxiliary suction interface [710] is positionally controlled relative to said grasping device [20]. For example, it can move, in a controlled manner, at least close to one surface of the object [60] by an actuator [110].

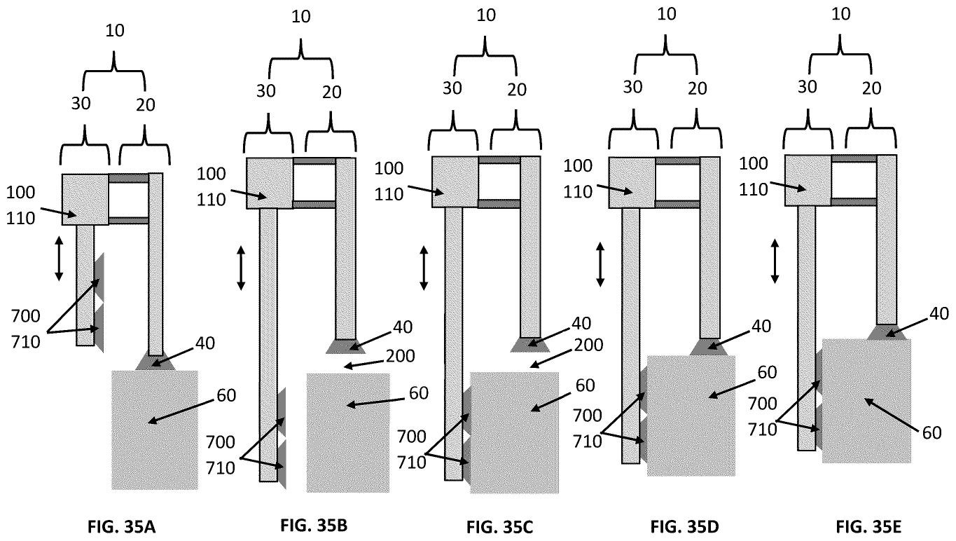

In yet another embodiment as in FIG. 35A, an augmented grasping device [10] comprises a primary grasping device [20] and one auxiliary grasping device [30]. Said primary grasping device [20] has one primary grasping interface [40] in the form of one suction device. And said auxiliary grasping device [30] has more than one auxiliary grasping interfaces [700] in the form of more than one auxiliary suction interfaces [710] facing towards a direction which is different from or substantially perpendicular to the one defined by the central axis of said primary grasping device [20] or the central axis of said primary grasping interface [40]. Said auxiliary suction interfaces [710] is positionally controlled relative to said primary grasping interface [40]. For example, it can move, in a controlled manner, at least close to one surface of the object [60] by an actuator [110].

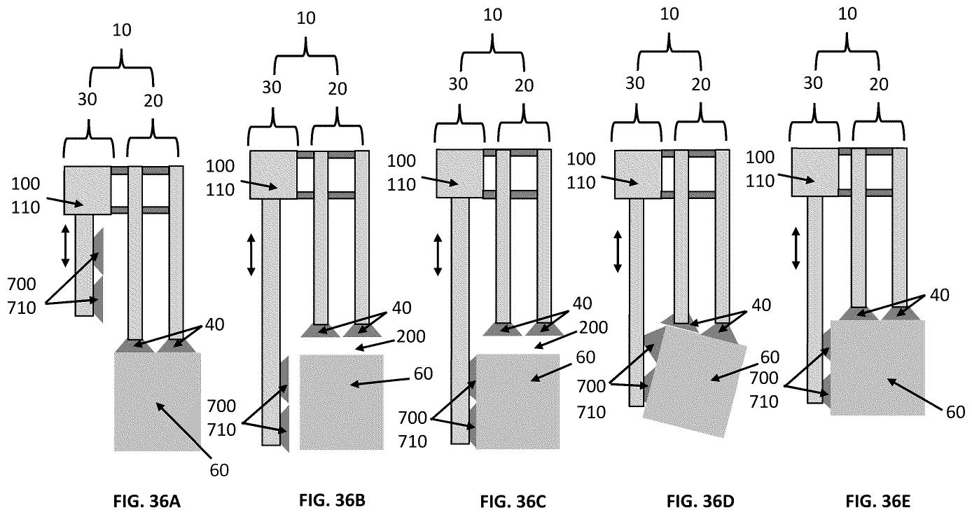

In yet another embodiment as in FIG. 36A, an augmented grasping device [10] comprises a primary grasping device [20] and one auxiliary grasping device [30]. Said primary grasping device [20] has more than one primary grasping interfaces [40] in the form of more than one suction devices. And said auxiliary grasping device [30] has more than one auxiliary grasping interfaces [700] in the form of more than one auxiliary suction interfaces [710] substantially facing the axis of the primary grasping device [20]. Said auxiliary suction interfaces [710] is positionally controlled relative to said primary grasping device [20]. For example, it can move, in a controlled manner, at least close to one surface of the object [60] for grasping the object [60] by an actuator [110] .

A method for grasping objects [60] such as boxes with the lid hinged on one side or boxes with a lid that is unfastened, hinged on one side, or hinged on one side and fastened or where grasping the box could result in the box opening during grasping, motion or placing the object using the augmented grasping devices [10] shown in FIG. 31A, FIG. 32A, FIG. 33A, FIG. 34A, FIG. 35A and FIG. 36A is described as follows, and the process is shown in FIG. 31, FIG. 32, FIG. 33, FIG. 34, FIG. 35, and FIG. 36.

a) When grasping these types of objects, at least one primary grasping interface [40] of the primary grasping device [20] is moved into initial contact with the object [60] with the auxiliary grasping device located in a position where at least one of its auxiliary suction interfaces [710] may be extended alongside one edge of the object [60] as in FIG. 31A, FIG. 32A, FIG. 33A, FIG. 34A, FIG. 35A and FIG. 36A.
b) At least one primary grasping interface [40] is then lifted slightly to create a gap [200] between said object [60] and said at least one primary grasping interface [40].
c) At the same time, or at some later time, that the gap [200] is being created between said at least one primary grasping interface [40] and the top of said object [60], said at least one auxiliary suction interface [710] of said auxiliary grasping device [30] can be extended substantially towards the distal direction of the augmented grasping device [10] by an actuator [110] until such time that said at least one auxiliary suction interface [710] has a clear path towards the side of said object [60] as in FIG. 31B, FIG. 32B, FIG. 33B, FIG. 34B, FIG. 35B and FIG. 36B.
d) At the same time as said at least one auxiliary suction interface [710] is undergoing relative motion with respect to said at least one primary grasping interface [40], or at some later time, said auxiliary grasping device [30] is activated creating a suction force at said at least one auxiliary suction interface [710].
e) Once said auxiliary grasping device [30] has been activated, said augmented grasping device [10] is moved laterally so that said at least one auxiliary suction interface [710] of said auxiliary grasping device [30] is moved into contact with the side of said object [60] as in FIG. 31C, FIG. 32C, FIG. 33C, FIG. 34C, FIG. 35C and FIG. 36C.
f) Once contact is detected, using vacuum suction monitoring, force detection or some other means, the lateral motion of said augmented grasping device [10] is stopped. If no contact is detected before traveling some lateral distance, the pick is abandoned.
g) If contact is detected, said auxiliary grasping device [30] is moved towards the proximal direction of said augmented grasping device [10] relative to said at least one primary grasping interface [40], lifting the side of said object [60] until the top of said object [60] contacts said at least one primary grasping interface [40] as in FIG. 31D, FIG. 32D, FIG. 33D, FIG. 34D, FIG. 35D and FIG. 36D.
h) And said object [60] is then grasped also by the primary grasping interface [40] as in FIG. 31E, FIG. 32E, FIG. 33E, FIG. 34E, FIG. 35E and FIG. 36E and moved.

### Methods for Grasping and Releasing Boxes With Gripper, Side Cup, and Blade

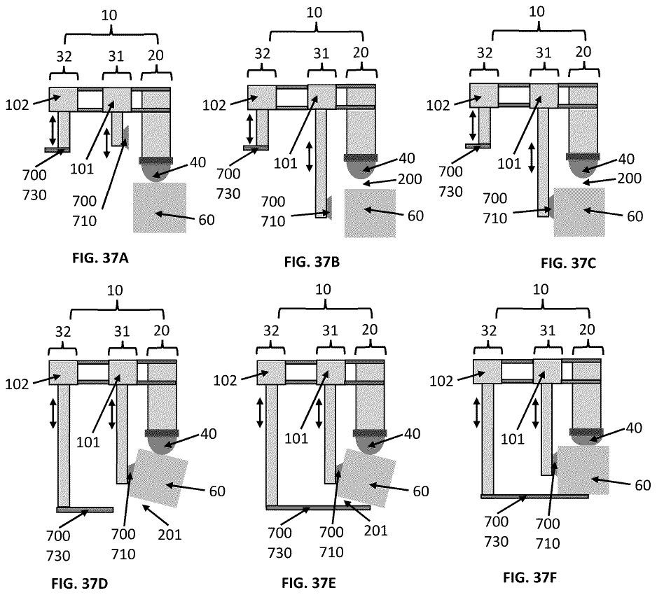

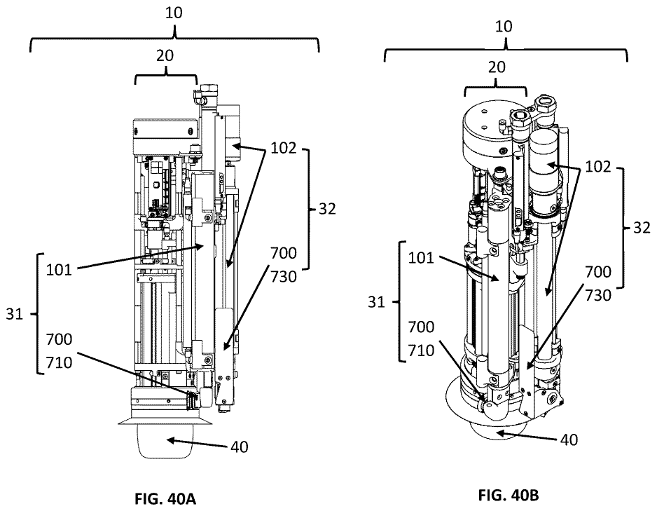

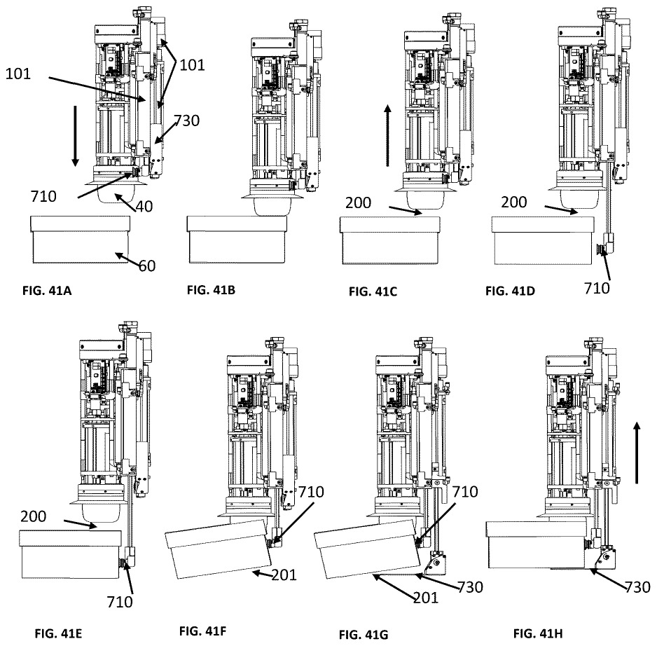

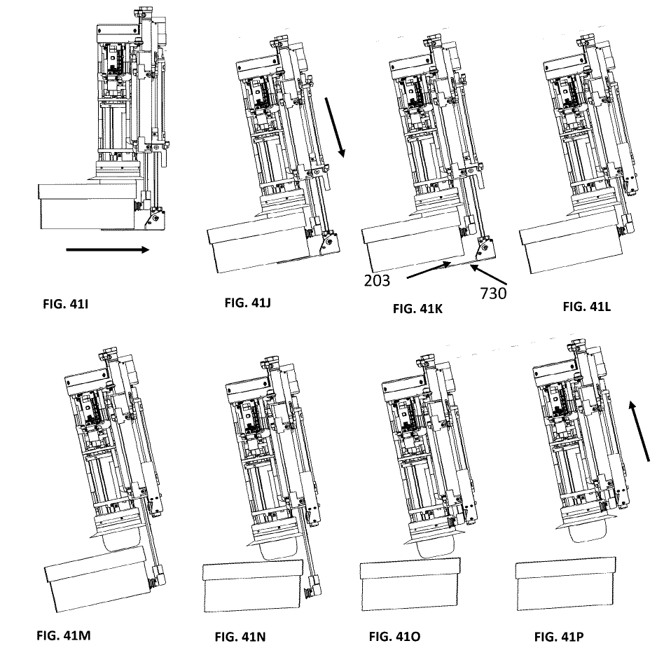

In yet another embodiment as in FIG. 37A, an augmented grasping device [10] comprises a primary grasping device [20], a first auxiliary grasping device [31], and a second auxiliary grasping device [32]. Said first auxiliary grasping device [31] has one auxiliary grasping interface [700] in the form of one auxiliary suction interface [710] facing towards a direction which is different from or substantially perpendicular to the one defined by the central axis of the primary grasping device [20] or the central axis of a primary grasping interface [40]. Optionally, said auxiliary suction interface [710] is facing towards a direction that is substantially parallel to the central axis of at least one primary grasping interface [40]. Said auxiliary suction interface [710] is positionally controlled relative to said primary grasping interface [40]. Specifically, it can move close to one surface of an object [60] for grasping the object [60]. The second auxiliary grasping device [32] has one auxiliary grasping interface [700] in the form of one rotating protrusion [730]. Said rotating protrusion [730] is positionally controlled relative to said primary grasping interface [40]. Specifically, said rotating protrusion [730] can move beyond the distal end [28] of the primary grasping device [20] and below the object [60] and rotate around an axis substantially parallel to the central axis of said primary grasping interface [40] by one or more actuators [102]. A more detailed implementation of the embodiment in FIG. 37A is shown in FIG. 40.

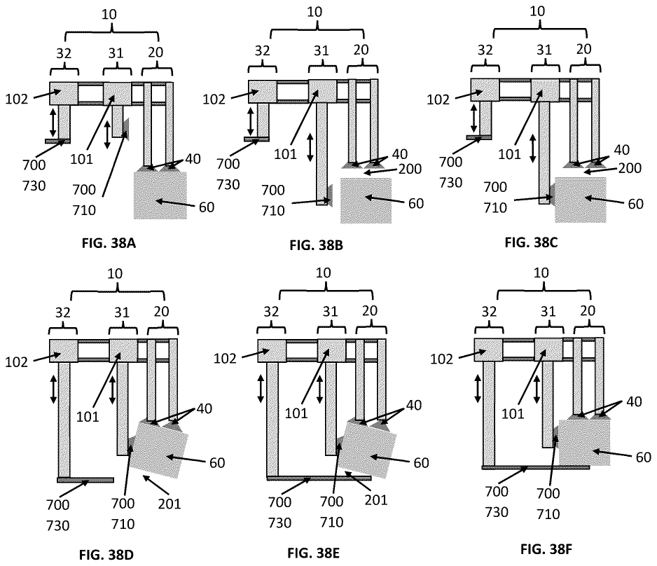

In yet another embodiment as in FIG. 38A, an augmented grasping device [10] comprises a primary grasping device [20], a first auxiliary grasping device [31], and a second auxiliary grasping device [32]. It is different from the embodiment in FIG. 37A that the primary grasping device [20] in FIG. 38A has more than one primary grasping interface [40] in the form of more than one suction interface.

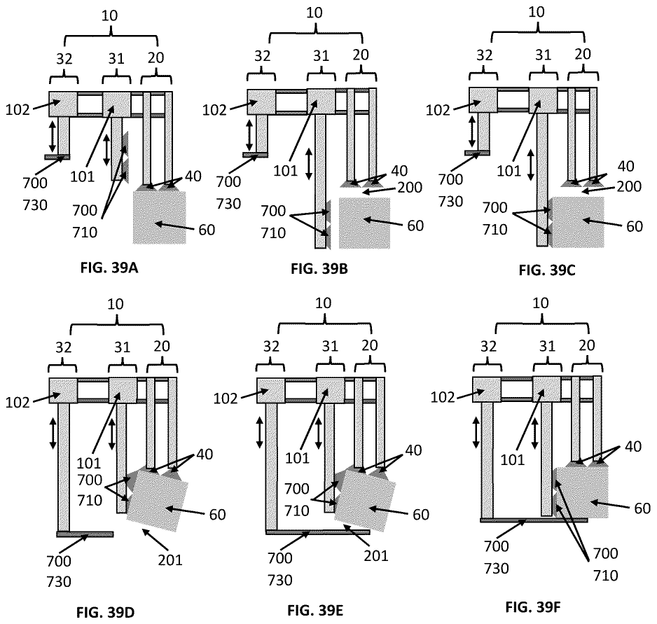

In yet another embodiment as in FIG. 39A, an augmented grasping device [10] comprises a primary grasping device [20], a first auxiliary grasping device [31], and a second auxiliary grasping device [32]. It is different from the embodiment in FIG. 38A that the first auxiliary grasping device [31] has more than one auxiliary grasping interface [700] in the form of more than one auxiliary suction interface [710] facing towards a direction which is different from or substantially perpendicular to the one defined by the central axis of the primary grasping device [20] or the central axis of a primary grasping interface [40].

A method for grasping objects [60], especially those such as shoe boxes with the lid attached on one side or boxes with a lid that is loose and could be considered to be telescopic, or where grasping the box could result in the box opening during grasping, motion or placing the object, using an augmented grasping device [10] shown in FIG. 37A, FIG. 38A, FIG. 39A, and in FIG. 40 is described as follows and shown in FIG. 37, FIG. 38, FIG. 39, and FIG. 41.
a) When grasping these types of objects [60], the initial state is shown in FIG. 41A where at least one primary grasping interface [40] of the primary grasping device [20] is above the object [60], and with the auxiliary grasping devices [31] and [32] located in positions where at least one auxiliary suction interface [710] and the rotating protrusion [730] may be extended alongside one edge of the object [60].
b) Then said at least one primary grasping interface [40] of said primary grasping device [20] of said augmented grasping device [10] is moved into initial contact with the object [60] with said first auxiliary grasping device [31] located in a position where at least one auxiliary suction interface [710] may be extended alongside one edge of said object [60] as in FIG. 37A, FIG. 38A, FIG. 39A, and FIG. 41B.
c) Said at least one primary grasping interface [40] is then lifted slightly to create a gap [200] between said object [60] and said at least one primary grasping interface [40] as in FIG. 37B, FIG. 38B, FIG. 39B, and FIG. 41C.
d) At the same time, or at some later time, that the gap [200] is being created between said at least one primary grasping interface [40] and said object [60], said at least one auxiliary suction interface [710] of said first auxiliary grasping device [31] can be moved by an actuator [101] until such time that said at least one auxiliary suction interface [710] has a clear path towards the side of said object [60] as in FIG. 41D.
e) Said augmented grasping device [10], with said at least one auxiliary suction interface [710] of said first auxiliary grasping device [31] extended, is moved laterally to bring said at least one auxiliary suction interface [710] into contact with the side of said object [60] as in FIG. 37C, FIG. 38C, FIG. 39C, and FIG. 41E.
f) Before, at the same time, or, at some later time, as said augmented grasping device [10] is undergoing lateral motion, said first auxiliary grasping device [31] can be activated to generate suction at said at least one auxiliary suction interface [710].
g) Once contact between said at least one auxiliary suction interface [710] and said object [60] is detected, using vacuum suction monitoring, force detection or some other means, the lateral motion of said augmented grasping device [10] is stopped and said object is grasped by said at least one auxiliary suction interface [710]. If no contact is detected before traveling some maximum lateral distance, the pick is abandoned.
h) If contact is detected, said first auxiliary grasping device [31] is used to lift the side of said object [60] until the top of said object [60] contacts said at least one primary grasping interface [40] and said primary grasping device [20] grasps said object. With sufficient lifting of one side of said object [60], a gap [201] under the lifted side of said object [60] is created as in FIG. 41F.
i) Said second auxiliary grasping device [32] then moves the rotating protrusion [730] towards the distal direction of said augmented grasping device [10] until the rotating protrusion [730] is at a level where it can freely rotate into the gap [201] and under said object [60] as in FIG. 37D, FIG. 38D, and FIG. 39D.
j) Then said rotating protrusion [730] is rotated into the gap [201] and under said object [60] as in FIG. 37E, FIG. 38E, FIG. 39E, and FIG. 41G.
k) Once said rotating protrusion [730] has been rotated under said object [60], one or more actuators [102] can then move said rotating protrusion [730] towards said at least one primary grasping interface [40] until sufficient contact force is detected between said rotating protrusion [730] and said object [60] , or between said at least one primary grasping interface [40] and said object [60]. As a result, said object [60] becomes pinched between said at least one primary grasping interface [40] and said rotating protrusion [730] as in FIG. 37F, FIG. 38F, FIG. 39F, and FIG. 41H.

l) When a sufficient pinching or contact force has been applied, said augmented grasping device [10] can now lift and move said object [60] as in FIG. 411.

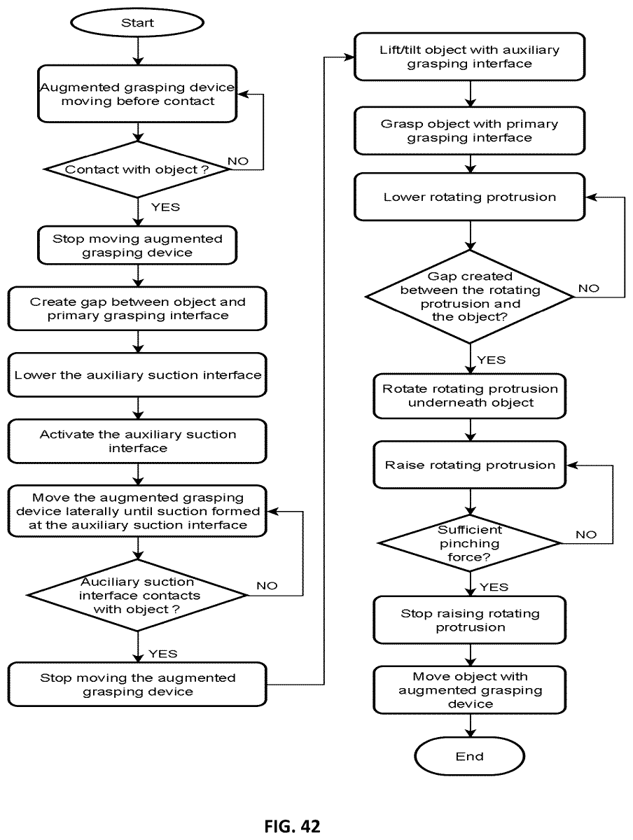

This grasping process is also summarized in FIG. 42.

Releasing or placement of said object [60], is the reverse of picking:
a) Said augmented grasping device [10] stops motion while still holding said object [60] at some distance above a placement surface (e.g., a bin or table). Said object [60] may be situated so that at least one corner or edge of said object [60] is contacting said placement surface or said object [60] may be held above said placement surface as in FIG. 41J.
b) Said rotating protrusion [730] is firstly moved towards the distal direction of the augmented grasping device [10] by one or more actuators [102], creating a gap [203] between said rotating protrusion [730] and said object [60] as in FIG. 41K.
c) Said rotating protrusion [730] is then rotated out by one or more actuators [102] from under said object [60] as in FIG. 41L and said first auxiliary grasping device [31] is deactivated, thus turning off the suction at said at least one auxiliary suction interface [710] as in FIG. 41N and releasing said object from said at least one auxiliary suction interface [710].
d) The actuator [101] controlling the motion of said at least one auxiliary suction interface [710] of said first auxiliary grasping devices [31] may move said at least one auxiliary suction interface [710] towards the distal direction of said augmented grasping device [10] prior to deactivating said primary grasping interface [40] as in FIG. 41M, for example to prevent the lid of a telescopic box object [60] to open.
e) Once said at least one primary grasping interface [40] is released, said augmented grasping device [10] may undergo a lateral motion moving said at least one auxiliary suction interface [710] away from the side of said object [60] so that said at least one auxiliary suction interface [710] does not catch on a part of said object [60], for example the lid or edge of a box.
f) Once clear of the edge of the object [60], the actuators [101] and [102] move said at least one auxiliary suction interface [710] and said rotating protrusion [730] to their initial positions as in FIG. 410.
g) Said augmented grasping device [10] can then move away from said object [60] as in FIG. 41P.

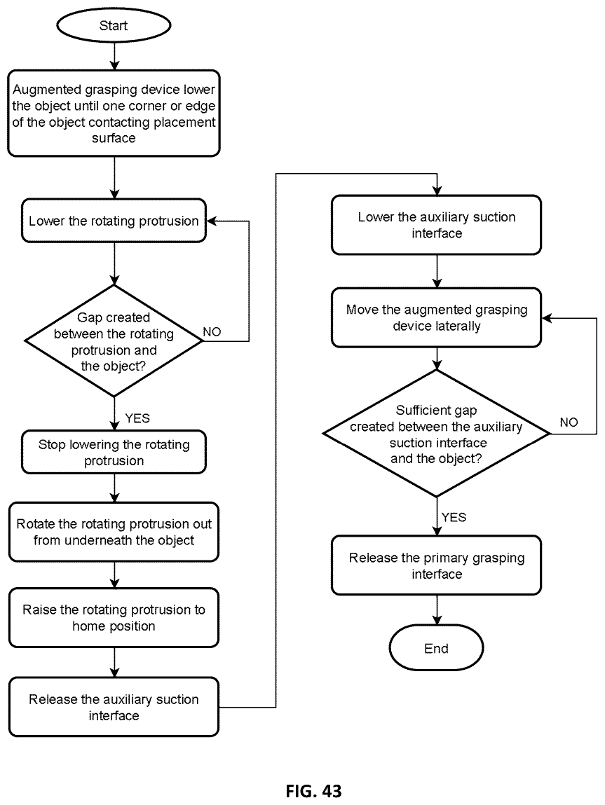

This releasing process is also summarized in FIG. 43.

### Articulated Appendage Preconditioning Object to Be Grasped

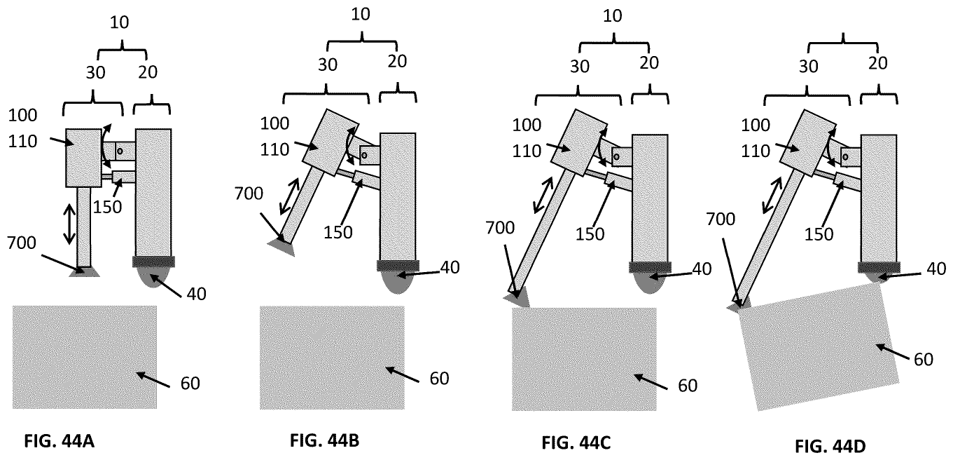

In yet another embodiment, a method for using the auxiliary grasping device [30] in the embodiment shown in FIG. 11 to precondition an object [60] for grasping by tilting the object [60] is as follows and shown in FIG. 44. First, the augmented grasping device [10] is moved to a position such that at least one primary grasping interface [40] is brought above the object [60], and then the motion of the augmented grasping device [10] stops as in FIG. 44A. At least one auxiliary grasping interface [700] is then tilted so that at least one auxiliary grasping interface [700] is pointing towards one edge of the object [60] as in FIG. 44B. And the linear actuator [103] may extend said at least one auxiliary grasping interface [700] towards one edge of the object [60] as in FIG. 44B. Upon contact with the object as in FIG. 44C, the linear actuator [103] continues to extend to press on the object [60] and the object [60] begins to tilt. The linear actuator [103] for the auxiliary grasping device [30] continues to extend until the surface of the object [60] is tilted up into contact with at least one primary grasping interface [40]. Once in contact with said at least one primary grasping interface [40], said at least one primary grasping interface [40] activates to grasp the object [60] as in FIG. 44D.

### Auxiliary Grasping Device Can Articulate As a Whole, With Blade

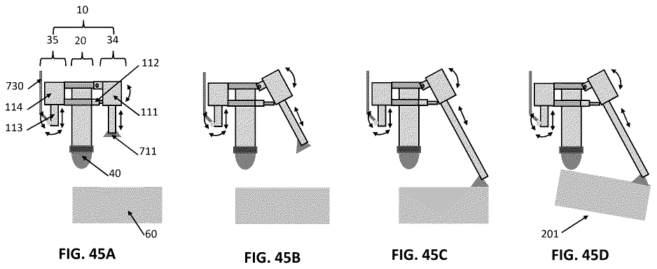

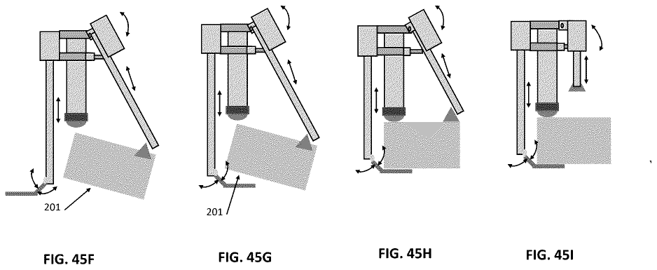

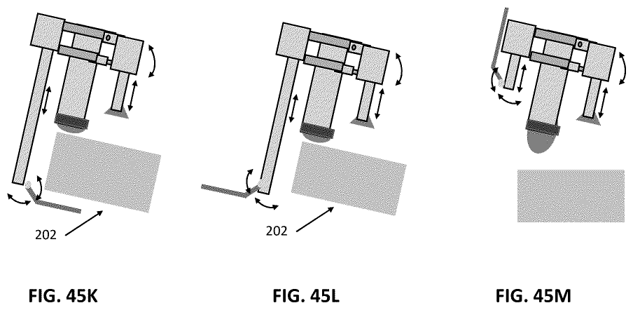

In yet another embodiment as in FIG. 45A, an augmented grasping device [10] comprises a primary grasping device [20], a first auxiliary grasping device [34], and a second auxiliary grasping device [35]. Said first auxiliary grasping device [34] has one auxiliary grasping interface [711]. Said first auxiliary grasping device [34] has an actuator [111] that can extend or retract its auxiliary grasping interface [711], and the whole first auxiliary grasping device [34] is mounted in such a way that it may be articulated in a manner where the angle of the first auxiliary grasping device [34] with respect to the central axis of the primary grasping device [20] or the central axis of a primary grasping interface [40] can change passively, or can be controlled actively using the same actuator [111] or a separate actuator [112]. Said second auxiliary grasping device [35] has one auxiliary grasping interface [700] in the form of a rotating protrusion [730]. An actuator [113] is used to move the rotating protrusion [730] beyond the distal end [28] of the primary grasping device [20] and below the object [60]. The same [113] or a different [114] actuator is used to rotate at least the rotating protrusion [730] around an axis substantially parallel to the central axis of the primary grasping device [20] or the central axis of said primary grasping interface [40]. Optionally, the rotating protrusion [730] can also rotate around an axis substantially perpendicular to the central axis of the primary grasping device [20] or the central axis of said primary grasping interface [40], so that it can be folded up, as in FIG. 45A to FIG. 45E and FIG. 45M, when not in use to save space and reduce the chance of undesirable collisions involving the rotating protrusion [730]. This rotation motion can be generated with or without an actuator.

### Method of Grasping-Auxiliary Grasping Device Can Articulate As a Whole, With Blade

In yet another embodiment, a method for an augmented grasping device [10] as in FIG. 45A with a first auxiliary grasping device [34] and a second auxiliary grasping device [35] to grasp, move, and place an object [60] is as follows and shown in FIG. 45:
a) The best pick point and orientation for the augmented grasping device [10] is determined by means that may include a manual (person-in-the-loop), machine vision, software, sensors or other methods.
b) The augmented grasping device [10], which may be attached to a robot, machine, automated equipment or intelligent system or by other such means, is moved to the pick point and orientation determined in (a) as in FIG. 45A.
c) The first auxiliary grasping device [34] is tilted so that the auxiliary grasping interface [711] on the first auxiliary grasping device [34] can be extended by the actuator [111] towards one edge of the object [60] as in FIG. 45B.
d) The auxiliary grasping interface [711] on the first auxiliary grasping device [34] is extended by the actuator [111] towards one edge of the object [60] until contacting with the object [60] as in FIG. 45C.
e) Upon the auxiliary grasping interface [711] on the first auxiliary grasping device [34] contacting the object [60] as in FIG. 45C, it continues to be extended by the actuator [111], causing the object [60] to tilt until the object [60] contacts with the primary grasping interface [40] on the primary grasping device [20] as in FIG. 45D. Due to the tilting of the object [60], a gap [201] under the lifted side of the object [60] is created as in FIG. 45D.
f) Once the object [60] is in contact with the primary grasping interface [40], the primary grasping interface [40] is activated to grasp the object [60] as in FIG. 45E.
g) The rotating protrusion [730] on the second auxiliary grasping device [35] is moved to a position that is clear to rotate into the gap [201] as in FIG. 45F.
h) The rotating protrusion [730] on the second auxiliary grasping device [35] is rotated into the gap [201] as in FIG. 45G.
i) The rotating protrusion [730] on the second auxiliary grasping device [35] is moved towards the primary grasping interface [40] until contacting with the object [60], creating a pinching action between the rotating protrusion [730] and the primary gripping interface [40] as in FIG. 45H.
j) The auxiliary grasping interface [711] on the first auxiliary grasping device [34] is brought back to its initial position. The object [60] can now be moved by the augmented grasping device [10] while being pinched between the rotating protrusion [730] and the primary gripping interface [40] as in FIG. 451.
k) When arriving at the destination for placing the object [60], the object [60] is positioned near the placement surface with one edge, side, or corner touching said placement surface as in FIG. 45J, creating a gap [202] between the object [60] and said placement surface.
l) The rotating protrusion [730] on the second auxiliary grasping device [35] moves away from the primary grasping interface [40] so that it is no longer pinching the object [60] as in FIG. 45K.
m) The rotating protrusion [730] on the second auxiliary grasping device [35] is rotated out of the gap [202] as in FIG. 45L.
n) The primary gripping interface [40] is deactivated to release the object [60] and the rotating protrusion [730] on the second auxiliary grasping device [35] is brought back to its initial position. The object [60] is fully released by the augmented grasping device [10] as in FIG. 45J.

### Picking and Placing Books by Pinching the Cover With the Blade

In yet another embodiment, a method of grasping objects [60] such as books using an augmented grasping device [10] comprising at least one auxiliary grasping interface [700] in the form of a rotating protrusion [730] such as that in FIG. 7A is as follows:
a) At least one primary grasping interface [40] of the augmented grasping device [10] is brought into contact with the object [60], which resembles a book or a box with a hinged-lid box, near a non-binding edge or the opening side of the lid.
b) Said At least one primary grasping interface [40] is activated to grasp the cover of the book (the object) [60] or the lid of the box.
c) Once grasped, the cover of the book or the lid of the box can be slightly opened by either lifting the entire augmented grasping device [10] or by the relative motion of said at least one primary grasping interface [40] with respect to the remainder of the augmented grasping device [10], creating a gap [201] between the cover and, perhaps, a few pages of the book and the remainder of the book or the lid and the reminder of the box.
d) Once a sufficient gap [201] has been created, the rotating protrusion [730] can be extended and then rotated or slid into the gap [201]. The location and size of the gap [201] can either be detected using sensing [310] or visualization methods or, it may be inferred, by the relative position change of either the augmented grasping device [10] or the relative motion of said at least one primary grasping interface [40].
e) Once located within the gap [201], moving the rotating protrusion [730] towards said at least one primary grasping interface [40] will exert a pinching force on the book cover or the box lid, thus allowing the book or the box (the object [60]) to be grasped and moved by the augmented grasping device [10].
f) Placement of the book or the box (the object [60]) is done by first bringing the book or the box (the object [60]) near a placement surface and continuing to bring the augmented grasping device [10] closer to said placement surface while optionally laterally moving the augmented grasping device [10] to ensure the book or the box (the object [60]) is at least partially closed in the process.
g) Release the pinching grasp by first moving the rotating protrusion [730] towards the distal direction of the augmented grasping device [10] or moving the rotating protrusion [730] away from said at least one primary grasping interface [40] and then rotating or sliding the rotating protrusion [730] out from under the book cover or the box lid.
h) Once clear of the book or the box (the object [60]), the rotating protrusion [730] can be returned to its initial position and said at least one primary grasping interface [40] releases the book cover or the box lid.
i) Once released, the augmented grasping device [10] can be moved clear of the book or the box (the object [60]).

### Mini Blade and Method of Gripping Together With the Blade and the Gripper

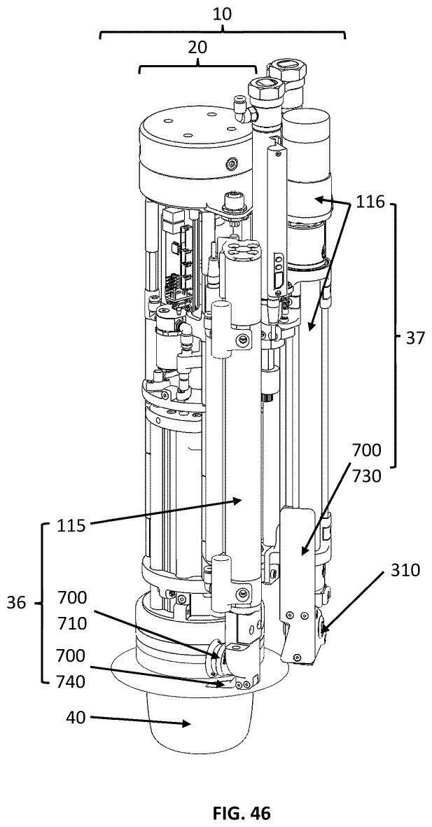

In yet another embodiment as shown in FIG. 46, an augmented grasping device [10] comprises one primary grasping device [20] and at least two auxiliary grasping devices [36][37]. The first auxiliary grasping device [36] comprises at least one auxiliary grasping interface [700] in the form of a miniature protrusion [740]. Said miniature protrusion [740] is positionally controlled relative to at least one primary grasping interface [40]. Specifically, an actuator [115] that can move the miniature protrusion [740] at least beyond the distal end [28] of the primary grasping device [20]. Optionally, the first auxiliary grasping device [36] further comprises at least one auxiliary grasping interface [700] in the form of an auxiliary suction interface [710] facing towards a direction which is different from or substantially perpendicular to the one defined by the central axis of said at least one primary grasping interface [40]. The second auxiliary grasping device [37] has at least one auxiliary grasping interface [700] who is a rotating protrusion [730]. Said rotating protrusion [730] is positionally controlled relative to said at least one primary grasping interface [40]. Specifically, said second auxiliary grasping device [37] has at least one actuator [116] used to move the rotating protrusion [730] beyond the distal end [28] of the primary grasping device [20] and below the object [60] and to rotate the rotating protrusion [730] around an axis substantially parallel to the central axis of the primary grasping device [20] or the central axis of said at least one primary grasping interface [40]. An intermediate structure [90] configured to connect the primary grasping device [20], the first auxiliary grasping device [37] and the second auxiliary grasping device [36] together to form the augmented grasping device [10], wherein the intermediate structure can be but not limited to a plate, a disc, a bracket, a truss, a framed structure, a robotic interface, a ball joint, a hydraulic mechanism, a pneumatic mechanism, a fluid mechanism, an electro-mechanical mechanism, a linear mechanism, a revolute joint, a spherical joint and a cardan joint. The intermediate structure [90] can connect the primary grasping device [20], the first auxiliary grasping device [37], and the second auxiliary grasping device [36] in different ways including: the intermediate structure [90] connects the first auxiliary grasping device [37] to the primary grasping device [20], and connects the second auxiliary grasping device [36] to the first auxiliary grasping device [37]; the intermediate structure [90] connects the second auxiliary grasping device [36] to the primary grasping device [20], and connects the first auxiliary grasping device [37] to the second auxiliary grasping device [36]; the intermediate structure [90] connects the second auxiliary grasping device [36] to the primary grasping device [20], and connects the first auxiliary grasping device [37] to the primary grasping device [20]; and the intermediate structure [90] connects the second auxiliary grasping device [36] to the primary grasping device , connects the first auxiliary grasping device [37] to the primary grasping device [20], and connects the first auxiliary grasping device [37] to the second auxiliary grasping device [36].

The miniature protrusion [740] can be used to slide under the edge of an object [60]. Once slid under the edge of the object [60], the miniature protrusion [740] could be used to lift the object [60] to create a gap [201] between the object [60] and a table or placement surface. Once a gap [201] between the base of the object [60] and the table or placement surface has been created, the rotating protrusion [730] on the second auxiliary grasping device [37] can be moved to and rotated underneath the object [60]. Once rotated into a suitable position underneath the object [60], the rotating protrusion [730] is retracted and the object [60] becomes pinched between said at least one primary grasping interface [40] and the rotating protrusion [730]. Once firmly pinched, the object [60] can be moved by the augmented grasping device [10].

Mini Blade and Method of Gripping Together with the Blade and the Gripper In yet another embodiment, the rotating protrusion [730] could be deployed in conjunction with the miniature protrusion [740] and primary grasping interface [40] to grasp objects [60] such as books or boxes with loose lids.

### Mini Blade Picking—Passive Mini Blade Retraction

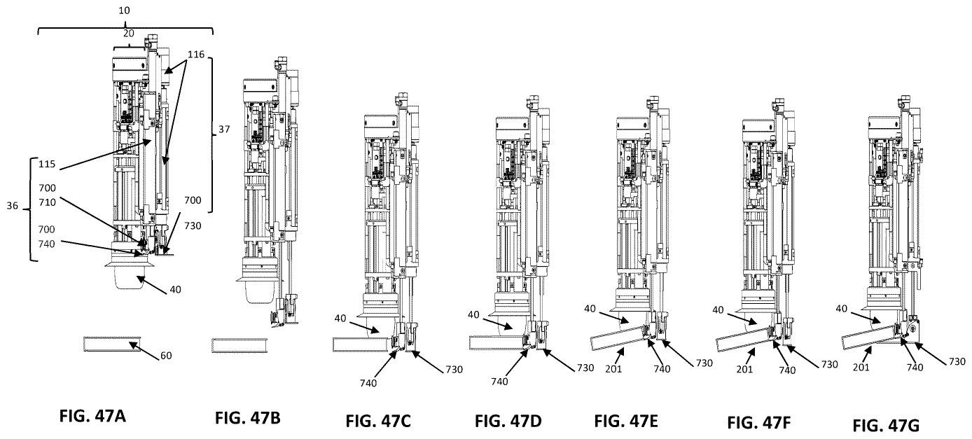

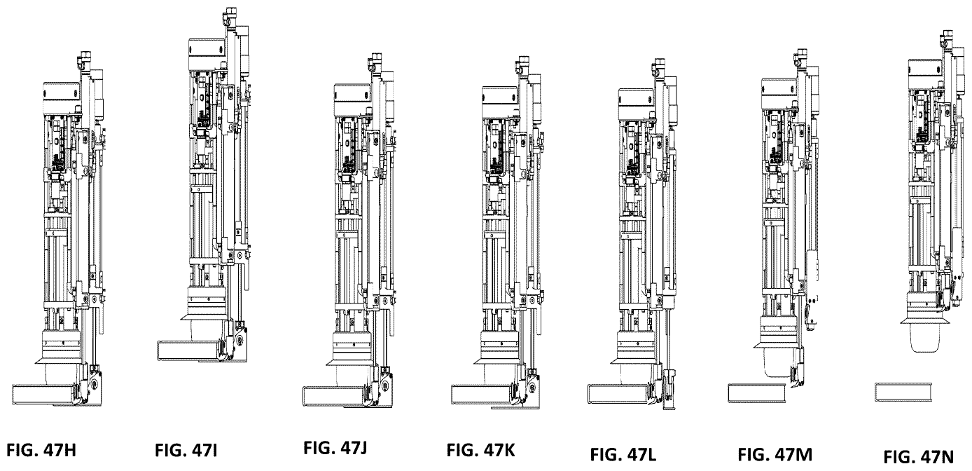

In one method of grasping, moving, and placing objects [60] such as easily opened books or boxes from the non-binding side or opening side using the augmented grasping device [10] in FIG. 46 comprising one auxiliary grasping device [36] having an auxiliary grasping interface [700] in the form of a miniature protrusion [740], and one auxiliary grasping device [37] having an auxiliary grasping interface in the form of a rotating protrusion [730] is as follows and shown in FIG. 47.
a) The best pick point near the non-binding side or opening side of the object [60] and orientation for the augmented grasping device [10] is determined by means that may include a manual (person-in-the-loop), machine vision, software, sensors or other methods.
b) The augmented grasping device [10], which may be attached to a robot, machine, automated equipment or intelligent system or by other such means, is moved to above the pick point and along orientation determined in (a) as in FIG. 47A.
c) The rotating protrusion [730] and miniature protrusion [740] are moved towards the distal direction of the augmented grasping device [10] by the actuators [116] and [115] from their initial positions so that they extend beyond at least one primary grasping interface [40] as in FIG. 47B.
d) As the augmented grasping device [10] is moved towards the object, the rotating protrusion [730] and miniature protrusion [740] may come into contact with the surface on which the object to be grasped is lying. As the augmented grasping device [10] continues to move toward the object [60], in this example, typically a book or box, the actuators [116] and [115] are allowed to compress or perhaps retracted in such a manner that at least the miniature protrusion [740] remains in contact with or near said surface. The augmented grasping device [10] slows or stops its motion once said at least one primary grasping interface [40] contacts the object [60] as in FIG. 47C.
e) The augmented grasping device [10] then moves laterally so that the miniature protrusion [740] is slid somewhat underneath the lower edge of the object [60] as in FIG. 47D.
f) Said at least one primary grasping interface [40] is activated to grasp the upper surface of the book or box (the object [60]) and then retracting both the miniature protrusion [740] and said at least one primary grasping interface [40], while maintaining the grasp with said at least one primary grasping interface [40], towards the proximal direction of the augmented grasping device [10] causes the edge of the book or box (the object [60]) to be lifted and creates a gap [201] under the object [60] as in FIG. 47E.
g) The rotating protrusion [730] is then positioned, perhaps with the aid of one or more sensors [310], in such a manner that it is free to rotate into the gap [201] under the book or box (the object [60]) as in FIG. 47F.
h) The rotating protrusion [730] is rotated under the book or box (the object [60]) as in FIG. 47G.
i) After the rotating protrusion [730] is rotated under the book or box (the object [60]), it can be retracted until a sufficient pinching grasp is created between said at least one primary grasping interface [40] and the surface of the rotating protrusion [730] as in FIG. 47H. The force or pressure of the pinching grasp may be measured using force, strain, load, pressure, or similar sensing devices.
j) Once the book or box (the object [60]) is pinched, the augmented grasping device [10] may move the book or box (the object [60]) to above the placement position as in FIG. 471.
k) Placement of the book or box (the object [60]) is done by first bringing the augmented grasping device [10] with the book or box (the object [60]) over a placement surface as in FIG. 47J.
l) The pinching grasp between said at least one primary grasping interface [40] and the rotating protrusion [730] is loosened by sufficiently moving the rotating protrusion [730] away from said at least one primary grasping interface [40], as in FIG. 47K, before rotating the rotating protrusion [730] out from under the book or box (the object [60]) as in FIG. 47L. The rotating protrusion [730] is then free to be retracted to its initial position.
m) Said at least one primary grasping interface [40] then releases the upper surface of the book or box (the object [60]) and the augmented grasping device [10] or miniature protrusion [740] is laterally moved away from the edges of the book or box (the object [60]) as in FIG. 47M.
n) Once sufficient clearance is achieved between the book or box (the object [60]) and the miniature protrusion [740], the miniature protrusion [740] is then moved back towards the proximal direction of the augmented grasping device [10] to its initial position and the augmented grasping device [10] is free to be moved away from the book or box (the object [60]) as in FIG. 47N.

### Picking and Placing Books by Pinching the Cover with the Blade, Mini Blade for Opening Cover

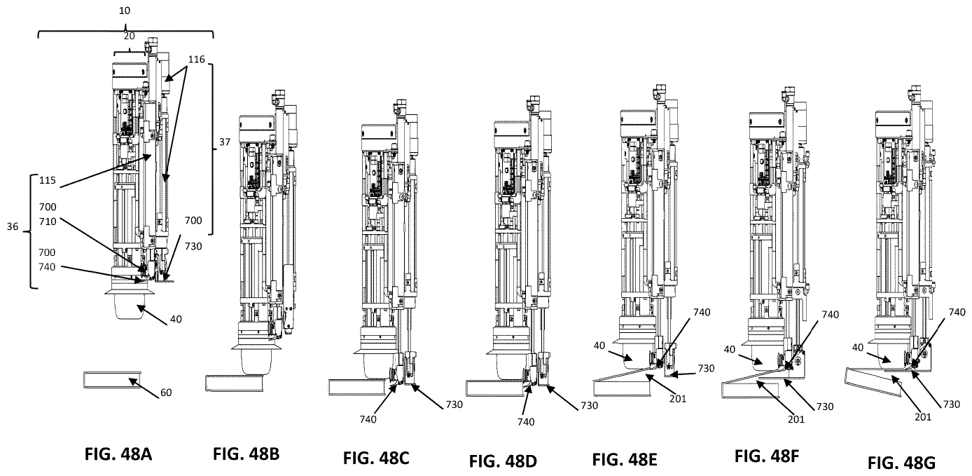

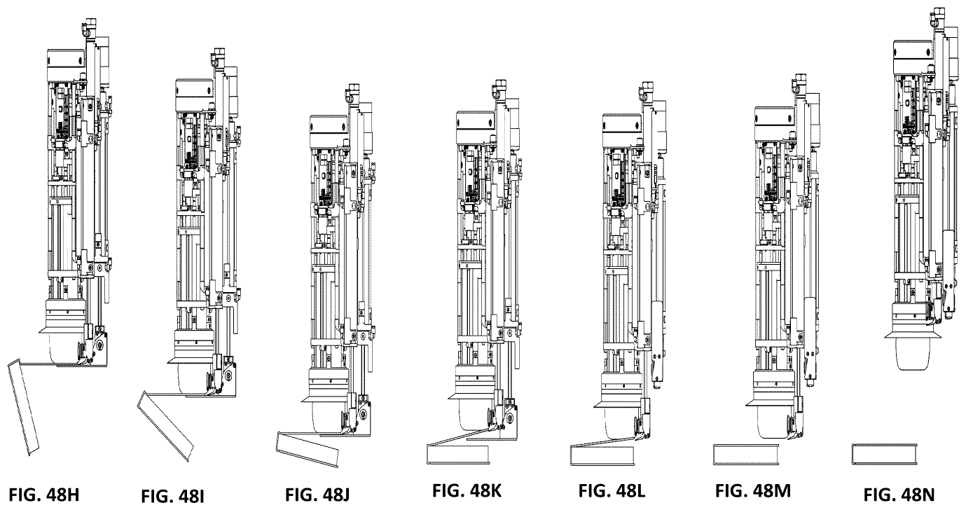

In yet another method for grasping and moving objects [60] such as easily opened books or boxes from the non-binding side or opening side using the augmented grasping device [10] in FIG. 46 comprising one auxiliary grasping device [36] having an auxiliary grasping interface in the form of a miniature protrusion [740], and one auxiliary grasping device [37] having an auxiliary grasping interface in the form of a rotating protrusion [730] is as follows and shown in FIG. 48.
a) The best pick point near the non-binding side or opening side of the object [60] and orientation for the augmented grasping device [10] is determined by means that may include a manual (person-in-the-loop), machine vision, software, sensors or other methods.
b) The augmented grasping device [10], which may be attached to a robot, machine, automated equipment or intelligent system or by other such means, is moved to above the pick point and orientation determined in (a) as in FIG. 48A.
c) The augmented grasping device [10] is lowered until at least one primary grasping interface [40] contacts the object [60] as in FIG. 48B.
d) The rotating protrusion [730] and miniature protrusion [740] are moved towards the distal direction of the augmented grasping device [10] by the actuators [116] and [115] from their initial positions so that the miniature protrusion [740] is located below the upper cover of the book or the lid of the box (the object [60]) as in FIG. 48C.
e) The miniature protrusion [740] is then laterally moved until it is near the pages of the book and underneath the upper cover of the book, or under the edge of the lid of the box as in FIG. 48D. A sensing or visualization device may be used to detect the proximity of the miniature protrusion [740] from the book pages and book cover or the side of the box.
f) Said at least one primary grasping interface [40] then grasp the upper cover of the book (or the lid of the box) while the miniature protrusion [740] is moved towards the proximal direction of the augmented grasping device [10] into contact with the upper cover of the book (or the lid of the box) and pinching of the book cover (or the lid of the box) is achieved between said at least one primary grasping interface [40] and the miniature protrusion [740]. Working together to maintain the pinching grasp, both said at least one primary grasping interface [40] and the miniature protrusion [740] lift the cover and open the book (or lift the lid and open the box) to create a gap [201] as in FIG. 48E sufficiently so that the rotating protrusion [730] can be rotated freely under the upper cover of the book or the lid of the box (the object [60]) as in FIG. 48F.
g) Once between the cover and the pages of the book or under the lid of the box (the object [60]), the rotating protrusion [730] can be moved towards the proximal direction of the augmented grasping device [10] or towards said at least one primary grasping interface [40] and pinching the cover of the book and perhaps a few pages or the lid of the box (the object [60]), between said at least one primary grasping interface [40] and the rotating protrusion [730] with sufficient force as in FIG. 48G. The force of the pinching grasp can be measured using force sensing, strain gauges, load cells, pressure sensors, or similar sensing devices.
h) Once the cover of the book or the lid of the box (the object [60]) is pinched, the book or the box (the object [60]) is lifted by the cover or the lid, and the augmented grasping device [10] moves the book or the box to its placement location. Note that the remainder of the book or the box (the object [60]) that is not pinched between said at least one primary grasping interface [40] and the rotating protrusion [730] is free to swing or hang as the book or the box (the object [60]) is supported only by its cover or its lid as in FIG. 48H. In order to reduce swinging of the remainder of the book or the box that is hanging, the augmented grasping device [10] holding the book or the box may be rotated so that the binding of the book or the hinged side of the box (the object [60]) is aligned with the direction of motion.
i) For placement, the augmented grasping device [10] holding the opened book or box (the object [60]) is lowered towards the placement surface until at least part of the book or box (the object [60]) contacts the placement surface as in FIG. 481.
j) The augmented grasping device [10] may continue to lower the book or the box while ensuring that the book or the box closes by employing a lateral motion as in FIG. 48J.
k) Once the book or the box is lowered sufficiently, the release process begins by releasing the pinching force on the book cover or box lid by moving the rotating protrusion [730] towards the distal direction of the augmented grasping device [10] until sufficient clearance is achieved as in as in FIG. 48K, and then rotating the rotating protrusion [730] out from underneath the book cover or box lid. Once free of the book cover or box lid the rotating protrusion [730] may be lifted to its initial position as in FIG. 48L. If needed, the miniature protrusion [740] may be moved towards the distal direction of the augmented grasping device [10] slightly during the pinching grasp or while the rotating protrusion [730] is releasing the pinching grasp.
l) Said at least one primary grasping interface [40] then releases the book cover or the box lid (the object) [60]) and the miniature protrusion [740] is moved laterally away from the book or the box (the object) [60]) as in FIG. 48M.
m) Once sufficiently clear of the book or the box (the object [60]), the miniature protrusion [740] is moved towards the proximal direction of the augmented grasping device [10] to its initial position and the augmented grasping device [10] is free to be moved away from the book as in FIG. 48N.

### Preferred Way to Hold a Book When the Book Is Held by Only its Cover

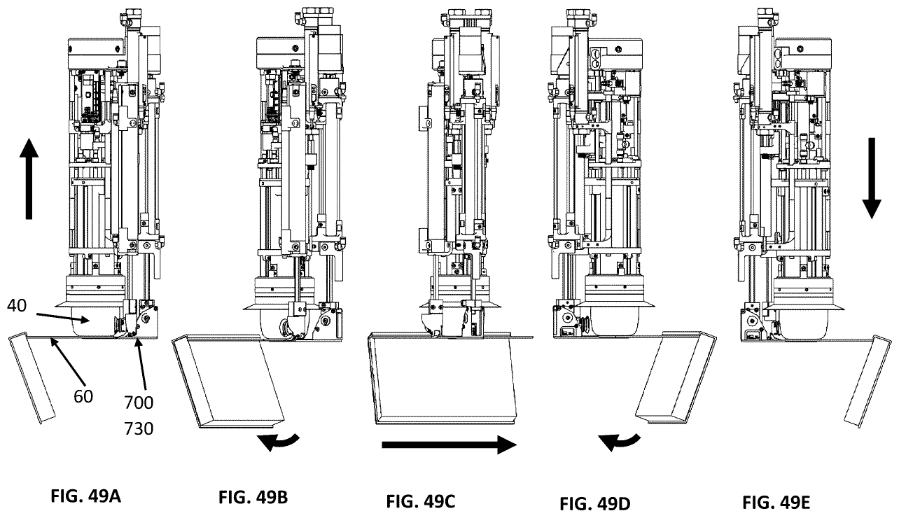

In yet another embodiment, a method of moving a book held by its cover to minimize swinging of the book is as follows: the augmented grasping device [10] rotates the book so that the binding of the book is aligned with the direction of travel of the augmented grasping device [10] as in FIG. 49. Specifically, firstly the book is lifted vertically as in FIG. 49A. Then the augmented grasping device [10] rotates the book as in FIG. 49B, so that the binding substantially aligns with the desired direction of motion of the augmented grasping device [10] as in FIG. 49C. Before placement, the augmented grasping device [10] rotates the book so that the book edges align with the desired placement position as in FIG. 49D. And finally, the book is lowered as in FIG. 49E.

### Picking and Placing With a Chain Link Blade

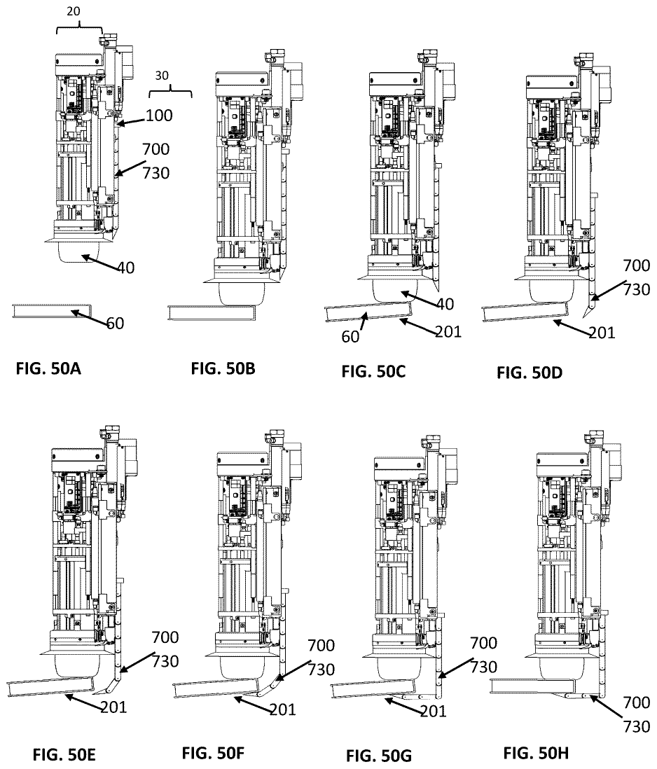

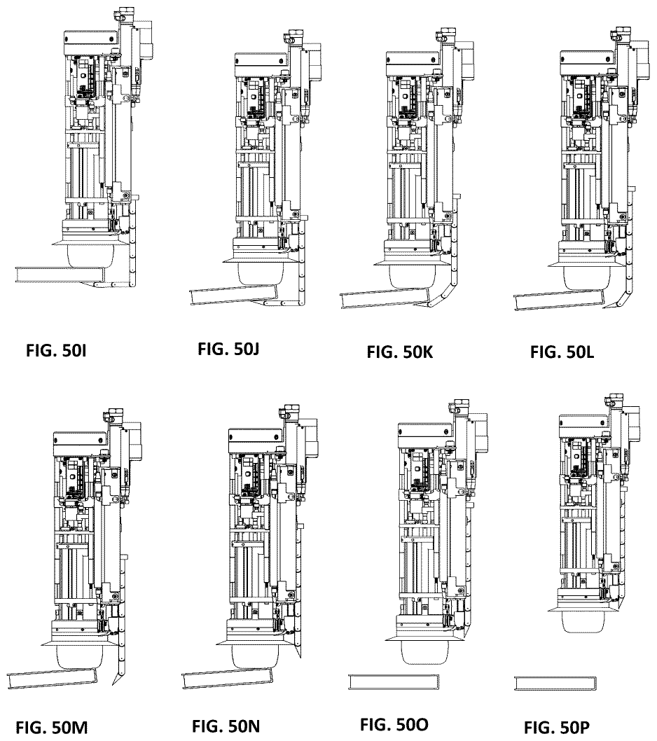

In yet another method of grasping an object [60], the embodiment of an augmented grasping device [10] as in FIG. 13 is used. The rotating protrusion [730] embodied as in FIG. 13 is used to provide a pinching force between the rotating protrusion [730] and at least one primary grasping interface [40] of the augmented grasping device [10]. The motion of said rotating protrusion [730] is restricted so that as the rotating protrusion [730] is lowered, it bends or rotates towards a direction which is different from or substantially perpendicular to the one defined by the central axis of the primary grasping device [20] or the central axis of said at least one primary grasping interface [40]. The rotating protrusion [730] may be formed as a single flexible protrusion or a flexible linkage with attached protrusions or similar means. The method of grasping is as follows and is shown in FIG. 50.
a) The best pick point near the non-binding side or opening side of the object [60] and orientation for the augmented grasping device [10] is determined by means that may include a manual (person-in-the-loop), machine vision, software, sensors or other methods.
b) The augmented grasping device [10], which may be attached to a robot, machine, automated equipment or intelligent system or by other such means, is moved to above the pick point and orientation determined in (a) as in FIG. 50A.
c) The augmented grasping device [10] is lowered until at least one primary grasping interface [40] contacts the object [60] as in FIG. 50B.
d) Said at least one primary grasping interface [40] is then activated to grasp the upper surface of the object [60] and lifts the object to create a sufficient gap [201] between the lower surface of the object [60] and the surface upon which it rests as in FIG. 50C. Before or after the gap [201] is created the rotating protrusion [730] is slid down towards the placement surface until it is sufficiently near said surface.
e) The rotating protrusion [730] is then directed into the gap [201] by flexing the linkage towards a direction which is different from or substantially perpendicular to the one defined by the central axis of the primary grasping device [20] or the central axis of said at least one primary grasping interface [40] and reaching beneath the object [60] as in FIG. 50D, FIG. 50E, and FIG. 50F.
f) Once the rotating protrusion [730] is sufficiently beneath the object, the rotating protrusion [730] is stiffened as in FIG. 50G and lifted as in FIG. 50H so that a pinching force is exerted on the object [60] by said at least one primary grasping interface [40] and the rotating protrusion [730]. Once a sufficient pinching force is achieved, the object [60] may be moved by the augmented grasping device [10].
g) Placement of the object [60] is done by bringing the object near to the placement surface as in FIG. 50I, releasing the pinching grasp by lowering the rotating protrusion [730] relative to said at least one primary grasping interface [40] as in FIG. 50J and then sliding the rotating protrusion [730] out from under the object [60] and back to the resting or home position of the rotating protrusion [730] as in FIG. 50K, FIG. 50L, FIG. 50M, and FIG. 50N.
h) Once the rotating protrusion [730] is free of the object [60] said at least one primary grasping interface [40] releases the object [60] as in FIG. 500.
i) The augmented grasping device [10] is free to move clear of the object [60] as in FIG. 50P.

### Detailed Embodiment of the Primary Membrane Gripper

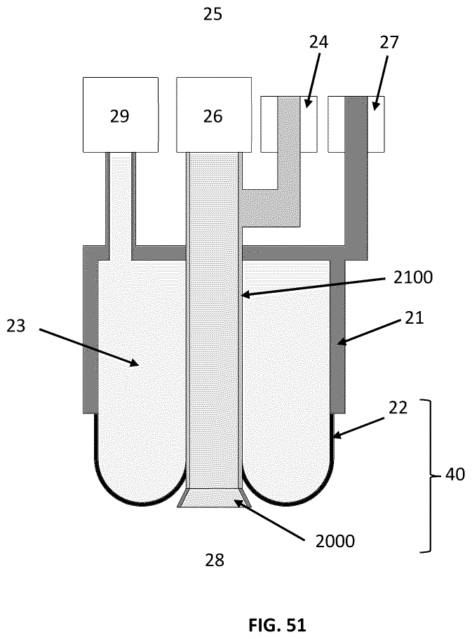

In an embodiment, a primary grasping device [20] in an augmented grasping device [10] is constructed as follows. A cross-sectional view of said primary grasping device [20] is shown in FIG. 51. Said primary grasping device [20] composed of an external wall [21] and a flexible membrane [22] at least partially sealing a peripheral compartment [23]. The external wall [21] and flexible membrane [22] are configured to allow a core suction interface [2100] to pass through the peripheral compartment [22] unhindered. The core suction interface [2100] is attached also to the flexible membrane [22] but is free to slide through the at least external wall [21]. The core suction interface [2100] is attached to at least one actuating mechanism [24], and, in the preferred embodiment, at least said one actuating mechanism [24] is configured to move the core suction interface linearly towards the proximal end [25] of said primary grasping device [20]. At least one fluid control mechanism [26] is in fluid communication with the core suction interface [2100]. The external wall [21] is also attached to at least one actuating mechanism [27] and is configured to move the external wall [21] linearly towards the distal end [28] of said primary grasping device [20] from a resting position. At least one fluid control mechanism [29] is in fluid communication with the at least partially sealed peripheral compartment [23] and allows the peripheral compartment [23] to be pressurized or depressurized. The linear motion of the external wall [21], linear motion of the core suction interface [2100] and/or the pressurization/depressurization of the at least partially sealed peripheral compartment [23] are contrived in such a manner as to cause the flexible membrane [22] to be deformed from its resting state. At any one time, the flexible membrane [22] deformation can be controlled dynamically using any combination of the external wall actuating mechanism [27], core suction interface actuating mechanism [24] or fluid control mechanism [29] and an appropriate control scheme. The distal end [28] of the core suction interface [2100] is terminated in a suction interface [2000] that may be configured for improved object contact. The flexible membrane [22] and the suction interface [2000] comprise a primary grasping interface [40] of said primary grasping device [20].

### A Rod Appendage for Conditioning Object Before Grasping

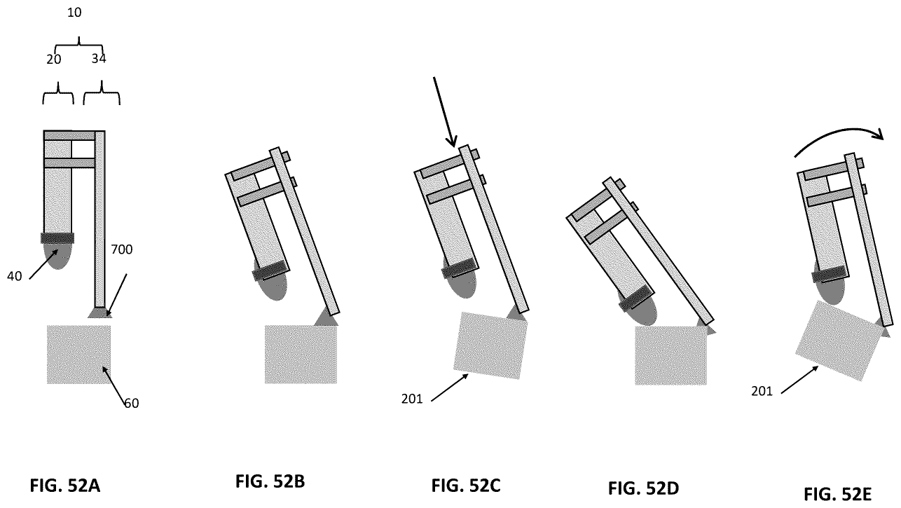

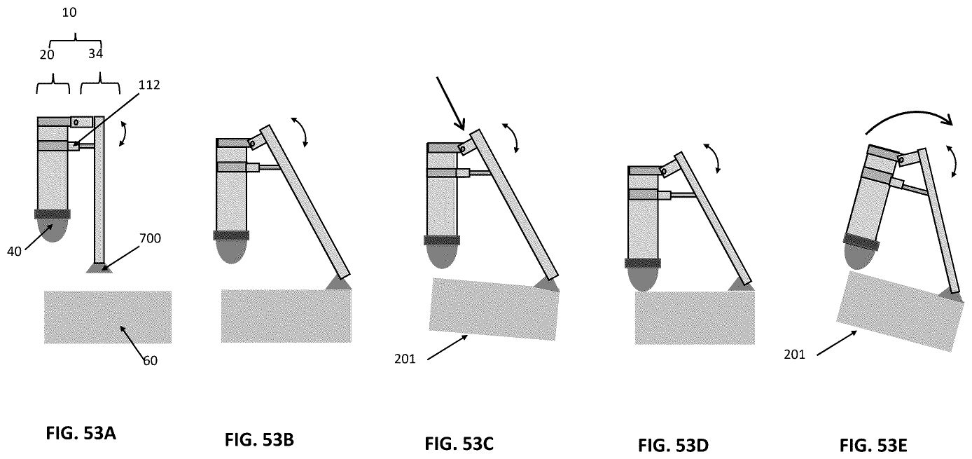

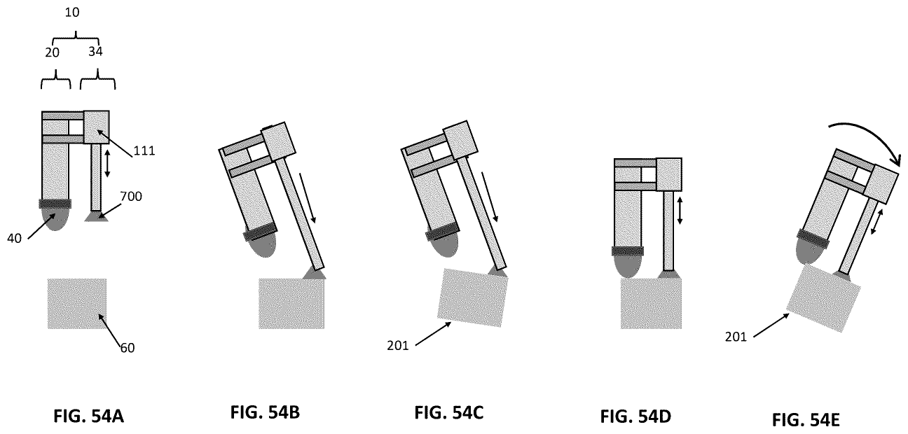

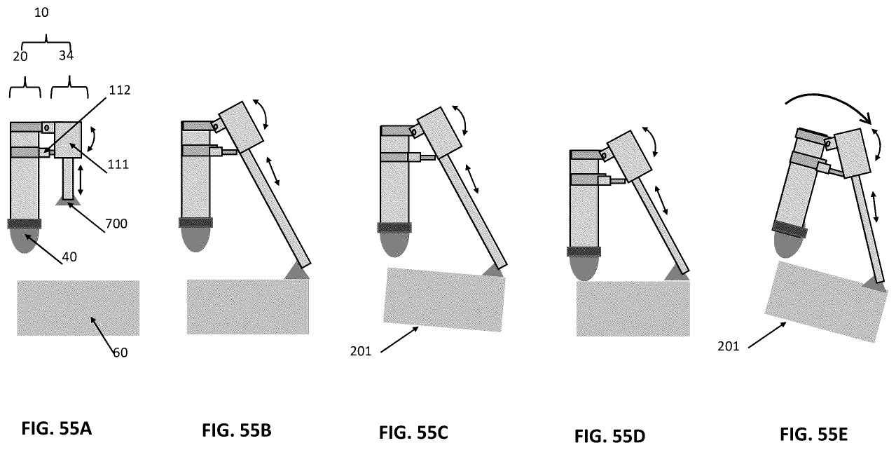

In a group of embodiments, an augmented grasping device [10] as in FIG. 52A, FIG. 53A, FIG. 54A, and FIG. 55A comprises one primary grasping device [20] and at least one first auxiliary grasping device [34]. Said primary grasping device [20] comprises at least one primary grasping interface [40] and can be constructed as in FIG. 51 or can be implemented as other kinds of grasping devices, for example, a suction device. Said first auxiliary grasping device [34] has at least one auxiliary grasping interface [700]. Said at least one auxiliary grasping interface [700] may be fixed relative to said first auxiliary grasping device [34] and said primary grasping device [20] as in FIG. 52A, and can extend and retract substantially along the direction of its central axis relative to the object [60] to be grasped, or can change its relative orientation relative to the object [60] to be grasped, by moving the whole augmented grasping device [10] relative to said object [60]. Alternatively, said first auxiliary grasping device [34] may further comprise at least one actuator [111] as in FIG. 54A and FIG. 55A that can extend and retract said at least one auxiliary grasping interface [700] substantially along the direction of its central axis relative to the object [60] to be grasped. Also alternatively, said first auxiliary grasping device [34] may use the same actuator [111], or further comprises at least another actuator [112] as in FIG. 53A and FIG. 55A that can change the orientation of said at least one auxiliary grasping interface [700] relative to the object [60] to be grasped, and relative to said primary grasping device [20].

In yet another embodiment, a method using said augmented grasping device [10] in the embodiment shown in FIG. 52A, FIG. 53A, FIG. 54A, and FIG. 55A is used to precondition an object [60] to facilitate subsequent grasping. The object [60] is initially resting upon at least one item, which could be but not limited to a flat surface, a curved surface, a textured surface, a perforated surface, a grided frame, a mesh, a fin array, a bin, a shelf, a tray, a conveyor belt, a bench, a table, an automated guided vehicle, an autonomous mobile robot, and a pile of other objects, etc. And the method is as follows:
a) At least said at least one auxiliary grasping interface [700] on said first auxiliary grasping device [34], as in FIG. 52B, FIG. 53B, FIG. 54B, and FIG. 55B, or also said at least one primary grasping interface [40] on said primary grasping device [20], as in FIG. 52D, FIG. 53D, FIG. 54D, and FIG. 55D, are brought into contact with the object [60].
b) Said at least one auxiliary grasping interface [700] on said first auxiliary grasping device [34] is positioned at a contact point on said object [60] that is close to an edge of said object [60].
c) Said at least one auxiliary grasping interface [700] moves or presses against said object [60] at said contact point, in an orientation that causes said object [60] to tilt as in FIG. 52C, FIG. 53C, FIG. 54C, FIG. 55C, FIG. 52E, FIG. 53E, FIG. 54E, and FIG. 55E.
d) said tilting creates a gap [201] underneath said object [60], which facilitates grasping said object [60] by using said primary grasping device [20], at least one auxiliary grasping device [30], or their combination.

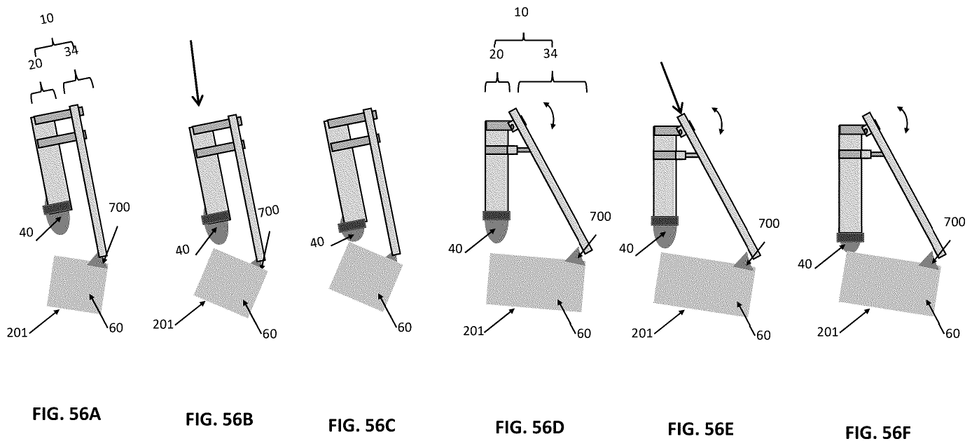

In yet another embodiment, a method for grasping an object [60] after being preconditioned as in FIG. 52C, FIG. 53C, FIG. 54C, and FIG. 55C, using said augmented grasping device [10] is as follows:
a) Said at least one auxiliary grasping interface [700] on said first auxiliary grasping device [34] contacts the object [60] first while said at least one primary grasping interface [40] is still not in contact with said object [60] as in FIG. 56A, FIG. 56D, FIG. 56G, and FIG. 56J.
b) Said at least one auxiliary grasping interface [700] presses on said object [60] and causes said object to tilt until at least a part of said object [60] contacts with said at least one primary grasping interface [40] as in FIG. 56B, FIG. 56E, FIG. 56H, and FIG. 56K.
c) Said at least one primary grasping interface [40] activates after the object [60] is tilted and grasps the object [60] on the edge opposite to the edge near which said contact point at which the auxiliary grasping interface [700] presses is located as in FIG. 56C, FIG. 56F, FIG. 561, and FIG. 56L.

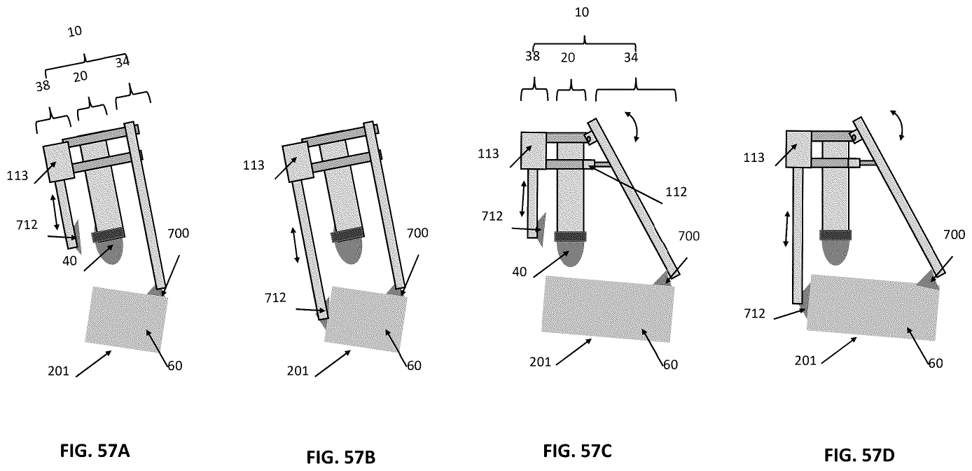

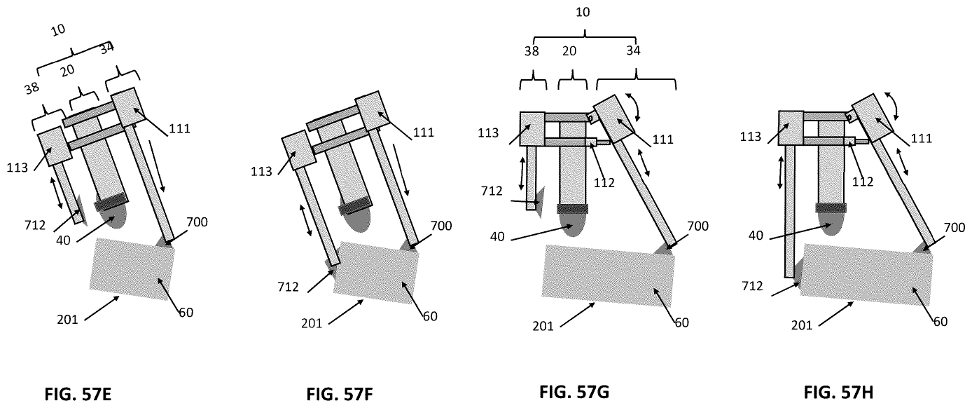

In yet another group of embodiments, an augmented grasping device [10] is constructed by adding to the embodiment in FIG. 52A, FIG. 53A, FIG. 54A, and FIG. 55A at least one second auxiliary grasping device [38]. Wherein the second auxiliary grasping device [38] comprises at least one auxiliary grasping interface [700] in the form of at least one auxiliary suction interface [712] that generates a suction effect towards the object [60] to be grasped when said auxiliary grasping interface [700] is activated. Zero or more actuators [113] may be added to said second auxiliary grasping device [38] or said augmented grasping device [10] for moving said auxiliary suction interface [712]. A method for grasping an object [60] after being preconditioned as in FIG. 52C, FIG. 53C, FIG. 54C, FIG. 55C, FIG. 52E, FIG. 53E, FIG. 54E, and FIG. 55E, also in FIG. 57A, FIG. 57C, FIG. 57E, FIG. 57G using said augmented grasping device [10] is as follows:
a) Said at least one auxiliary grasping interface [700] on said first auxiliary grasping device [34] continues to press on said object [60] and cause said object [60] to tilt.
b) The augmented grasping device [10] moves, rotates or activates zero or more said actuators [113] to establish a contact between said at least one auxiliary suction interface [712] on said second auxiliary grasping device [38] and said object [60].
c) Said at least one auxiliary suction interface [721] on said second auxiliary grasping device [38] activates to grasp the object [60].

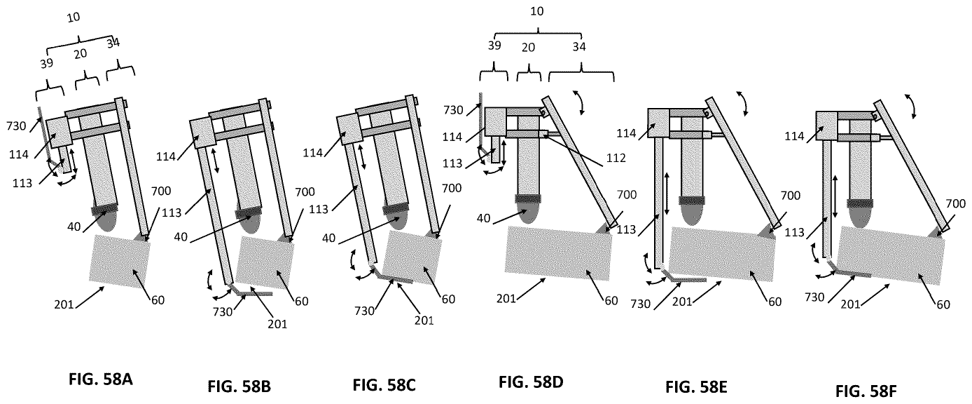

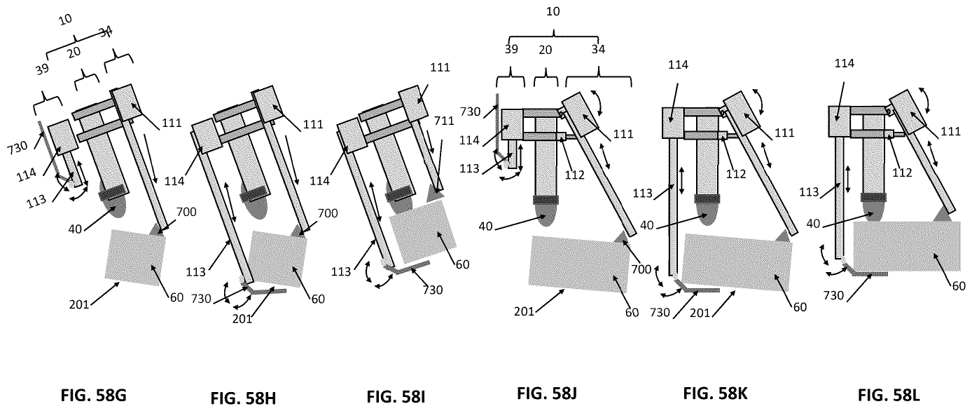

In yet another group of embodiments, an augmented grasping device [10] is constructed by adding to the embodiment in FIG. 52A, FIG. 53A, FIG. 54A, and FIG. 55A at least one second auxiliary grasping device [39]. Wherein the second auxiliary grasping device [39] comprises at least one auxiliary grasping interface [700] in the form of a rotating protrusion [730] configured to allowing pinching the object [60] to be grasped between said rotating protrusion [730] and said at least one primary grasping interface [40] to aid in picking up, manipulating, and releasing objects [60]; and at least one actuator [113] [114] configured to move said rotating protrusion [730] at least beyond the distal end [28] of the primary grasping device [20] and below the object [60], and to rotate said rotating protrusion [730] at least substantially around an axis parallel to the central axis of said at least one primary grasping interface [40]. A method for grasping an object [60] after being preconditioned as in FIG. 52C, FIG. 53C, FIG. 54C, FIG. 55C, FIG. 52E, FIG. 53E, FIG. 54E, and FIG. 55E, also in FIG. 58A, FIG. 58D, FIG. 58E, FIG. 58G using said augmented grasping device [10] is as follows:
a) The rotating protrusion [730] on said second auxiliary grasping device [39] is moved by said at least one actuator [113] [114] to a position that is clear to rotate into said gap [201].
b) The rotating protrusion [730] on said second auxiliary grasping device [39] is rotated into said gap by said at least one actuator [113] [114].
c) The rotating protrusion [730] on said second auxiliary grasping device [39] is moved towards said at least one primary grasping interface [40] until contacting said object [60], creating a grasping action between said rotating protrusion [730] and said at least one primary grasping interface [40].

At this point said object [60] can be moved by the augmented grasping device [10] while being pinched between the rotating protrusion [60] and said at least one primary grasping interface [40]. To release said object [60] from the augmented grasping device [10], the following process is used:
a) When said augmented grasping device [10] arriving at the destination for placing the object [60], the object [60] is positioned near a placement surface with one edge, side, or corner touching said surface, creating a gap [202] between said object [60] and said placement surface.
b) The rotating protrusion [730] on the second auxiliary grasping device [39] moves in a direction away from said at least one primary grasping interface [40] so that it is no longer grasping the object [60] between said rotating protrusion [730] and said at least one primary grasping interface [40].
c) The rotating protrusion [730] on the second auxiliary grasping device [39] is rotated out of said gap [202] between said object [60] and said placement surface.
d) The rotating protrusion [730] on the second auxiliary grasping device [39] is brought back to its initial position by said at least one actuator [113][114] on the second auxiliary grasping device [39].
e) The augmented grasping device [10] moves away from the object [10].

The object [60] is now fully released by the augmented grasping device [10].

### Gripper+Blade With Actuator (FIG. 7)

According to the disclosure, an augmented grasping device (10) configured for attachment to a robot, machine, automated equipment or intelligent system and configured for picking up, manipulating or releasing objects is disclosed. The augmented grasping device (10) comprises one primary grasping device (20) comprising a core suction interface (2100) configured for vacuum air suction, a peripheral compartment (23) surrounding the core suction interface (2100), an external wall (21) forming the upper surface of the peripheral compartment (23), a flexible membrane (22) forming the lower surface of the peripheral compartment (23), the flexible membrane (22) further configured to partially seal the peripheral compartment (23), wherein the flexible membrane (22) is attached to the external wall (21), wherein the core suction interface (2100) is attached to the flexible membrane (22) and wherein the peripheral compartment (23) is configured to allow passage of the core suction interface (2100) through the peripheral compartment (23).

According to the disclosure, the primary grasping device (20) further comprises at least one actuating mechanism (24 or 27) configured to change the respective distance between the peripheral compartment (23) and the core suction interface (2100), at least one fluid control mechanism (29) configured to allow fluid communication to the peripheral compartment (23), and wherein the flexible membrane (22) and the core suction interface (2100) constitute at least one primary grasping interface (40) at the distal end (28) of the primary grasping device (20).

According to the disclosure, the augmented grasping device (10) further comprises at least a first auxiliary grasping device (30) comprising a first auxiliary grasping device proximal end, a first auxiliary grasping device distal end, at least a first auxiliary grasping interface (700) connected to the first auxiliary grasping device distal end configured to aid in picking up, manipulating or releasing objects, at least one actuator (100) configured to move the at least first auxiliary grasping interface (700) relative to the at least one primary grasping interface (40), wherein the at least first auxiliary grasping interface (700) is selected from a list consisting of a rotating protrusion (730), an auxiliary suction interface (710), a miniature protrusion (740) or a sleeve (750).

According to the disclosure, if the at least first auxiliary grasping interface (700) is the rotating protrusion (730), the rotating protrusion (730) is configured to slide underneath the object to be grasped and exert force in a direction different from the direction of the at least one primary grasping interface (40) and pinch the object to be grasped between the rotating protrusion (730) and the at least one primary grasping interface (40) to aid in picking up, manipulating or releasing the object, wherein the at least one actuator (100) of the first auxiliary grasping device (30) is further configured to move the rotating protrusion (730) beyond the distal end (28) of the primary grasping device (20) and below the object and to rotate the rotating protrusion (730) at least around an axis substantially parallel to the central axis of the at least one primary grasping interface (40).

According to the disclosure, if the at least first auxiliary grasping interface (700) is the auxiliary suction interface (710), the auxiliary suction interface (710) is further configured to generate a suction effect towards the object to be grasped when the at least first auxiliary grasping interface (700) is activated, wherein the at least one actuator (100) in of the first auxiliary grasping device (30) is further configured to at least move the auxiliary suction interface (710) to a deployed position, wherein if the deployed position is not already at a point of contact on the object where the object is to be engaged using suction effect, a path exists from the deployed position to the point of contact on the object, such that the augmented grasping device (10) or the first auxiliary grasping device (30) can unobstructedly move with the auxiliary suction interface (710) following the path and attain a grasping of the object.

According to the disclosure, if the at least first auxiliary grasping interface (700) is the miniature protrusion (740), the miniature protrusion (740) is further configured to provide a means to pull, pry, nudge or create a gap between the object to be grasped and another surrounding object, wherein the at least one actuator (100) of the first auxiliary grasping device (30) is further configured to move the miniature protrusion (740) beyond the distal end (28) of the primary grasping device (20).

According to the disclosure, if the at least first auxiliary grasping interface (700) is the sleeve (750), the sleeve (750) is further configured to surround the at least one primary grasping interface (40), provide the object being grasped with additional contact points or auxiliary grasping area to increase grasp strength or reduce object oscillations and vibrations, wherein the at least one actuator (100) of the first auxiliary grasping device (30) is further configured to move the sleeve (750) at least substantially parallel to the central axis of the at least one primary grasping interface (40).

According to the disclosure, the augmented grasping device (10) further comprises an intermediate structure (90) configured to connect the primary grasping device (20) and the at least first auxiliary grasping device (30) along at least one attachment point on the auxiliary grasping device (30), wherein the intermediate structure (90) is selected from a list consisting of at least a plate, a disc, a bracket, a truss, a framed structure, a robotic interface, a ball joint, a hydraulic mechanism, a pneumatic mechanism, a fluid mechanism, an electro-mechanical mechanism, a linear mechanism, a revolute joint, a spherical joint or a cardan joint.

### Sensor on Appendage (FIG. 9)

According to the disclosure, the augmented grasping device (10) wherein at least one auxiliary grasping device (30) further comprises at least one sensor (310) for measuring the position of at least one auxiliary grasping interface on the at least one auxiliary grasping device, or measuring the orientation of at least one auxiliary grasping interface on the at least one auxiliary grasping device, or detecting the presence of the object to be grasped, or detecting the detachment of the object from any second object placed underneath, or measuring object properties such as distance, size, color, reflectivity, surface texture, stiffness, and appearance, or collision avoidance, or measuring force, torque, pressure or vacuum level.

### Gripper+Appendage1: Blade+Appendage2, Mini Blade (FIG. 46)

According to the disclosure, the augmented grasping device (10) further comprises at least a second auxiliary grasping device (30, also 36 in FIG. 47 and FIG. 48) comprising a second auxiliary grasping device proximal end, a second auxiliary grasping device distal end, at least a first secondary auxiliary grasping interface (700) located at the second auxiliary grasping device distal end further comprising a secondary miniature protrusion (740), wherein the secondary miniature protrusion (740) is configured to provide a means to pull, pry, nudge or create a gap between the object to be grasped and another surrounding object and at least one secondary actuator (100) configured to move the secondary miniature protrusion (740) beyond the distal end (28) of the primary grasping device (20).

### Gripper+Appendage1: Blade+Side Cup Facing Down (FIG. 7B)

According to the disclosure, the augmented grasping device (10) wherein the first auxiliary grasping device (30) further comprises at least a second auxiliary grasping interface (700) in the form of at least one auxiliary suction interface (710) that generates a suction effect towards the object to be grasped when the auxiliary grasping interface is activated, wherein the at least one auxiliary suction interface (710) of the first auxiliary grasping device (30) is facing a direction that is substantially parallel to the central axis of the at least one primary grasping interface (40).

### Gripper+Appendage1: Blade+Side Cup Facing Sideways (FIG. 7B)

According to the disclosure, the augmented grasping device (10) wherein the first auxiliary grasping device (30) further comprising at least a second grasping interface (700) in the form of at least one auxiliary suction interface (710) that generates a suction effect towards the object to be grasped when the auxiliary grasping interface is activated, wherein the at least one auxiliary suction interface (710) of the first auxiliary grasping device (30) is facing towards a direction which is different from or substantially perpendicular to the one defined by the central axis of the at least one primary grasping interface (40).

### Gripper+Appendage1: Blade+Side Cup Facing Sideways (FIG. 37-FIG. 41)

According to the disclosure, the augmented grasping device (10) wherein at least a second auxiliary grasping device (31) comprising at least a first secondary auxiliary grasping interface (700) in the form of at least one secondary auxiliary suction interface (710) that generates a suction effect towards the object to be grasped when the first secondary auxiliary grasping interface (700) is activated, wherein the at least one secondary auxiliary suction interface (710) of the second auxiliary grasping device (31) is facing towards a direction which is different from or substantially perpendicular to the one defined by the central axis of at least one primary grasping interface (40) and at least one secondary actuator (101) configured to at least move the secondary auxiliary suction interface (710) to a deployed position unobstructedly, wherein if the deployed position is not already at a point of contact on the object where the object is to be engaged using suction effect, a path exists from the deployed position to the point of contact on the object, such that the augmented grasping device (10) or the second auxiliary grasping device (30) can unobstructedly move with the secondary auxiliary suction interface (710) following the path and attain a desired grasping orientation at the end of the pathof the object.

### Gripper+Appendage1: Blade+Appendage2, Side Cup Facing Down (FIG. 37)

According to the disclosure, the augmented grasping device (10) wherein at least a second auxiliary grasping device (31) comprising at least a first secondary grasping interface (700) in the form of at least one secondary auxiliary suction interface (710) that generates a suction effect towards the object to be grasped when the first secondary auxiliary grasping interface (700) is activated, wherein the at least one secondary auxiliary suction interface (710) of the second auxiliary grasping device (31) is facing in a direction that is parallel to the central axis of at least one primary grasping interface (40) and at least one secondary actuator (101) configured to at least move the secondary auxiliary suction interface (710) to a deployed position, wherein if the deployed position is not already at a point of contact on the object where the object is to be engaged using suction effect, a path exists from the deployed position to the point of contact on the object, such that the augmented grasping device (10) or the second auxiliary grasping device (30) can unobstructedly move with the secondary auxiliary suction interface (710) following the path and attain a grasping of the object.

### Gripper+Appendage1: Blade+Appendage2, Side Cup Facing Sideways+Min Blade (FIG. 46)

According to the disclosure, the augmented grasping device (10) wherein the first auxiliary grasping device (37) further comprises at least one sensor (310) for at least detecting at least the presence of the object to be grasped and its detachment from any second object placed underneath, wherein the second auxiliary grasping device (36) further comprises at least a second secondary auxiliary grasping interface (700) further comprising a secondary miniature protrusion (740) configured to provide a means to pull, pry, nudge or create a gap between the object to be grasped and another surrounding object, wherein the at least one secondary actuator (115) on the second auxiliary grasping device (36) is also configured to move the secondary miniature protrusion (740) beyond the distal end (28) of the primary grasping device (20).

### Gripper+More Than One Appendages−Grasping Devices Simultaneously to Grasp

According to the disclosure, the augmented grasping device (10) further comprises at least a second auxiliary grasping devices (30), wherein such second auxiliary grasping device (30) comprises a second auxiliary grasping device proximal end, a second auxiliary grasping device distal end, at least one secondary auxiliary grasping interface (700) connected to the secondary auxiliary grasping device distal end configured to aid in picking up, manipulating or releasing objects, at least one secondary actuator (100) configured to move the at least one secondary auxiliary grasping interface (700) relative to the at least one primary grasping interface (40), wherein the at least one secondary auxiliary grasping interface (700) is selected from a list consisting of a secondary rotating protrusion (730) resembling the rotating protrusion (730), a secondary auxiliary suction interface (710) resembling the auxiliary suction interface (710), a secondary miniature protrusion (740) resembling the miniature protrusion (740), or a secondary sleeve (750) resembling the sleeve (750).

According to the disclosure, if the secondary auxiliary grasping interface (700) is the secondary rotating protrusion (730), the secondary rotating protrusion (730) is configured to slide underneath the object to be grasped and exert force in a direction different from the direction of the at least one primary grasping interface (40), pinch the object to be grasped between the secondary rotating protrusion (730) and the at least one primary grasping interface (40) to aid in picking up, manipulating or releasing the objects, wherein the at least one secondary actuator (100) in of the first second auxiliary grasping device (30) is further configured to move the secondary rotating protrusion (730) beyond the distal end (28) of the primary grasping device (20) and below the object and to rotate the secondary rotating protrusion (730) at least around an axis substantially parallel to the central axis of the at least one primary grasping interface (40).

According to the disclosure, if the secondary auxiliary grasping interface (700) is the secondary auxiliary suction interface (710), the secondary auxiliary suction interface (710) is further configured to generate a suction effect towards the object to be grasped when the secondary auxiliary grasping interface (700) is activated, wherein the at least one secondary actuator (100) in of the first second auxiliary grasping device (30) is further configured to at least move the secondary auxiliary suction interface (710) to a deployed position, wherein if the deployed position is not already at a point of contact on the object where the object is to be engaged using suction effect, a path exists from the deployed position to the point of contact on the object, such that the augmented grasping device (10) or the second auxiliary grasping device (30) can unobstructedly move with the secondary auxiliary suction interface (710) following the path and attain a grasping of the object close to one surface of the object for grasping the object.

According to the disclosure, if the secondary auxiliary grasping interface (700) is the secondary miniature protrusion (740), the secondary miniature protrusion (740) is further configured to provide a means to pull, pry, nudge or create a gap between the object to be grasped and another surrounding object, wherein the at least one secondary actuator (100) in the first second auxiliary grasping device (30) is further configured to move the secondary miniature protrusion (740) beyond the distal end (28) of the primary grasping device (20);

According to the disclosure, if the secondary auxiliary grasping interface (700) is the secondary sleeve (750), the secondary sleeve (750) is further configured to surround the at least one primary grasping interface (40), provide the object being grasped with additional contact points or auxiliary grasping area to increase grasp strength or reduce object oscillations and vibrations, wherein the at least one secondary actuator (100) is further configured to move the secondary sleeve (750) at least linearly along a direction substantially parallel to the central axis of the at least one primary grasping interface (40), wherein the augmented grasping device (10) grasps an object using a configuration selected from a list consisting of: using: the primary grasping device (20) alone, using one at least the first auxiliary grasping device alone, at least the second auxiliary grasping device alone, at least the primary grasping device and the first auxiliary grasping device, or at least the primary grasping device and the second auxiliary grasping device, or the first auxiliary grasping device and the second auxiliary grasping device.

### Gripper+Appendage1: Side Cup Facing Sideway (FIG. 4E]

According to the disclosure, the augmented grasping device (10) wherein the at least one auxiliary suction interface (710) is facing towards a direction which is different from or substantially perpendicular to the one defined by the central axis of the at least one primary grasping interface (40).

### Gripper+Appendage1: Side Cup Facing Sideway (FIG. 4D]

According to the disclosure, the augmented grasping device (10) wherein the at least one auxiliary suction interface (710) is facing a direction that is substantially parallel to the central axis of at least one primary grasping interface (40).

### No Gripper Detail+Appendage1: Blade with Sensor+Appendage2, Min Blade (FIG. 46)

According to the disclosure, an augmented grasping device (10) configured for attachment to a robot, machine, automated equipment or intelligent system and configured for picking up, manipulating or releasing objects is disclosed. The augmented grasping device comprises one primary grasping device (20) comprising at least one primary grasping interface (40) at the distal end (28) of the primary grasping device (20) to contact and grasp an object, at least a first auxiliary grasping device (37) comprising at least one auxiliary grasping interface (700) in the form of a rotating protrusion (730) configured to allow pinching the object to be grasped between the rotating protrusion (730) and the primary grasping interface (40) to aid in picking up, manipulating, and releasing objects, at least one actuator (116) configured to move the rotating protrusion (730) beyond the distal end (28) of the primary grasping device (20) and below the object and to rotate the rotating protrusion (730) at least around an axis substantially parallel to the central axis of the at least one primary grasping interface (40) and at least one sensor (310) for detecting at least the presence of the object to be grasped and its detachment from any second object placed underneath.

According to the disclosure, an augmented grasping device (10) further comprises at least a second auxiliary grasping device (36) comprising at least a first secondary auxiliary grasping interface (700) in the form of a secondary miniature protrusion (740) configured to provide a means to pull, pry, nudge or otherwise create a gap between the object to be grasped and other surrounding objects, and at least one secondary actuator (115) configured to move the secondary miniature protrusion (740) beyond the distal end (28) of the primary grasping device (20).

According to the disclosure, an augmented grasping device (10) further comprises an intermediate structure (90) configured to connect the primary grasping device (20), the first auxiliary grasping device (37) and the second auxiliary grasping device (36) together to form the augmented grasping device (10) wherein the intermediate structure (90) is selected from a list consisting of a plate, a disc, a bracket, a truss, a framed structure, a robotic interface, a ball joint, a hydraulic mechanism, a pneumatic mechanism, a fluid mechanism, an electro-mechanical mechanism, a linear mechanism, a revolute joint, a spherical joint and a cardan joint, and wherein the intermediate structure (90) connects the primary grasping device (20), the first auxiliary grasping device (37) and the second auxiliary grasping device (36) in ways selected from a list consisting of the intermediate structure (90) connects the first auxiliary grasping device (37) to the primary grasping device (20), and connects the second auxiliary grasping device (36) to the first auxiliary grasping device (37); the intermediate structure (90) connects the second auxiliary grasping device (36) to the primary grasping device (20), and connects the first auxiliary grasping device (37) to the second auxiliary grasping device (36), the intermediate structure (90) connects the second auxiliary grasping device (36) to the primary grasping device (20), and connects the first auxiliary grasping device (37) to the primary grasping device (20); and the intermediate structure (90) connects the second auxiliary grasping device (36) to the primary grasping device (20), connects the first auxiliary grasping device (37) to the primary grasping device (20), and connects the first auxiliary grasping device (37) to the second auxiliary grasping device (36).

According to the disclosure, the second auxiliary grasping device (36) further comprises at least a second secondary auxiliary grasping interface (700) in the form of at least one secondary auxiliary suction interface (710) that generates a suction effect towards the object to be grasped when the auxiliary grasping interface is activated, wherein the at least one secondary auxiliary suction interface (710) is facing towards a direction which is different from or substantially perpendicular to the one defined by the central axis of at least one primary grasping interface (40) and at least one secondary actuator (115) configured to at least move the at least one secondary auxiliary suction interface (710) to a position, wherein if this position is not already at a point on the object where the object is to be engaged using suction effect, a path exists from this position to the point, such that the augmented grasping device (10) can unobstructedly move with the secondary auxiliary suction interface (710) following the path and attain a desired grasping orientation at the end of the path.

### Method to Press to Tilt an Object With a Rod (FIG. 52-55)

According to the disclosure, a method for preconditioning an object to facilitate subsequent grasping using an augmented grasping device (10), wherein the augmented grasping device (10) comprising one primary grasping device (20) having at least one primary grasping interface (40) configured to contact and grasp an object and at least a first auxiliary grasping device (34)comprising at least one auxiliary grasping interface (700), one proximal end, and one distal end is disclosed. The method comprises the steps of: bringing the at least one auxiliary grasping interface (700) of the first auxiliary grasping device (34) or the at least one primary grasping interface (40) of the primary grasping device (20) into contact with the object, positioning the at least one auxiliary grasping interface (700) of the first auxiliary grasping device (34) at a contact point on the object that is close to an edge of the object, or far from the geometric centre of the object, or far from the centre of gravity of the object, moving or pressing the at least one auxiliary grasping interface (700) of the first auxiliary grasping device (34) against the object at the contact point, in an orientation that causes the object to tilt, and wherein the object is initially resting upon at least one item, wherein the item on which the object rests is selected from a list consisting of a flat surface, a curved surface, a textured surface, a perforated surface, a grided frame, a mesh, a fin array, a bin, a shelf, a tray, a conveyor belt, a bench, a table, an automated guided vehicle, an autonomous mobile robot, and a pile of other objects and wherein tilting of the object creates a gap (201) underneath the object, which facilitates grasping of the object by the primary grasping device (20) or the first auxiliary grasping device (34) or their combination.

### Primary Grasping Interface Involved in Tilting (FIG. 52-55, D and E)

According to the disclosure, the method wherein the tilting movement is done in conjunction with movement or force exerted by the at least one primary grasping interface (40) on the object and movement or force exerted by the auxiliary grasping interface (700) of the first auxiliary grasping device on the object.

### Primary Grasping Interface+Rod Not Actuated, Pressing Is Done by Moving the Whole Augmented Grasping Device (FIG. 52C and FIG. 53C)

According to the disclosure, the method wherein the tilting movement is caused by moving the augmented grasping device (10), whereby the auxiliary grasping interface (700) of the first auxiliary grasping device (34) presses against the object and the proximal end of the first auxiliary grasping device (34) moves to facilitates the auxiliary grasping interface (700) of the first auxiliary grasping device (34) to press against the object.

### Primary Grasping Interface +Rod Actuated, Pressing is Done by an Actuator (FIG. 54C and FIG. 55C)

According to the disclosure, the method wherein the first auxiliary grasping device (34) further comprises at least a first actuator (111) configured to at least extend the auxiliary grasping interface (700) of the first auxiliary grasping device (34) and wherein the pressing of the auxiliary grasping interface (700) of the first auxiliary grasping device (34) against the object is achieved by at least the first actuator (111).

### Primary Grasping Interface+Rod Actuated, Orientation of Pressing is Achieved by an Actuator (FIG. 55)

According to the disclosure, the method wherein the first auxiliary grasping device (34) further comprises at least a second actuator (112) configured to at least orientate the auxiliary grasping interface (700) of the first auxiliary grasping device (34) with respect to the direction of the central axis of the at least one primary grasping interface (40), and wherein the orientation in which the at least one auxiliary grasping interface (700) of the first auxiliary grasping device (34) presses the object is attained by at least the second actuator (112).

### Method to Press to Tilt an Object With a Rod—Preferred Embodiment

According to the preferred embodiment of the disclosure, the method wherein the primary grasping device (20) further comprises a core suction interface (2100) configured for vacuum air suction, a peripheral compartment (23) surrounding the core suction interface (2100), an external wall (21) forming the upper surface of the peripheral compartment (23), a flexible membrane (22) forming the lower surface of the peripheral compartment (23), the flexible membrane (22) further configured to partially seal the peripheral compartment (23), wherein the flexible membrane (22) is attached to the external wall (21), wherein the core suction interface (2100) is attached to the flexible membrane (22), and wherein the peripheral compartment (23) is configured to allow passage of the core suction interface (2100) through the peripheral compartment (23).

According to the preferred embodiment of the disclosure, the method further comprising at least one actuating mechanism (24 or 27) configured to change the respective distance between the peripheral compartment (23) and the core suction interface (2100), at least one fluid control mechanism (29) configured to allow fluid communication to the peripheral compartment (23) and wherein the flexible membrane (22) and the core suction interface (2100) constitute at least one primary grasping interface (40).

### Method for Grasping+Rod+Primary Grasping Interface (FIG. 56)

According to the disclosure, the method further comprises the following steps: the at least one auxiliary grasping interface (700) of the first auxiliary grasping device (34) contacts the object first while the at least one primary grasping interface (40) is still not in contact with the object, the at least one auxiliary grasping interface (700) of the first auxiliary grasping device (34) presses on the object and causes the object to tilt until at least a part of the object contacts with the at least one primary grasping interface (40) and the at least one primary grasping interface (40) activates after the object is tilted and grasps the object on the part of the object opposite to the contact point at which the auxiliary grasping interface (700) of the first auxiliary grasping device (34) is located.

### Method for Grasping+Rod+Side Cup With No Limitation on Side Cup Orientation+Actuation (FIG. 57)

According to the disclosure, the method wherein the augmented grasping device (10) further comprises at least a second auxiliary grasping device (38) comprising, at least a first secondary auxiliary grasping interface (700) in the form of at least one secondary auxiliary suction interface (712) that generates a suction effect towards the object to be grasped when the first secondary auxiliary grasping interface is (700) activated, wherein the method further comprises the following steps: the at least one auxiliary grasping interface (700) on the first auxiliary grasping device (34) continues to press on the object and causes the object to tilt, the augmented grasping device (10) moves or rotates to establish a contact between the at least one secondary auxiliary suction interface (712) of the second auxiliary grasping device (38) and the object, and the at least one secondary auxiliary suction interface (712) of the second auxiliary grasping device (38) grasps the object.

### Method for Grasping+Rod+Blade (FIG. 58)

According to the disclosure, the method wherein the augmented grasping device (10) further comprises at least a second auxiliary grasping device (39) comprising at least a first secondary auxiliary grasping interface (700) in the form of a secondary rotating protrusion (730) configured to allowing pinching the object to be grasped between the secondary rotating protrusion (730) and the at least one primary grasping interface (40) to aid in picking up, manipulating, and releasing objects, and at least one secondary actuator (113)(114) configured to move the secondary rotating protrusion (730) beyond the distal end (28) of the primary grasping device (20) and below the object, and to rotate the secondary rotating protrusion (730) at least around an axis substantially parallel to the central axis of the at least one primary grasping interface (40), wherein the method further comprises the following steps of the secondary rotating protrusion (730) of the second auxiliary grasping device (39) is moved by the at least one secondary actuator (113, 114) of the second auxiliary grasping device (39) to a position that is clear to rotate into the gap (201), the secondary rotating protrusion (730) of the second auxiliary grasping device (39) is rotated into the gap (201) by the at least one secondary actuator (113, 114) of the second auxiliary grasping device (39), the secondary rotating protrusion (730) of the second auxiliary grasping device (39) is moved towards the at least one primary grasping interface (40) until contacting the object, creating a pinching action between the secondary rotating protrusion (730) of the second auxiliary grasping device (39) and the at least one primary grasping interface (40), wherein the object can be moved by the augmented grasping device (10) while being pinched between the secondary rotating protrusion (730) of the second auxiliary grasping device (39) and the at least one primary grasping interface (40).

### Method for Grasping+Placing Rod+Blade

According to the disclosure, the method wherein further comprises when arriving at the destination for placing the object, the object is positioned near a placement surface with one edge, side, or corner touching the surface, creating a gap between the object and the placement surface, the secondary rotating protrusion (730) of the second auxiliary grasping device (39) moves in a direction away from the at least one primary grasping interface (40) so that it is no longer pinching the object between the secondary rotating protrusion (730) of the second auxiliary grasping device (39) and the at least one primary grasping interface (40), the secondary rotating protrusion (730) of the second auxiliary grasping (39) device is rotated out of the gap between the object and the placement surface, the secondary rotating protrusion (730) of the second auxiliary grasping device (39) is brought back to its initial position by the at least one secondary actuator (113, 114) of the second auxiliary grasping device (39), and the augmented grasping device (10) moves away from the object and releasing the object by the augmented grasping device (10).

Mini Blade Folds so Either Mini Blade or Side Cup Exposed to the Object

According to the disclosure, an augmented grasping device (10) wherein the secondary miniature protrusion (740) of the second auxiliary grasping device (36) is configured to be able to move relative to the at least one secondary auxiliary suction interface (710) of the second auxiliary grasping device (36), so that either the secondary miniature protrusion (740) or the at least one secondary auxiliary suction interface (710) can be exposed to the object (60) for a specific pick without the other obstructing it operation.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

1-24. (canceled)

25. An augmented grasping device comprising:
a primary grasping device having a primary grasping interface;
an auxiliary grasping device including:
a rotating protrusion in mechanical communication with the auxiliary grasping device and configured to extend and retract relative to the primary grasping device; and
at least one actuator operatively coupled to the rotating protrusion;
wherein the rotating protrusion is extendable to a position beneath an object grasped by the primary grasping interface and is rotatable and retractable to apply a pinching force in cooperation with the primary grasping interface to facilitate lifting of the object.

26. The augmented grasping device of claim 25, wherein the auxiliary grasping device further comprises a sensor configured to measure a force applied by the rotating protrusion.

27. The augmented grasping device of claim 25, wherein the rotating protrusion is configured to rotate about an axis substantially parallel to a central axis of the primary grasping interface.

28. The augmented grasping device of claim 25, wherein the actuator is configured to control both linear extension and rotational movement of the rotating protrusion.

29. The augmented grasping device of claim 25, further comprising retracting the rotating protrusion away from the object after the object has been placed in a new location.

30. The augmented grasping device of claim 25 further comprising an auxiliary suction interface.

31. The augmented grasping device of claim 25, wherein the primary grasping device is configured to grasp a book, a box or a bag.

32. The augmented grasping device of claim 31, wherein the primary grasping device is configured to grasp along a spine of the book or along a spine lid of the box.

33. The augmented grasping device of claim 31, wherein the primary grasping device is configured to grasp the object on or in proximity to an edge of the object and the rotating blade is configured to slide underneath the object whereby the object does not open, deform or deconstruct.

34. The augmented grasping device of claim 31, wherein the augmented grasping device is configured to rotate to the edge of spine of the book.

35. The augmented grasping device of claim 32, wherein the object further comprises a sleeve or a jacket, wherein upon grasping the object, the sleeve or jacket is in space and the rotating blade is positioned underneath the object, whereby the sleeve or jacket does not come off the object.

36. The augmented grasping device of claim 25, wherein the primary grasping device further comprises a membrane.

37. A method of lifting an object using the combination of a primary grasping interface and a rotating protrusion, the method comprising the following steps in any order:
using a primary grasping device to grasp a portion of the object;
actuating an auxiliary grasping device to position a rotating protrusion beneath the object; and
moving the rotating protrusion upward to contact or lift the object or generate a pinching force with the primary grasping interface.

38. The method of claim 37, further comprising determining a sufficient pinching force has been applied prior to lifting the object.

39. The method of claim 37, further comprising releasing the primary grasping interface after the object is supported by the rotating protrusion.

40. The method of claim 37, wherein the object comprises a book, a box, or a similarly structured object with a non-binding edge or surface.

41. An augmented grasping device comprising:
a primary grasping device having a primary grasping interface configured to grasp a top or side surface of an object; and
an auxiliary grasping device including:
an auxiliary suction interface configured to extend in proximity or beyond the distal end of the primary grasping device to assist in grasping the object;
wherein the auxiliary suction interface is configured to apply a dual lifting or pinching force in conjunction with the primary grasping interface to assist in lifting or stabilizing the object.

42. The augmented grasping device of claim 41, wherein the primary grasping device further comprises a membrane.

43. A method for grasping and lifting an object using an augmented grasping device, the method comprising the steps of:
grasping a top or lateral surface of an object using a primary grasping interface;
extending a rotating protrusion of an auxiliary grasping device beneath the object;
moving the rotating protrusion to apply a lifting or pinching force against the object in conjunction with the primary grasping interface; and
lifting the object using the combined grasp of the rotating protrusion and the primary grasping interface.

44. The method of claim 43, further comprising determining whether a sufficient pinching has been applied before lifting the object or during transport of the object.
